(19) United States
(12) Patent Application Publication
(10) Pub. No.: US 2025/0183677 A1
(43) Pub. Date: Jun. 5, 2025

(54) HYBRID VEHICLE CONNECTOR

(71) Applicants: Go Eve Ltd, London (GB); University College Dublin, National University of Ireland, Dublin (IE)

(72) Inventors: Ammar Malik, Dublin (IE); Hugh Sheehy, Dublin (IE); Pietro Ferraro, London (GB); John Goodbody, London (GB)

(73) Assignees: Go Eve Ltd, London (GB); University College Dublin, National University of Ireland, Dublin (IE)

(21) Appl. No.: 18/981,480

(22) Filed: Dec. 14, 2024

Related U.S. Application Data
(63) Continuation-in-part of application No. 18/221,512, filed on Jul. 13, 2023.
Application No. 18/221,512 is a continuation of application No. 16/767,811, filed on May 28, 2020, now Pat. No. 11,749,998.
(60) Provisional application No. 63/611,095, filed on Dec. 15, 2023.
(60) Provisional application No. 63/696,363, filed on Sep. 18, 2024.
(60) Provisional application No. 63/697,947, filed on Sep. 23, 2024.

(30) Foreign Application Priority Data
Nov. 29, 2017 (EP) 1719884.7

(51) Int. Cl. H02J 7/00; B60L 53/10; B60L 53/12; B60L 53/14; B60L 53/16; B60L 53/60; B60L 53/66; B60L 53/67; B60L 55/00; H01R 13/639; H02J 3/14

(52) U.S. Cl. CPC H02J 7/0013; B60L 53/10; B60L 53/12; B60L 53/14; B60L 53/16; B60L 53/60; B60L 53/665; B60L 53/67; B60L 55/00; H01R 13/6397; H02J 7/00032; H02J 3/14

(57) ABSTRACT

The present disclosure describes a vehicle charging system comprising a vehicle charging gun comprising at least two pins, a protective earth (PE) pin configured to connect to ground and a proximity pilot (PP) pin configured to detect when the vehicle charging gun has been inserted into a vehicle; and an apparatus to couple with the vehicle charging gun, the apparatus comprising: a switch operable between a first position and a second position, the switch being controlled by a controller, wherein, when the switch is in the first position, the switch enables the vehicle or a vehicle charging station to detect that the vehicle charging gun is inserted into a vehicle inlet port of the vehicle, and when the switch is in the second position, the apparatus generates an electrical effect that simulates the removal of the vehicle charging gun from the vehicle inlet port.

### CROSS-REFERENCE TO RELATED APPLICATIONS

This application claims the benefit of priority to U.S. Provisional Application No. 63/611,095, filed Dec. 15, 2023, U.S. Provisional Application No. 63/696,363, filed Sep. 18, 2024, and U.S. Provisional Application No. 63/697,947, filed Sep. 23, 2024, the entirety of each of which is incorporated by reference herein. This application also claims the benefit of priority as a continuation-in-part to U.S. patent application Ser. No. 18/221,512, filed Jul. 13, 2023, which claims the benefit of priority as a continuation to U.S. patent application Ser. No. 16/767,811, filed May 28, 2020, which claims the benefit of priority to PCT Application No.: PCT/EP2018/083062, filed Nov. 29, 2018, which claims the benefit of priority to European Patent Application No.: 1719884.7, filed Nov. 29, 2017, the entirety of each of which is incorporated by reference herein.

### FIELD OF THE DISCLOSURE

The present disclosure relates to charging and directing power flow between electrical devices. More particularly, it relates to an apparatus for directing power flow between multiple devices, such as charge points and electrical-powered devices.

### BACKGROUND OF THE DISCLOSURE

In recent years there has been a gradual but progressively increasing movement towards a widespread use of electric vehicles in order to reduce the negative impacts of internal combustion engine vehicles on the environment and population's health caused by air and noise pollution.

Many of the limitations of electric vehicles (battery-related issues, range anxiety, charging times, lack of infrastructure) are being resolved by the OEMs and infrastructure providers.

One issue that remains is that of Charge Point anxiety. This is the “angst” that prevails when one needs access to a charge point. This issue is directly related to cars blocking charge points in our cities. Several solutions exist for sharing charge points, such as car-swapping algorithms where users arrange to exchange parking spaces via an app. These solutions do not guarantee access to a parking space and require dedicated brokerage engines.

In view of the above-described technologies, there is therefore a need for a system which addresses at least the problems outlined above.

### SUMMARY

These and other problems are addressed by providing an apparatus as detailed in the independent claims. Advantageous features are provided in dependent claims.

The apparatus and system of the present disclosure alleviate, or even completely eliminate, charge point anxiety as well as provide other benefits, as outlined below.

These and other features will be better understood with reference to the following figures which are provided to assist in an understanding of the present teaching, by way of example only.

### BRIEF DESCRIPTION OF THE DRAWINGS

FIG. 1 is a block diagram illustrating an apparatus for extending one or more charge points, according to an embodiment of the present disclosure;

FIG. 2 is a diagram illustrating an apparatus for extending one or more charge points, comprising 6 ports which can be outlet or inlet ports, according to an embodiment of the present disclosure;

FIG. 3 is a diagram illustrating a system for extending a charge point to multiple electrically powered devices, the system comprising a plurality of apparatus connected in a daisy chain configuration, according to an embodiment of the present disclosure;

FIG. 4 is a diagram illustrating different types of electrical vehicles connected to an apparatus, according to an embodiment of the present disclosure;

FIG. 5 is a diagram illustrating the directing of power flow between an apparatus having six ports, according to an embodiment of the present disclosure;

FIG. 6 is a diagram illustrating the directing of power between electrical devices connected in a daisy chain configuration via a plurality of apparatuses, according to an embodiment of the present disclosure;

FIG. 7 is a detailed schematic diagram of the apparatus, according to an embodiment of the present disclosure;

FIG. 8 is a diagram illustrating a plug-in protocol, according to an embodiment of the present disclosure;

FIG. 9 is a diagram illustrating a removal protocol, according to an embodiment of the present disclosure;

FIG. 10 is a diagram illustrating an unlocking protocol, according to another embodiment of the present disclosure;

FIG. 11 is a diagram illustrating a plurality of electric vehicles configured for wireless charging via an apparatus, according to an embodiment of the present disclosure;

FIG. 12 is a diagram illustrating a charging protocol for detecting the number of cars in a chain, according to an embodiment of the present disclosure;

FIG. 13 is a diagram illustrating a charging protocol, according to another embodiment of the present disclosure;

FIG. 14 is a diagram illustrating a charging protocol, according to another embodiment of the present disclosure;

FIG. 15 is a diagram illustrating a charging protocol, according to another embodiment of the present disclosure;

FIG. 16 is a diagram illustrating a charging protocol, according to another embodiment of the present disclosure;

FIG. 17 is a diagram illustrating a charging protocol, according to another embodiment of the present disclosure;

FIGS. 18 to 20 are graphs illustrating a percentage of time spent charging versus algorithm duration;

FIG. 21 is a diagram illustrating an embodiment of the present disclosure wherein users of a number of the apparatuses access the use of said apparatuses via a token system;

FIG. 22 is a diagram illustrating the return of a token to a user of an apparatus, according to an embodiment of the present disclosure;

FIG. 23 is a schematic diagram of a monetization system related to an apparatus, according to an embodiment of the present disclosure;

FIG. 24 is a diagram illustrating an apparatus of the present disclosure in communication with a GPS satellite and at least one mobile device, according to an embodiment of the present disclosure;

FIG. 25 is a diagram illustrating a charging protocol according to another embodiment of the present disclosure;

FIG. 26 is a diagram illustrating a network layer architecture of the apparatus, according to an embodiment of the present disclosure;

FIG. 27 is a block diagram illustrating a configuration of a computing device which includes various hardware and software components that function to perform processes according to embodiments of the present disclosure;

FIG. 28 is a block diagram of a system for charging vehicles in a daisy chain configuration, according to an embodiment of the present disclosure;

FIG. 29 is a flowchart illustrating a method for charging vehicles in a system with a daisy chain configuration, according to an embodiment of the present disclosure;

FIG. 30 is a block diagram illustrating a locking protocol for a system for charging vehicles in a daisy chain configuration, according to an embodiment of the present disclosure;

FIG. 31 is a flowchart illustrating a method for charging vehicles in a system with a daisy chain configuration, according to an embodiment of the present disclosure;

FIG. 32 is a block diagram of a system for charging vehicles in a daisy chain configuration;

FIG. 33A is a block diagram of a system for charging vehicles in a daisy chain configuration, according to an embodiment of the present disclosure;

FIG. 33B is a block diagram of a system for charging vehicles in a daisy chain configuration, according to an embodiment of the present disclosure;

FIG. 34 is an illustration of components of a system for charging vehicles in a daisy chain configuration, according to an embodiment of the present disclosure;

FIG. 35 is a flowchart illustrating a method for charging vehicles in a system with a daisy chain configuration, according to an embodiment of the present disclosure;

FIG. 36A is a block diagram of a system for charging vehicles in a daisy chain configuration, according to an embodiment of the present disclosure;

FIG. 36B is a block diagram of a system for charging vehicles in a daisy chain configuration, according to an embodiment of the present disclosure;

FIG. 37 is an illustration of a pin configuration of a vehicle charging gun, according to an embodiment of the present disclosure;

FIG. 38 is an illustration of a hybrid wiring system in which an alternating current supply is used for alternating current vehicle charging, according to an embodiment of the present disclosure;

FIG. 39 is an illustration of a hybrid wiring system in which an alternating current supply is used for direct current vehicle charging, according to an embodiment of the present disclosure;

FIG. 40 is an illustration of a communication circuit, according to an embodiment of the present disclosure;

FIG. 41 is an illustration of a welding detection circuit, according to an embodiment of the present disclosure;

FIG. 42 is an illustration of a charging locking circuit, according to an embodiment of the present disclosure;

FIG. 43 is a flowchart illustrating a method for charging vehicles in a system with a daisy chain configuration, according to an embodiment of the present disclosure;

FIG. 44 is a block diagram of a system for charging vehicles, according to an embodiment of the present disclosure;

FIG. 45 is an illustration of a wiring diagram of a vehicle charging gun, according to an embodiment of the present disclosure;

FIG. 46 is an illustration of a wiring diagram of a vehicle charging gun, according to an embodiment of the present disclosure; and

FIG. 47 is a flowchart illustrating a method for charging vehicles in a system with a daisy chain configuration, according to an embodiment of the present disclosure.

### DETAILED DESCRIPTION

Embodiments of the present disclosure will now be described with reference to some exemplary apparatus and systems described herein. It will be understood that the embodiments described are provided to assist in an understanding of the present disclosure and are not to be construed as limiting in any fashion. Furthermore, modules or elements that are described with reference to any one figure may be interchanged with those of other figures or other equivalent elements without departing from the spirit of the present disclosure.

The present disclosure provides an apparatus and system that are configured to alleviate, or even completely eliminate, charge point anxiety. Moreover, it will be understood that the terms ‘charge point’ and ‘charging point’ are equivalent. Also, the term ‘box’ illustrated in some of the drawings will be understood to refer to the apparatus for directing power flow between multiple devices according to the present disclosure. Unless otherwise specified, the term “devices” encompasses electrically-powered devices such as electric vehicles, e-bikes, e-scooters, mobile devices, Internet of Things (IoT) devices, and charging points. As such, the apparatus may be configured to redirect power flow between one or more charging points and a plurality of electrically powered devices. The apparatus may also be configured to redirect power flow between a plurality of electrically powered devices themselves.

FIG. 1 is a block diagram illustrating an apparatus 100 for extending one or more charge points to multiple electrically powered devices, according to an embodiment of the present disclosure. Referring to FIG. 1, the apparatus 100 comprises one or more inlet port(s) 110 for connection to one or more charge points, at least two outlet ports 210 and 220 configured for supplying electrical power; and a computing device 900 configured to route power from the one or more inlet port(s) to the at least two outlet ports.

The apparatus 100 may be configured to direct power flow from at least one charging point to one or more electrically powered devices. The apparatus 100 may be configured to redirect power flow from one or more electrically powered devices to one or more charging points. The apparatus 100 may be configured to redirect power flow between a plurality of electrically powered devices. In view of the above, the apparatus 100 may be considered an adaptor for redirecting power flow between electrically powered devices and/or charging points.

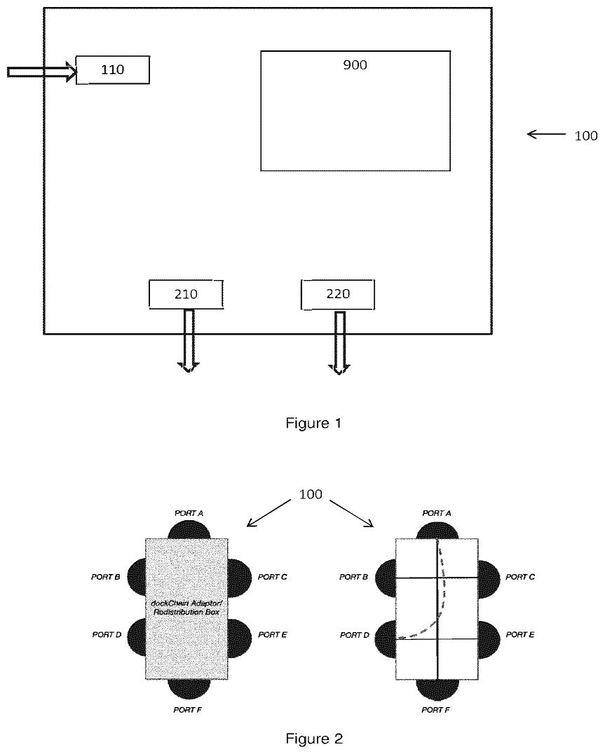

FIG. 2 depicts an exemplary embodiment in which the apparatus 100 comprises six ports which may be inlet ports and/or outlet ports for extending one or more charge points. The ports can be connected to each other to transfer energy between the ports, as illustrated by the lines and dashed lines between the ports depicted in FIG. 2.

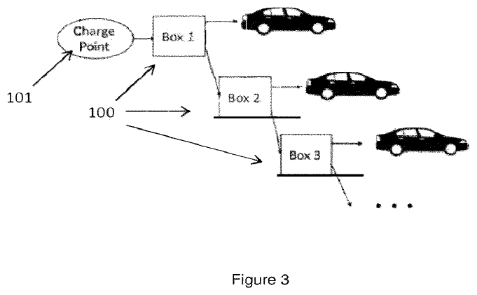

In an exemplary embodiment of the present disclosure involving electric vehicles, such vehicles carry the apparatus 100 much like how a spare wheel is carried. The apparatus 100 comprises one or more inlet port(s) for connection to one or more charge points. Public charge points may be located on-street and in locations such as shopping centres and car parks. Such charge points are connected to a three-phase electricity supply and depending on the car type and battery size, charging can take between 1 and 6 hours. In another exemplary embodiment of the present disclosure involving electric vehicles, a charging point operator may install multiple such apparatuses, fixed in place, to extend the reach of a charging point to multiple parking spaces. The apparatus 100 may comprise a cable and plug connector for plugging into one or more charge points, and at least two outlet ports for enabling connection or charging to additional electrically powered devices. In this way electric vehicles can be daisy-chained together and never block a charge point 101, as depicted in FIG. 3. FIG. 3 is a diagram illustrating a system for extending one or more charge points to multiple electrically powered devices, the system comprising a plurality of apparatus 100 (or boxes as indicated in the drawings) connected in a daisy chain configuration, according to an embodiment of the present disclosure.

End-users of the apparatus 100 may include the following:

| User | Embodiment |
|---|---|
| Owners of public charge | Apparatus 100 may be used to extend |
| points (Hotels, hospitals, | the reach of a charge point to multiple |
| universities, etc.) | vehicles. |
| Owners of private charge | |
| points | |
| Plug-in vehicle owners | Apparatus 100 may be used to prevent a |
| | plug-in car from blocking a charge point. |

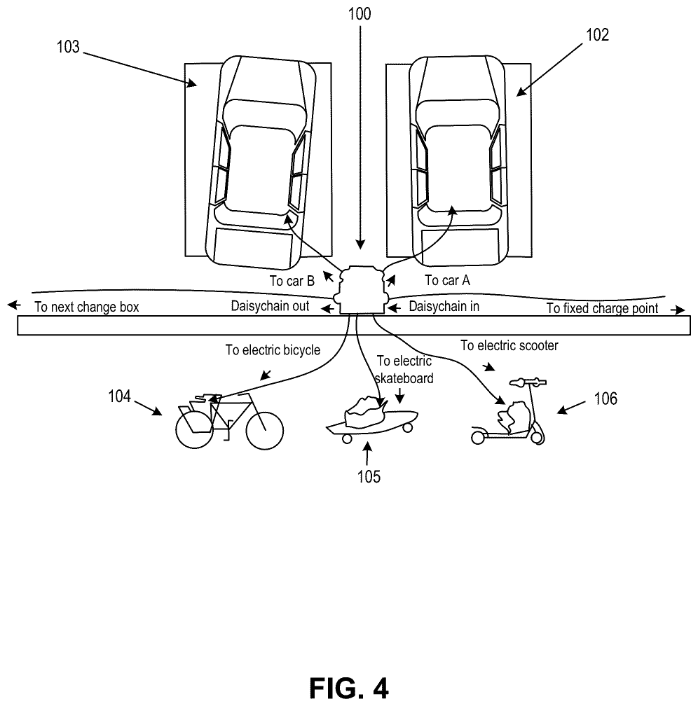

The apparatus 100 may also be used for other devices that require simultaneous charging (e.g., mobile devices, e-bikes, e-scooters, and most Internet of Things (IoT) devices). In this regard, the apparatus 100 may be configured for an electric vehicle charging point, a computing device charging point or an Internet of Things (IoT) charging point. FIG. 4 is a diagram illustrating an embodiment of the apparatus 100 according to the present disclosure, in which a plurality of different electrically powered devices 102-106 are connected to an apparatus 100. In one embodiment, each apparatus 100 can be dynamically paired with one or more electrical devices using a Distributed Ledger Technology (DLT) token-based system. The apparatus 100 may be configured to implement the distributed ledger network with user payment devices. The DLT token-based system may be private and pseudo-anonymous.

The apparatus 100 may comprise a housing for receiving the componentry of the apparatus 100, various hardware and software components that function to perform processes according to the present disclosure, such as supporting software, logic, and payment mechanisms to secure the apparatus 100, and one or more processors configured to route power from the one or more inlet ports to the outlet ports according to a charging protocol. The one or more processors may route power between the one or more inlet ports and the outlet ports via a software-defined interface.

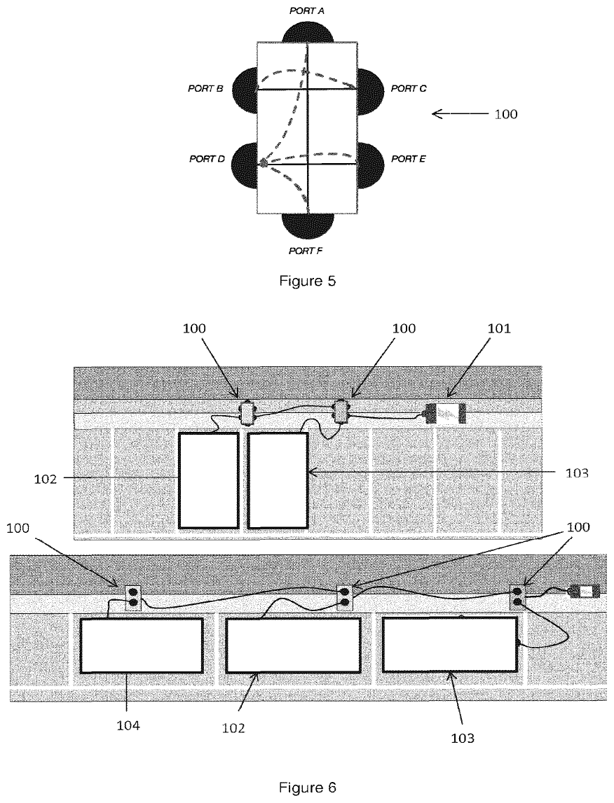

FIG. 5 is a diagram illustrating the directing of power flow between an apparatus 100 having 6 ports which may be inlet ports and/or outlet ports according to an embodiment of the present disclosure. The dotted-line arrows represent the directions of the respective power flows.

FIG. 6 is a diagram illustrating the directing of power between electrical devices 102-104 connected in a daisy chain configuration via a plurality of apparatuses 100 according to an embodiment of the present disclosure. Further electrical devices may be connected to any one of these apparatuses 100. The electrical devices 102-104 may be electric vehicles.

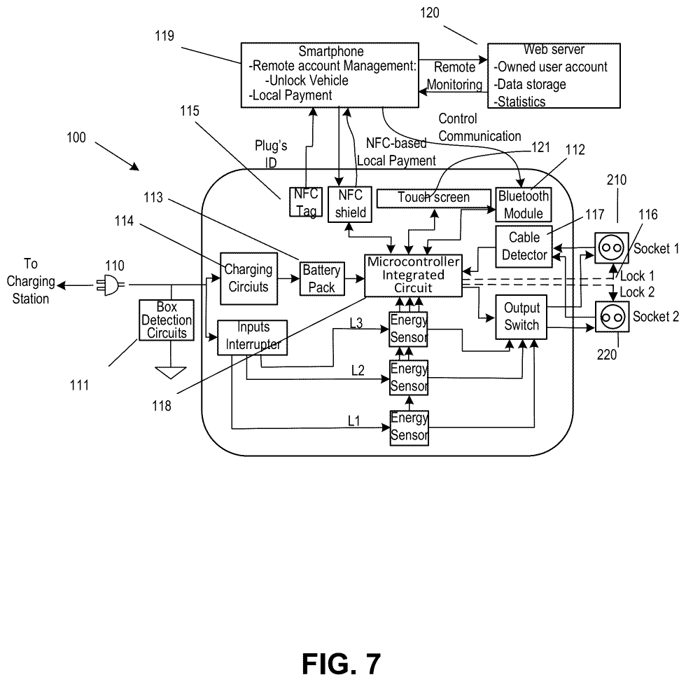

FIG. 7 is a detailed schematic diagram of the apparatus 100 according to an embodiment of the present disclosure. Referring to FIG. 7, the apparatus 100 may be configured to route power from the input 110 to one or other, or none of the output ports 210, 220. In the case of AC charging, up to three phases of input supply may be switched simultaneously and power of any of the three phases may be supplied to one or other, or none of the output ports 210, 220. Power on each phase can be measured independently (for the purpose of directing charging algorithms and payment schemes). The apparatus 100 may comprise a detection mechanism 111 to allow the detection of second or subsequent apparatuses in the chain. In an exemplary embodiment, the detection mechanism 111 may comprise a resistive circuit on the one or more inlet port(s) to allow for the detection of second or subsequent apparatuses. A wireless module such as a Bluetooth® module 112 may be provided for two purposes: (i) to enable peer-to-peer communication between apparatuses; (ii) and to enable communication with a paired smart device. The apparatus 100 may comprise an internal power supply 113 that is automatically charged when connected to a chain. Charging may be facilitated by a charging circuit 114. The internal power supply 113 enables wireless communication even when disconnected from a power supply (see deposit algorithm later). Near-field communication (NFC) tags 115 may be used to facilitate payment for power, security, or releasing the apparatus 100.

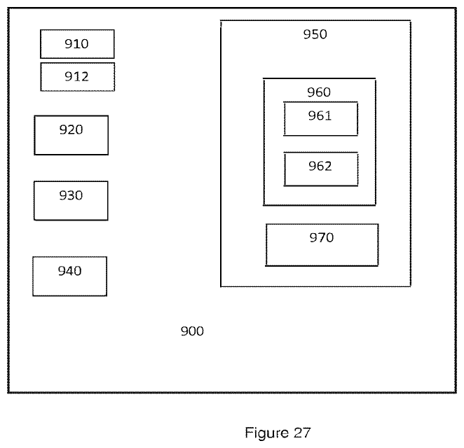

In some embodiments, the apparatus 100 can include a cable locking mechanism 116 that is configured to lock cables at the outlets. The cable locking mechanism 116 may allow devices downstream of, or otherwise connected with, a disconnected apparatus 100 to remain locked. That is, the cable locking mechanism 116 may be configured to lock cables of devices downstream (e.g., an apparatus coupled outside of the connections between the apparatus 100 and a charging point) of the apparatus 100 to the apparatus 100 when the apparatus 100 is disconnected from an upstream apparatus (e.g., an apparatus coupled between a charging point and the apparatus 100) or a charging point. The cable locking mechanism 116 may be configured to prevent unauthorized users from manually disconnecting paired apparatuses and/or electrical-powered devices. Power for the functionality of the cable locking mechanism 116 may be derived from the internal supply 113 and cables may be detected via a cable detector circuit 117. A microcontroller 118 may facilitate the execution of the various software modules either installed in memory units (not pictured, see FIG. 27) on board the apparatus 100 or communicated via remotely located devices including but not limited to at least one smart device 119 or otherwise. The smart device 119 may facilitate at least one of but limited to account management, device unlocking or payment processing. As such, in one embodiment the smart device 119 may retrieve account data and/or statistics from a remote server 120. A user may furthermore interact with the apparatus 100 and one or more of its functions via an integrally installed user interface which may be a touch screen interface 121.

In some embodiments, the apparatus 100 may not include a cable locking mechanism that locks the apparatus 100 to a device downstream from the apparatus 100. In such embodiments, the apparatus 100 may be permanently attached to the device downstream from the apparatus 100 and/or a cable configured to connect with the device downstream from the apparatus 100. In some cases, an apparatus or a set of apparatuses can be permanently connected with the charge point.

Protocols for connecting and disconnecting an apparatus 100 may be as follows.

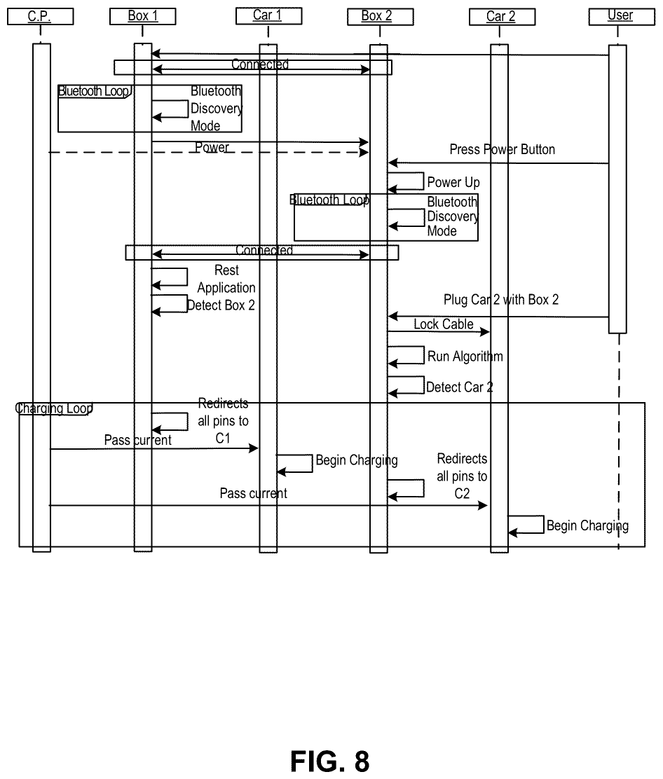

Plug-in protocol, as illustrated in FIG. 8.
1. User plugs in apparatus N into apparatus N−1
2. Apparatus N turns on automatically.
3. Apparatus N−1, apparatus N, and all other apparatuses in the chain connect wirelessly (peer to peer).
4. User plugs vehicle N into apparatus N
5. Charging Process begins

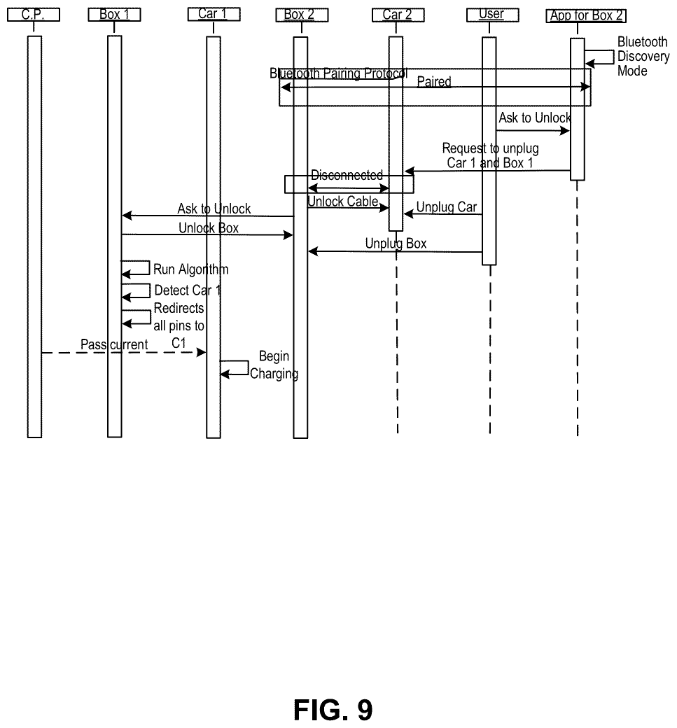

Disconnection protocol, as illustrated in FIG. 9.
1. User uses smart device app to ask apparatus N−1 to unlock car N
2. Owner of apparatus N unplugs from apparatus N−1.
3. Apparatus N releases apparatus N+1 and car N connected to apparatus N.
4. User connects apparatus N+1 to apparatus N−1 re-establishing the chain.
5. Charging Process begins again

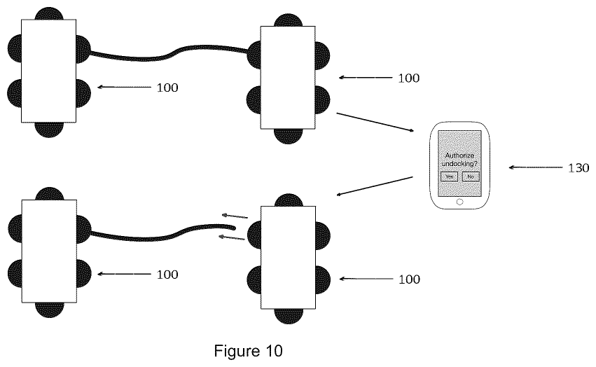

FIG. 10 illustrates step 1, wherein a user smart device 130 app is used to ask apparatus N−1 to unlock vehicle N. In another embodiment the device to be unlocked may be a device other than a vehicle, such as but not limited to a mobile device or an IoT device.

The steps of the disconnection protocol will be understood to be equally applicable, for example, in the case of an apparatus N connected to either only a charging point or a charging point and at least one additional apparatus.

In some embodiments, users who disconnect their apparatus 100 must reconnect the next apparatus in the chain. This can be achieved via:
(a) a ratings system where bad behaving EV owners achieve a low score each apparatus 100 is identified with a unique owner and bad behaving owners are penalised (paying more for electricity, or lower priority access to charging);
(b) or via a deposit system enabled using a payment service (e.g., PayPal®, Visa®) or using a cryptocurrency. Here, apparatuses 1-2- . . . -M are connected from left to right.

Suppose apparatus N (N<M) wishes to disconnect. The apparatus lodges a deposit with apparatus N−1 (or all other apparatuses) using for example, Bitcoin, or MIOTA. The deposit can be proportional to the number of apparatuses connected to the right of apparatus N; i.e. M−N apparatuses. The apparatus is then released by apparatus N−1, and the deposit is returned to apparatus N when the owner reconnects apparatus N+1 to apparatus N−1 (reconnects the chain).
3. Charging Analytics and Security

The apparatus 100 may be programmable and several charging algorithms are possible. It is instructive to consider here a daisy chain with apparatus N connected to apparatus N−1.

A ‘water filling’ algorithm, wherein only one electrical device is charged at a time. For example, first device N−1 in the chain is charged, then device N, etc.

Equal charge is supplied to all vehicles in the chain (device N and device N−1 receive equal charge).

Premium user charging based on payment (user of device N may have paid a priority fee while user of device N−1 may not have, giving device N priority charging).

Priority based on “good behaviour” (device N receives priority over device N−1 if user of device N has a preferential behaviour record over user of device N−1, e.g. according to the rating system described in a) above).

Prioritisation of charging based on number of occupants; vehicle type (government vehicles, emergency vehicles, shared vehicles) etc.

Prioritisation of charging based on charging requirements of a plurality of electrical devices connected to the apparatus 100, i.e. battery level and/or required journey range. For example, device N has critical battery while device N−1 is 90% charged, or a combination of this with, for example, information on required journey range of device N compared with device N−1. A decision may be made based on who needs greater battery in conjunction with journey range.

Time multiplexed charging priority of other kinds; for example, if device N has been charging for one hour longer than device N−1, then device N−1 may receive priority.

Market based prioritisation of charging based on trading of slots between users for money (IOTA/Bitcoin). User of device N may exchange currency with user of device N−1 to receive priority.

A number of the above charging protocols use a predetermined metric (e.g. battery level, journey range, behaviour etc.) to determine priority by comparison. Metric parameters other than those described herein may be implemented to the same effect.

Charging protocols to determine length of chain connected to each apparatus 100.

This may be used to provide added security in case of dishonest apparatuses (for example an apparatus 100 trying to disconnect without providing payment, or an apparatus 100 programmed to access charging whilst concealing the number of connected devices and/or without being subject to certain priority-based charging protocols such as the good behaviour protocol). This latter algorithm may be used to detect the number of apparatuses present in a chain of cascaded ‘Smart Plug’ apparatuses. In one embodiment, the algorithm initially may be performed with one empty socket in the chain, i.e., immediately after an apparatus 100 has been added to the chain and before another apparatus 100 is added. Each apparatus 100 randomly assigns current to a socket every T seconds for the algorithm duration of T with equal probability, e.g. a coin toss. The fraction for which current is not drawn is an indication of the length of the chain. If a new apparatus is detected, an access request may be sent to the apparatus for relevant encrypted protocol data such as behaviour history. The data may contain a series of security markers which identify the information as legitimate. If no information or no legitimate information is received from the request, then flow of power to that apparatus 100 may be ended. The dishonest apparatus 100 or apparatuses and/or device(s) may further be locked into the chain until payment is provided. In an embodiment where a DLT system is implemented to pair devices, the device N remains locked in until the token has been returned to the paired device N−1 or N+1 via a digital wallet located on a mobile device for example. In a further embodiment, the locking mechanism on an apparatus that is not in use is kept locked shut until an access request is sent from the user mobile device app and/or the user's apparatus 100 for legitimate encrypted protocol history data.

In one embodiment, any of the charging protocols above may comprise providing power (e.g., AC power) of different phases to the various electrical devices connected, according to their priority. For example, if device N has priority over device N−1, then device N may receive 3-phase electrical power from the apparatus 100 while device N−1 may receive single-phase or 2-phase electrical power from the apparatus 100.

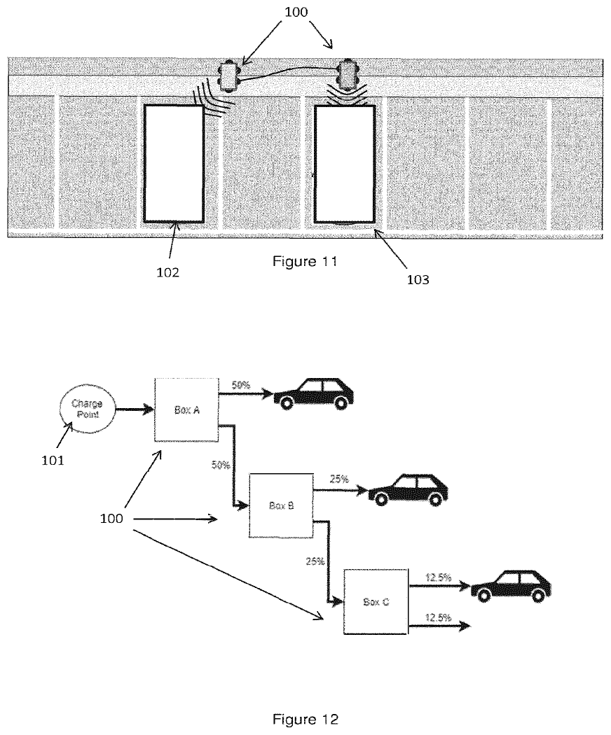

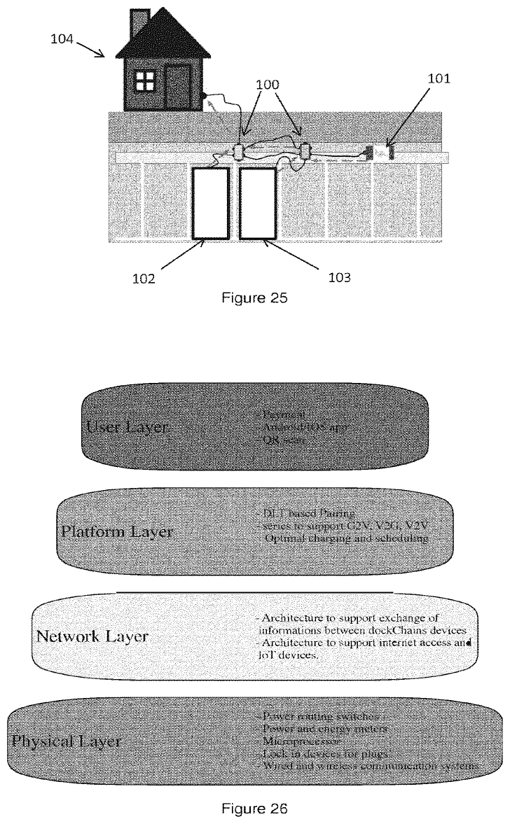

Referring to FIG. 11, the apparatus 100 may be further capable of wireless charging electrically powered devices 102, 103. FIG. 11 is a diagram illustrating a plurality of electrically powered devices 102, 103, such as electric vehicles, configured for wireless charging via the apparatus 100 according to an embodiment of the present disclosure. The wireless charging may be implemented using the same wireless module which provides peer-to-peer connection between apparatuses. In one embodiment, this may allow routing of power between any number of devices in a network of arbitrary interconnections via at least one apparatus 100 (see FIG. 25).

FIG. 12 is a diagram illustrating a charging protocol for detecting the number of electric vehicles in a chain according to an embodiment of the present disclosure. Referring to FIG. 12, an apparatus 100 assigns current randomly to each socket. If a socket is empty, current is not drained. The computing device can determine the percentage of time current is not drained.

For example:
12.5% of the time the current is not drained
12.5/100=½″n
where n=number of apparatuses in the chain.

The apparatus 100 of the present disclosure alleviate, or even completely eliminate charge point anxiety by enabling a plurality of the apparatus 100 to be connected together in a daisy chain configuration.

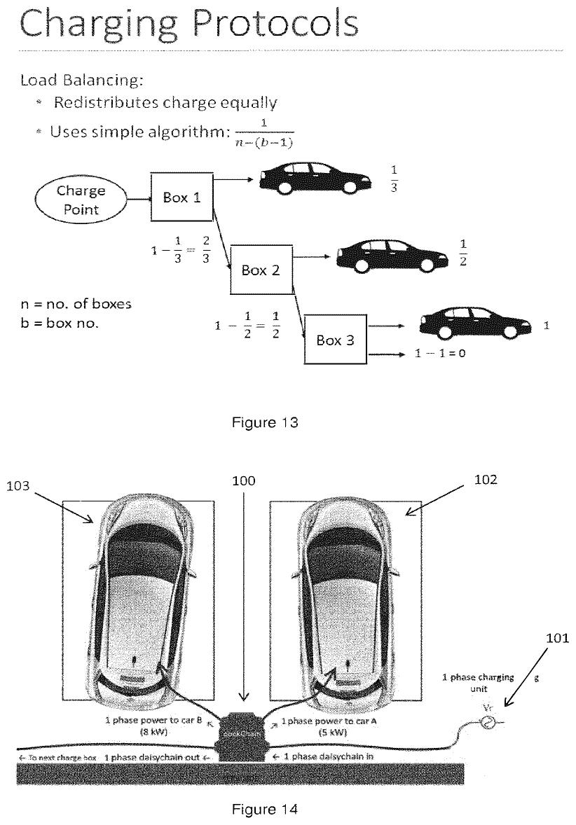

FIG. 13 is a diagram illustrating a charging protocol according to an embodiment of the present disclosure, in which to redistribute charge equally according to the equal charge charging protocol, the formula

$$Fraction of power to box b = \frac{1}{n - ( b - 1 )}$$

may be used, where n is the number of boxes and b is the box number. FIG. 13 illustrates an embodiment of this algorithm involving three devices (n=3) connected to a charge point via a plurality of the apparatus 100 in a daisy chain configuration. Box 1 (b=1) has:

$$\frac{1}{3 - ( 1 - 1 )} = \frac{1}{3}$$

Thus box 1 receives one third of the power from the charge point. This leaves two thirds of the power to be transferred to subsequent apparatuses. Box 2 has:

$$\frac{1}{3 - ( 2 - 1 )} = \frac{1}{2}$$

Thus box 2 receives one half of the remaining power:

$$\frac{2}{3} \times \frac{1}{2} = \frac{1}{3}$$

Box 2 and box 1 are therefore receiving the same fraction of the charge points power supply. Clearly there is one third of the total power remaining, one third having gone to each of boxes 1 and 2. Box 3 has:

$$\frac{1}{3 - ( 3 - 1 )} = 1$$

Therefore box 3 receives 100% of the remaining power, and so receives one third of the total charge point power supply as did boxes 1 and 2. Thus all three boxes and devices received the same power. Other formulations of this algorithm exist other than that presented here which achieve the same effect.

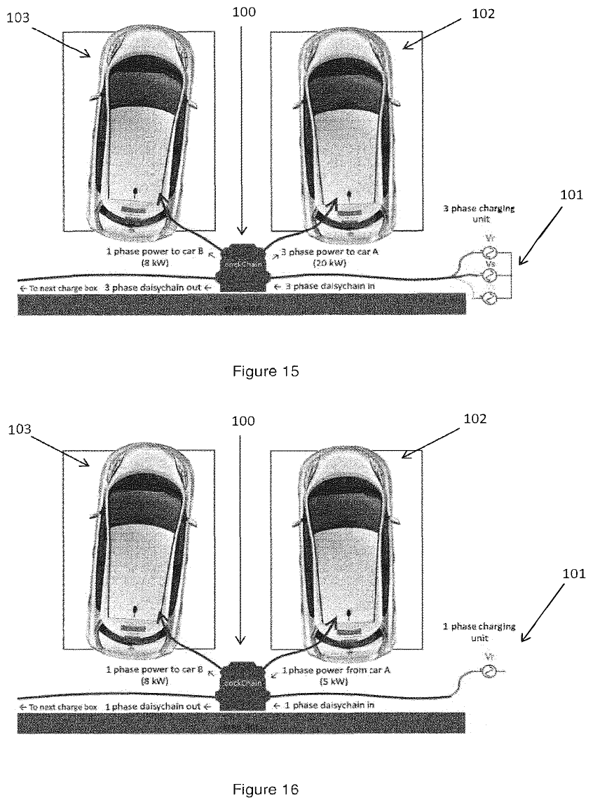

Referring to FIG. 14, in one embodiment the apparatus 100 is configured to route single-phase power (e.g., AC power) of 5 kW to an electrically powered device 102 and furthermore single-phase power of 8 kW to a second electrically powered device 103, while single-phase power is routed through the apparatus 100 to one or more further apparatuses connected in the daisy chain configuration. This provides an example of one device receiving charge priority over at least one additional device, according to one or a combination of the charging protocols. Moreover, the apparatus 100 may be configured such that the power (e.g., AC power) routed to at least one of the devices 102, 103 may differ in both phase and magnitude (in, for example, units of Watts). Furthermore, the apparatus 100 may be configured such that the power routed from the one or more charge points 101 to the apparatus 100 to any further apparatuses in the daisy chain configuration may be of a different phase to that detailed described above. An example of a further embodiment to this effect is illustrated in FIG. 15.

Referring to FIG. 16, in one embodiment the apparatus 100 is configured to reroute single-phase power (e.g., AC power) flow from an electrically powered device 102 to a second electrically powered device 103, while single-phase power is routed through the apparatus 100 to one or more additional apparatuses connected in the daisy chain configuration. Accordingly, a network of arbitrary interconnections comprising a network enabled service layer may be provided where users may sell power from their devices to one another (see FIG. 25). Moreover, other power phase flows to and from devices may be provided for example an embodiment in which single-phase power is routed from a device 102 to a device 103 which receives 3-phase power. In other embodiments, power may be rerouted, whether of the same phase or different, from one or more devices to a plurality of other devices.

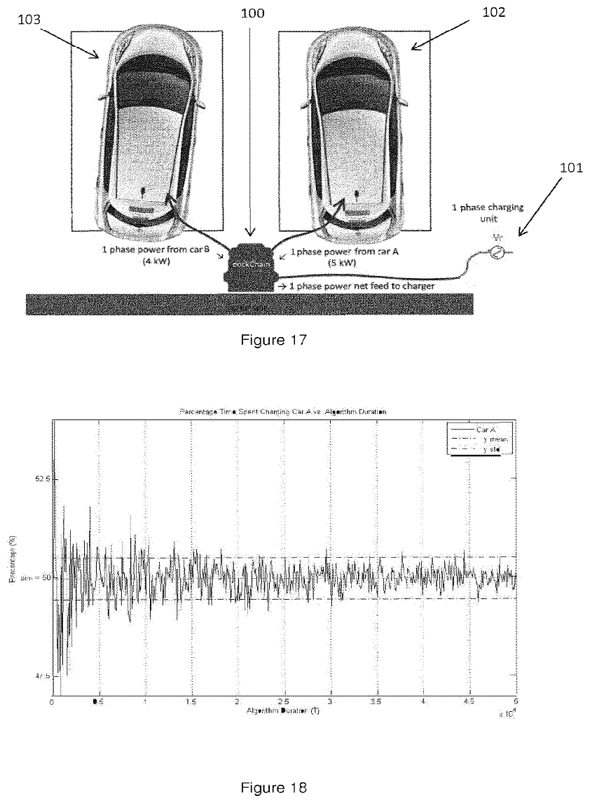

FIG. 17 depicts another embodiment of the apparatus 100 of the present disclosure in which single-phase power (e.g., AC power) is routed from both devices 102, 103 in a chain to the charge point 101. Other power (e.g., AC power) phase flows from devices may be implemented for example an embodiment in which single-phase power is routed from a device 102 to a charge point which receives while 3-phase power is routed from a device 103 to the same charge point 101. Another embodiment provides that power may be rerouted, whether of the same phase or different, from one or more devices to a plurality of charge points 101.

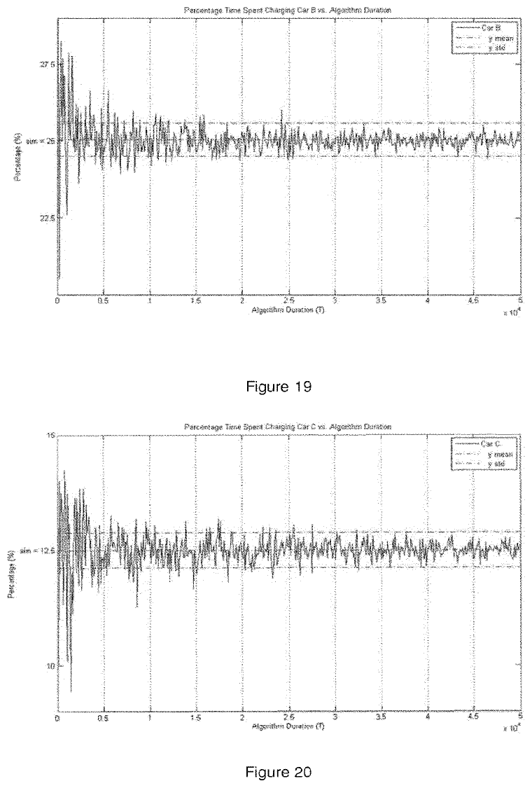

FIGS. 18 to 20 are graphs illustrating a percentage of time spent charging versus algorithm duration.

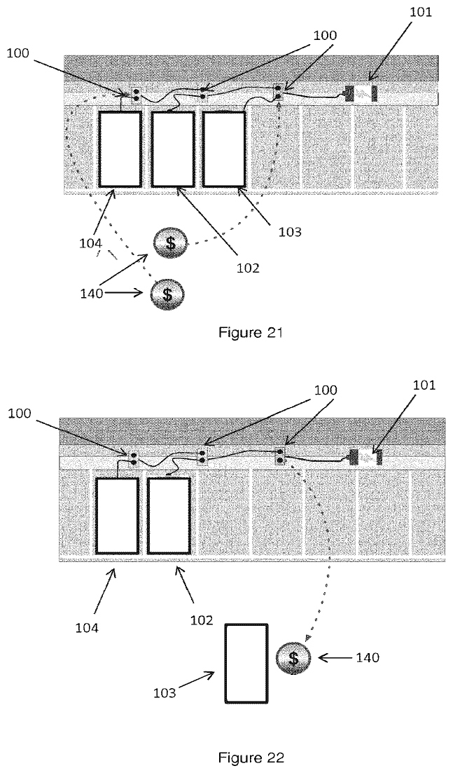

FIG. 21 is a diagram illustrating an embodiment of the present disclosure wherein users of a number of the apparatuses 100 access use of said apparatuses 100 via a token system 140. In one embodiment, the token system 140 may be implemented in combination with the previously described deposit system for penalising poor behaviour on the part of users in relation to reconnecting apparatuses 100 when the user disconnects (see description relating to disconnection protocol).

FIG. 22 is a diagram illustrating the return of a token 140 to a user of an apparatus 100 according to an embodiment of the present disclosure. In one embodiment, the token 140 may be returned to the user after reconnecting apparatuses 100 either side of them when disconnecting their own apparatus 100.

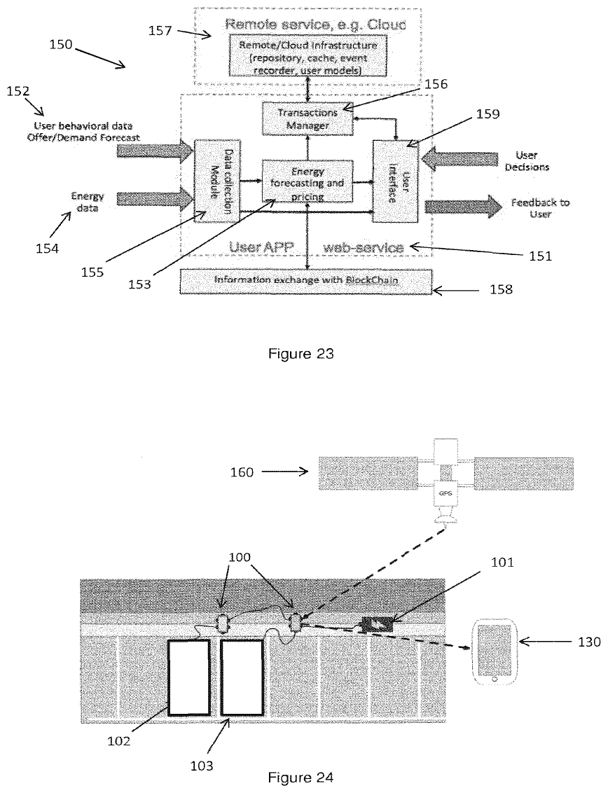

FIG. 23 is a schematic diagram of a monetization system 150 related to an apparatus 100 according to an embodiment of the present disclosure wherein the configured power flow is monetized via a web-interface 151. The monetization system 150 may be based on a user profile 152 and demand forecasting 153. Forecasting may be conducted in conjunction with energy data input 154 to a data collection module 155 which is furthermore either operably associated with a processing unit (not pictured) or integrally contains a processing unit. Pricing is then processed via a transactions manager 156 and any information relating to pricing is then relayed to a remote server 157 which may be cloud based. The system 150 may further exchange information with a blockchain 158. A user may interact with the system via a user interface 159. The user interface 159 may comprise a display module which may be touch screen.

FIG. 24 is a diagram illustrating an apparatus 100 in communication with a GPS satellite 160 and at least one mobile device 130, according to an embodiment of the present disclosure. In this embodiment, the location of the apparatus 100 may be determined, for example after the user has spent a period away from the apparatus 100 and wishes to locate it again. The association of the GPS system with an apparatus 100 may be used for other functional purposes including but not limited to reporting position information relating to system or apparatus 100 incidents to a remote server. The apparatus 100 of the present disclosure may be associated operably with any existing satellite navigation system other than GPS including but not limited to GLONASS, and possible future operational satellite navigation systems.

In the exemplary embodiment, the system of apparatuses may be configured to create a network of arbitrary interconnections to distribute power with reconfigurable access control. FIG. 25 is a diagram illustrating an embodiment of a charging protocol for a network enabled service layer, where two cars 102, 103 and a charge point 101 deliver power to a house 104. Arrows denote the direction of power flow. The network enables at least one user to route power from one or more devices associated with one or more respective apparatus N to one or more other devices also connected in the network. More generally, FIG. 25 is a diagram illustrating a charging protocol according to another embodiment of the present disclosure in which a system comprising a plurality of the apparatus 100 are used to create a network of arbitrary interconnections to distribute power with reconfigurable access control. Accordingly, other combinations of devices are possible, including but not limited to ad-hoc vehicle-to-vehicle, vehicle-to-grid and/or grid-to-vehicle services. The network enabled service may permit a user to take third-party ownership of power and implement various charging policies, as well as providing infrastructure access and including advanced queuing policies. For example, this would allow an owner of a motor vehicle connected to the system to sell power from their car to the national grid or to the owner of an electrical device connected to the system. In embodiments of the present disclosure, charging and queuing policies selectable by the owner may work in conjunction with, or override, those policies outlined above.

FIG. 26 is a diagram illustrating a network layer architecture of the system, according to an embodiment of the present disclosure. Referring to FIG. 26, multiple layers including a user layer, platform layer, network layer and physical layer are developed on top of each other to provide modularity and flexibility to the system. That is, each layer can be modified independently from all the other layers.

FIG. 27 is a block diagram illustrating a configuration of a computing device 900 which includes various hardware and software components that function to perform processes according to the present disclosure. The computing device 900 corresponds to the computing device 900 of the apparatus 100 of FIG. 1, configured to route power from the one or more inlet port(s) to the at least two outlet ports. Referring to FIG. 27, the computing device 900 comprises a user interface 910, a processor 920 in communication with a memory 950, and a communication interface 930. The processor 920 functions to execute software instructions that can be loaded and stored in the memory 950. The processor 920 may include a number of processors, a multi-processor core, or some other type of processor, depending on the particular implementation. The memory 950 may be accessible by the processor 920, thereby enabling the processor 920 to receive and execute instructions stored on the memory 950. The memory 950 may be, for example, a random access memory (RAM) or any other suitable volatile or non-volatile computer readable storage medium. In addition, the memory 950 may be fixed or removable and may contain one or more components or devices such as a hard drive, a flash memory, a rewritable optical disk, a rewritable magnetic tape, or some combination of the above.

One or more software modules 960 may be encoded in the memory 950. The software modules 960 may comprise one or more software programs or applications having computer program code or a set of instructions configured to be executed by the processor 920. Such computer program code or instructions for carrying out operations for aspects of the systems and methods disclosed herein may be written in any combination of one or more programming languages.

The software modules 960 may include at least a first application 961 and a second application 962 configured to be executed by the processor 920. During execution of the software modules 960, the processor 920 configures the computing device 900 to perform various operations relating to the embodiments of the present disclosure, as has been described above.

Other information and/or data relevant to the operation of the present systems and methods, such as a database 970, may also be stored on the memory 950. The database 970 may contain and/or maintain various data items and elements that are utilized throughout the various operations of the system described above, including but not limited to the behavior ranking system described in relation to charging protocols. It should be noted that although the database 970 is depicted as being configured locally to the computing device 900, in certain implementations the database 970 and/or various other data elements stored therein may be located remotely. Such elements may be located on a remote device or server—not shown, and connected to the computing device 900 through a network in a manner known to those skilled in the art, in order to be loaded into a processor and executed.

Further, the program code of the software modules 960 and one or more computer readable storage devices (such as the memory 950) form a computer program product that may be manufactured and/or distributed in accordance with the present disclosure, as is known to those of skill in the art.

The communication interface 940 is also operatively connected to the processor 920 and may be any interface that enables communication between the computing device 900 and other devices, machines and/or elements. The communication interface 940 is configured for transmitting and/or receiving data. For example, the communication interface 940 may include but is not limited to a Bluetooth, or cellular transceiver, a satellite communication transmitter/receiver, an optical port and/or any other such, interfaces for wirelessly connecting the computing device 900 to the other devices.

The user interface 910 is also operatively connected to the processor 920. The user interface may comprise one or more input device(s) such as switch(es), button(s), key(s), and a touchscreen.

The user interface 910 functions to facilitate the capture of commands from the user such as on-off commands or settings related to the operation of the system described above. The user interface 910 may function to issue remote instantaneous instructions on images received via a non-local image capture mechanism.

A display 912 may also be operatively connected to the processor 920. The display 912 may include a screen or any other such presentation device that enables the user to view various options, parameters, and results. The display 912 may be a digital display such as an LED display. The user interface 910 and the display 912 may be integrated into a touch screen display.

The operation of the computing device 900 and the various elements and components described above will be understood by those skilled in the art with reference to the apparatus 100 and system according to the present disclosure.

In the field of electric vehicle charging, a problem has been identified in which malicious or negligent individuals may prematurely remove charging cables from vehicles while they are awaiting their turn to charge or before the charging session is complete. This issue may not only disrupt the intended charging process, but may also pose safety hazards, because it can lead to electrical malfunctions, equipment damage, and potential injuries to both users and bystanders. The premature removal of charging cables may not only impede the efficient operation of electric vehicle charging stations, but may also result in financial losses for electric vehicle charging providers and inconvenience for electric vehicle owners.

The problem of premature removal of charging cables may also apply when a vehicle is connected to a charging system for a charging session, but the charging session has not yet begun. For example, there may be multiple cars plugged into a charging system for charging. However, the charging system may only be configured or otherwise able to charge one vehicle at a time or less than all of the vehicles that are connected to the charging system. The charging system may create a queue in which the charging system charges a subset of connected vehicles until the vehicles are sufficiently charged and then begin charging another subset of connected vehicles. An unscrupulous or mischievous bad actor could jump the last car in the queue to the front of the queue by disconnecting all of the other queuing cars. Accordingly, there is a need for a system in which only an authorized person (e.g., a car owner or the owner of the charging system) can disconnect a car from the charging system.

A charging system implementing the systems and methods described herein can overcome the aforementioned problem of bad actors removing charging cables from vehicles or apparatuses. For example, an apparatus of the charging system can include a processor and a network interface that can communicate with an electronic device (e.g., a computer or a computing device, such as a mobile phone or a laptop, or a fob) a computer owned by an individual that is charging their vehicle at the apparatus. Through the communication and/or memory, the apparatus can authenticate the individual to determine whether the individual has a user account to enable the apparatus to charge the individual's vehicle. After authenticating the individual, the individual can request for the apparatus to lock or unlock the charging cable connecting the vehicle with the apparatus for charging. The apparatus may lock or unlock the charging cable to the apparatus according to the requests based on the user being authenticated, thus reducing the ability of individuals (e.g., unauthorized individuals) who are passing by and may not have an account with the charging system or other unauthorized individuals to remove the cable from the apparatus.

In some cases, the apparatus can implement a second layer of security. For example, the apparatus may only control the locking or unlocking of the cable to the apparatus from the individual responsive to determining whether the individual is authorized to make such requests. The apparatus can determine if the individual is authorized to make locking or unlocking requests responsive to determining whether the individual is associated with the charging session charging the vehicle or otherwise associated with the vehicle (e.g., by determining the request to lock or unlock the cable from the apparatus originated from the same user account as the user account that initiated the charging session). An individual can be registered with the charging system, but may not be authorized to unlock and/or lock all, some, or any vehicles. The apparatus may only lock or unlock the cable to the apparatus responsive to requests by individuals that the apparatus determines are authorized to make such requests. Accordingly, the apparatus may further reduce the opportunity for bad actors that may have accounts with the charging system from removing cables from charging sessions before the charging sessions are complete.

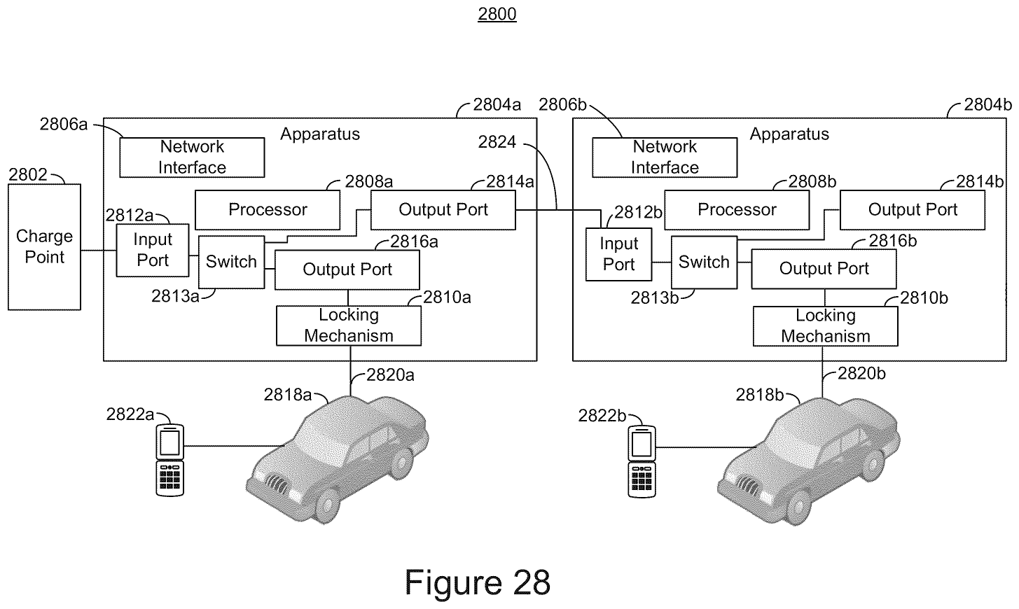

FIG. 28 is a block diagram illustrating a system 2800 for charging vehicles with a daisy chain configuration, according to an embodiment of the present disclosure. In brief overview, the system 2800 can include a charge point 2802 and apparatuses 2804a and 2804b (separately, the apparatus 2804, and together, the apparatuses 2804). The charge point 2802 can be the same as or similar to the charge point 101, shown and described herein. The apparatuses 2804a and 2804b can each be the same as the apparatus 100, shown and described herein. The charge point 2802 can be configured to provide power or voltage to the apparatuses 2804. The apparatuses 2804 can be configured to direct power from or towards the charge point 2802 to or from vehicles or other types of apparatuses that connect with the respective apparatuses 2804 through cables or other types of charging devices or components. The apparatuses 2804 can lock or tether (e.g., fasten) the cables to the apparatuses 2804 to which the cables are connected, in some cases with or without providing power to the vehicles or apparatuses.

The apparatuses 2804 can respectively include network interfaces 2806a and 2806b, processors 2808a and 2808b, locking mechanisms 2810a and 2810b, input ports 2812a and 2812b, output ports 2814a and 2814b, and output ports 2816a and 2816b. The network interfaces 2806a and 2806b can each be or include components that enable communication over a network. For example, the network interfaces 2806a and/or 2806b can be or include an ethernet network interface, a wireless network interface, a Bluetooth network interface, a cellular network interface, a loopback network interface, a FireWire network interface, an InfiniBand network interface, a fiber channel network interface, a token ring network interface, etc. The network interfaces 2806a and/or 2806b can be or include antennas, adaptors, or cards to enable such communication. In one example, the network interfaces 2806a and/or 2806b can be or include a chip (e.g., a yellow-beet-e 1.1 (EVSE) module) that implements powerline communication and that is used to enable “high level” communication between the apparatuses 2804 and vehicles. The network interfaces 2806a and/or 2806b can be used to connect with the Internet. In some cases, the network interfaces 2806a and/or 2806b can be used to communicate over physical cables, such as over cables between the apparatuses 3004 and/or the charge point 3002. The network interfaces 2806a and/or 2806b can be used to communicate with any device. The apparatuses 2804 can communicate with each other, a remote server, and/or the charge point 2802 via the network interfaces 2806a and/or 2806b. The apparatuses 2804 can each include a housing (e.g., an enclosed shell) in which the components 2810a-2816b are respectively located.

The processors 2808a and 2808b may be or include an ASIC, one or more FPGAs, a DSP, circuits containing one or more processing components, circuitry for supporting a microprocessor, a group of processing components, or other suitable electronic processing components. In some embodiments, the processors 2808a and 2808b may execute computer code or modules (e.g., executable code, object code, source code, script code, machine code, etc.) stored in the memory of the apparatuses 2804 to facilitate the activities described herein. The memory may be any volatile or non-volatile computer-readable storage medium capable of storing data or computer code. The memory may be or include non-transitory memory.

The input ports 2812a and 2812b and the output ports 2814a, 2814b, 2816a, and 2816b can operate or be configured within the apparatuses 2804 to receive and/or direct power to different destinations. For example, the input ports 2812a and 2812b can operate as entry points to receive power or energy from the charge point 2802 or other external power sources. The input ports 2812a and 2812b can direct power to the output ports 2814a, 2814b, 2816a, and 2816b through internal cables and/or switches of the respective apparatuses 2804 in which the ports 2812a, 2812b, 2814a, 2814b, 2816a, and 2816b are located. The output ports 2814a, 2814b, 2816a, and 2816b can connect with different cables or otherwise different devices to direct power to or through the cables or devices.

The apparatuses 2804 can be connected to the charge point 2802 in a daisy chain configuration. For example, only the apparatus 2804a may be directly connected with the charge point 2802 (e.g., connected with a cable from the input port 2812a to the charge point 2802). The apparatus 2804a may direct energy from the output port 2814a to the input port 2812b of the apparatus 2804b with a cable 2824 such that the apparatus 2804b can receive power from the charge point 2802 without being directly connected with the charge point 2802. The apparatus 2804b can then in turn direct power received from the apparatus 2804a. Any number of apparatuses can be connected with each other in this manner to create or form a daisy chain of apparatuses that can receive power from the charge point 2802 when only one apparatus is directly connected with the charge point 2802.

The apparatuses 2804 can be configured to charge or otherwise provide power to vehicles or other types of apparatuses. For example, a vehicle 2818a may be connected to the output port 2816a of the apparatus 2804a and a vehicle 2818b may be connected to the output port 2816b of the apparatus 2804b. The vehicle 2818a may be connected to the output port 2816a through a cable 2820a. The apparatus 2804a may direct power from the input port 2812a to the output port 2816a and then to the vehicle 2818a through the cable 2820a. The apparatus 2804b can similarly provide power to the vehicle 2818b through a cable 2820b. In some embodiments, the power flow can be in a vehicle-to-everything (V2X) configuration in which vehicles connected to the apparatuses direct power to the apparatuses 2804. The apparatuses 2804 can forward the power to the charge point 2802, the grid, or another load or destination.

In one example, the input ports 2812a and 2812b can direct power to the output ports 2814a, 2814b, 2816a, and 2816b through respective switches 2813a and 2813b. For example, upon initiating a charging session between the apparatus 2804a and a vehicle, the processor 2808a can communicate with the switch 2813a to connect the output port 2816a to the input port 2812a such that the energy provided through the input port 2812a is output from the output port 2816a to the vehicle being charged in the charging session. In doing so, the processor 2808a can cause the switch to disconnect the input port 2812a from the output port 2814a. When the apparatus 2804a is not charging a vehicle in a charging session, the processor 2808a can control the switch 2813a to connect the input port 2812a with the output port 2814a and not the output port 2816a. Accordingly, the switch 2813a can be configured such that energy can only travel from the input port 2812a to one of the output ports 2814a or 2816a at a time, such as based on whether the apparatus 2804a is currently charging a vehicle (e.g., in a charging session with a vehicle). The apparatus 2804b can be similarly configured. In some cases, each connected apparatus 2804 can be configured in this manner such that only one vehicle connected to the charge point 2802 (e.g., directly connected to the charge point 2802 or connected to the charge point 2802 through another apparatus 2804) may charge at a time.

In some embodiments, the switch 2813a can be configured such that the input port 2812a can be connected with the output ports 2814a and 2816a concurrently. Each apparatus 2804 connected with the apparatus 2804a can be configured in the same or a similar manner. In such a configuration, the charge point 2802 connected with the apparatuses 2804 can charge multiple vehicles connected with the charge point 2802 at once. The processors 2808 of the apparatuses 2804 can communicate with each other to determine the configurations of the switches 2813 that the processors 2808 respectively control (e.g., to make sure only one or a defined number of switches 2813 connect an input port 2812 to an output port 2816 for charging a vehicle, which may be based on arrival time, charge amount needed, or any other metrics corresponding to the connection with a vehicle or the state of the vehicle itself).

The locking mechanisms 2810a and 2810b can respectively lock or tether (e.g., fasten) the cables 2820a and 2820b to the output ports 2816a and 2816b and/or to the vehicles 2818a and 2818b. The locking mechanisms 2810a and 2810b can be the same as or similar to the locking mechanism 116, shown and described herein. The locking mechanisms 2810a and 2810b can respectively be or include, for example, one or more locking clips or latches, screw locks, bayonet locks, push-pull locks, magnetic locks, keyed locks, tamper-evident locks, etc. In some embodiments, the locking mechanisms 2810a and 2810b can include a communications interface to communicate (e.g., via the cables 2820a and 2820b, respective, or wirelessly) with vehicles. The locking mechanisms 2810a and 2810b can transmit instructions that cause the vehicles to lock the cables 2820a and 2820b, respectively to the vehicles to which the cables 2820a and 2820b are connected. When activated, the locking mechanisms 2810a and 2810b can stop the cables 2820a and 2820b from being removed from the apparatus 2804 and/or from being disconnected from the output ports 2816a and 2816b and/or from the vehicles 2818a and/or 2818b. The processors 2808a and 2808b can respectively control the locking mechanisms 2810a and 2810b to lock (e.g., activate) and/or unlock (e.g., deactivate) the locking mechanisms 2810a and 2810b. The locking mechanisms 2810a and/or 2810b can stop bad actors from disconnecting the cables 2820a and/or 2820b from the apparatus 2804a and/or 2804b, such as to restrict the bad actors from stopping a charging session or to disrupt a charging queue. In some embodiments, the cables 2820a and 2820b may be permanently affixed or connected to the apparatuses 2804a and 2804b, respectively.

The apparatuses 2804 can be configured to only allow authorized users of devices to control the locking mechanisms 2810a and/or 2810b. For example, via the processors 2808a and 2808b and the network interfaces 2806a and 2806b, the apparatuses 2804 can respectively communicate with different computing devices, such as electronic devices 2822a and 2822b. The electronic devices 2822a and 2822b can each respectively include a processor and memory to process an application that is configured to communicate with apparatuses such as the apparatuses 2804. The electronic devices 2822a and 2822b can execute the application to transmit a locking or an unlocking request to the apparatuses 2804 to cause the apparatuses 2804 to lock or unlock the locking mechanisms 2810a and/or 2810b of the respective apparatuses 2804.

In some embodiments, the locking mechanisms 2810a and/or 2810b can include an electronic readers that can authorize users to lock and/or unlock. The electronic readers can be configured to detect fobs for authorization. For example, a user can hold or have a fob that communicates with one or more both of the locking mechanisms 2810a and/or 2810b via radio frequency identification (RFID) or near-field communication (NFC). When the fob is within a certain range, it sends a unique signal to the electronic readers. The electronic readers can then verify the signal and grant access to remove or attach the cables 2820a and/or 2820b if the credentials match. For example, the locking mechanisms 2810a and/or 2810b may lock and/or unlock (e.g., automatically lock and/or unlock) responsive to detecting a fob that transmits a signal to the locking mechanisms 2810a and/or 2810b. In doing so, the locking mechanisms 2810a and/or 2810b may lock the cables 2820a and/or 2820b to the apparatuses 2804a and/or 2804b and/or unlock the cables 2820a and/or 2820b such that the cables 2820a and/or 2820b can be removed from the apparatuses 2804a and/or 2804b.

The electronic devices 2822a and/or 2822b can be or include any computer that is configured to receive, transmit, and/or process data. For example, the electronic devices 2822a and/or 2822b can be a laptop, desktop, tablet, personal digital assistant, smartphone, portable computer, or speaker. The electronic devices 2822a and/or 2822b can include or utilize at least one processing unit or other logic devices such as a programmable logic array engine or a module configured to communicate with one another or other resources or databases. The components of the electronic devices 2822a and/or 2822b can be separate components or a single component.

A user may access the electronic devices 2822a and/or 2822b to lock and/or unlock the locking mechanisms 2810a and/or 2810b. For example, the electronic device 2822a can execute an application that facilitates communication with the apparatus 2804a through the network interface 2806a of the apparatus 2804a. The electronic device 2822a can pair with the apparatus 2804a, such as by using a handshaking protocol or other type of protocol that creates a communication session or link between the electronic device 2822a and the apparatus 2804a. The user can select an option on the application to transmit a signal to the apparatus 2804a to cause the locking mechanism 2810a to lock or unlock the cable 2820a. The electronic device 2822a can transmit the signal to the apparatus 2804a over the communication channel responsive to receiving the selection of the option. Responsive to receiving the message, the processor 2808a of the apparatus 2804a can process the request and control the locking mechanism 2810a to lock or unlock the cable 2820a from the locking mechanism 2810a according to the request. When applicable, in doing so, the user can control whether the cable 2820a can be removed from the apparatus 2804 or not, which may be useful when the user owns the cable 2820a and plugs the cable 2820a into the apparatus 2804a to charge the vehicle 2818a. The locking and unlocking requests can stop the cable 2820a from being removed from the apparatus 2804a or the vehicle 2818a during undesirable times, such as while awaiting or during a charging session.

In some embodiments, the processor 2808a may only lock or unlock the locking mechanism 2810a responsive to authenticating the user of the electronic device 2822a. For example, responsive to pairing with the electronic device 2822a, the processor 2808a can receive an authentication request from the electronic device 2822a. The authentication request can be a request to access the application executing on the electronic device 2822a or otherwise communicate with the processor 2808a to perform a charging session. The authentication request can include authentication credentials (e.g., username and password). The processor 2808a can receive the authentication request and match the authentication credentials with stored authentication credentials for different user accounts. Responsive to identifying a match (e.g., identical values), such as after hashing all or a portion (e.g., a password) of the authentication credentials, the processor 2808a can authenticate the user accessing the electronic device 2822a. The processor 2808a may do so by transmitting a message to the electronic device 2822a indicating the authentication and/or the user account that was authenticated. The user can select an option from the application to transmit a locking or unlocking request message to the processor 2808a responsive to being authenticated (e.g., responsive to the electronic device 2822a receiving the message from the processor 2808a). Responsive to receiving the selection of the option, the electronic device 2822a can transmit a locking or unlocking request to the apparatus 2804a, and the processor 2808a can lock or unlock the locking mechanism 2810a accordingly.

In some embodiments, the processor 2808a may only lock or unlock the locking mechanism 2810a responsive to determining the user of the electronic device 2822a is authorized to lock or unlock the locking mechanism 2810. The processor 2808a may determine the user is authorized, for example, based on whether the user corresponds to the device or apparatus (e.g., the vehicle 2818a) being charged or connected with the apparatus 2804a. For example, when the user connects the vehicle 2818a with the apparatus 2804a, the apparatus 2804a may communicate with the electronic device 2822a to authenticate the user and/or initiate the charging session. The apparatus 2804a may also lock the locking mechanism 2810a, either automatically based on initiating the charging session or responsive to receiving a locking request from the electronic device 2822a. The processor 2808a can store a record (e.g., a file or a table) of the charging session in memory that includes an identifier of the user account of the user that initiated the charging session corresponds with the charging session, the vehicle 2818a, and/or the apparatus 2804a. In some embodiments, the processor 2808a can transmit, via the network interface 2806a, the record of the charging session to a remote server (e.g., a cloud-based server or an on-site server), and the remote server can store the record in a database in memory of the remote server. Upon completing the charging session, the electronic device 2822a can transmit a request to the apparatus 2804a to unlock the locking mechanism 2810a. The request can contain an identifier of the user account accessed through the electronic device 2822a. Responsive to receiving the request, the apparatus 2804a may identify the identifier of the user account from the request and compare the identifier with the identifier of the user account stored in the record for the charging session. Responsive to determining the identifiers match (e.g., are identical), the processor 2808a can unlock the locking mechanism 2810a. However, responsive to determining the identifiers do not match, the apparatus 2804a can transmit a message to the electronic device 2822a indicating the user is not authorized to unlock the locking mechanism 2810a (e.g., not authorized to access the apparatus 2804a). The apparatus 2804b can similarly operate to authenticate and/or authorize locking and/or unlocking of the locking mechanism 2810b based on requests from the electronic device 2822b. Using authentication and authorization techniques in this way can restrict unauthorized individuals from stopping incomplete charging sessions and/or from stealing cables connected to the apparatuses 2804. Additionally, the authentication and authorization techniques can restrict or stop unauthorized queue jumping.

In some embodiments, the locking mechanism 2810a or another locking mechanism of the apparatus 2804 can similarly lock the cable 2824 connecting the output port 2814a with the input port 2812b of the apparatus 2804b. In some such embodiments, the locking mechanism 2810a may be controlled by a user account of an administrator of the daisy chain instead of user accounts associated with vehicles being charged by the daisy chain of apparatuses. The administrator may adjust whether the locking mechanism 2810a locks or tethers the cable 2824 to the output port 2814a responsive to being authenticated and/or authorized by the apparatus 2804a. In some embodiments, the locking mechanism 2810b or a different locking mechanism of the apparatus 2804b can lock or tether the cable 2824 to the input port 2812b. In such embodiments, the locking mechanism 2810b may be controlled by the user account of the administrator of the daisy chain instead of user accounts associated with vehicles being charged by the daisy chain of apparatuses. The administrator may adjust whether the locking mechanism 2810b locks or tethers the cable 2824 to the input port 2812b responsive to being authenticated and/or authorized by the apparatus 2804b. Cables between any number of apparatuses of the daisy chain of apparatuses can be locked into place in this way. Doing so can stop bad actors from disrupting charging by the daisy chain of apparatuses. In some embodiments, the apparatuses 2804a and 2804b can be permanently affixed or connected to each other with no ability to disconnect the cable 2824 from either of the respective apparatuses 2804a or 2804b without excess force.

In some embodiments, the apparatuses 2804a and 2804b can be connected and/or disconnected from each other by a vehicle owner. Such may be the case, for example, when the vehicle owner owns the apparatus 2804b and connects the apparatuses 2804b to the apparatus 2804a through the cable 2824 for a charging session. In such embodiments, the vehicle owner may disconnect the apparatus 2804b they own from the cable 2824 by communicating with the apparatus 2804b with the electronic device 2822b for authentication. Responsive to a successful authentication (e.g., with the apparatus 2804b), the user can provide an input into the electronic device 2822b to unlock the apparatus 2804b from the cable 2824 such that the apparatus 2804b can be removed or disconnected from the cable 2824. Thus, the user can remove the apparatus 2804b from the cable 2824.

In some embodiments, the apparatuses 2804 can be configured to direct energy from vehicles to other apparatuses and/or to other loads (e.g., enable a vehicle-to-everything (V2X) charging configuration). For example, the vehicle 2818a can connect with the apparatus 2804a. Instead of requesting to receive energy or power from the apparatus 2804a, the vehicle 2818a or the electronic device 2822a can request for the vehicle 2818a to provide energy or power to the apparatus 2804a. The vehicle 2818a can direct energy from the battery of the vehicle 2818a to the apparatus 2804a. Responsive to receiving the request from the vehicle 2818a and/or the energy or power from the vehicle 2818a, the apparatus 2804a can propagate the energy or power to other apparatuses 2804 to use to charge vehicles connected with the apparatuses 2804 of the daisy chain and/or to the charge point 2802. In some embodiments, the apparatus 2804a can propagate the power to the other apparatuses 2804 responsive to determining vehicles or other apparatuses are connected to the other apparatuses 2804 and/or propagate the power to the charge point 2802 responsive to determining no vehicles are connected to any other apparatuses 2804 of the daisy chain. In some embodiments, the apparatuses 2804 can propagate power to the charge point 2802 when one or more vehicles are connected with the apparatuses 2804, such as in response to a command or request from a remote server or computer.

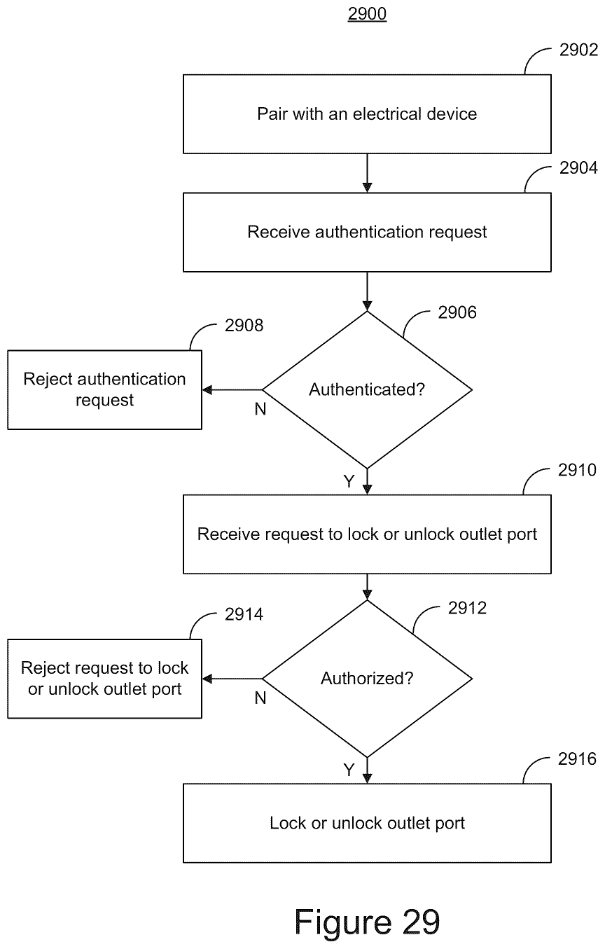

FIG. 29 is a flowchart illustrating a method 2900 for locking and unlocking vehicles in a system with a daisy chain configuration, according to an embodiment of the present disclosure. The method 2900 can be performed by an apparatus (e.g., the apparatus 2804). The apparatus can be connected to a charge point (e.g., an energy source) and/or one or more other similarly configured apparatuses. The apparatus can be configured to charge an apparatus, such as a vehicle, through an output port with energy received from the charge point through an input port of the apparatus. The apparatus may lock a cable to the apparatus through a locking mechanism. The apparatus can control whether the locking mechanism is locked or unlocked based on messages received from an electronic device configured to control or monitor a charging session between the apparatus and a vehicle, for example. The apparatus may restrict unauthorized individuals from disconnecting the cable facilitating energy transfer from the apparatus to the vehicle by only allowing authenticated and/or authorized individuals to control whether the locking mechanism of the apparatus is locked or unlocked.

At operation 2902, the apparatus pairs with an electronic device. The apparatus may pair with the electronic device responsive to a user accessing the electronic device connecting a vehicle or another type of apparatus with the apparatus for charging. In some embodiments, the apparatus may pair with the electronic device responsive to receiving a request to establish a communication session from the electronic device. Responsive to receiving the request, the apparatus may perform a handshaking protocol with the electronic device to connect with the electronic device and/or provide a platform to the user of the electronic device to control the charging session. The apparatus may provide the platform to the user through an application executing on the electronic device.

At operation 2904, the apparatus receives an authentication request. The apparatus can receive the authentication request from the electronic device. The apparatus can receive the authentication request from the application executing on the electronic device with which the apparatus paired. The authentication request can include authentication credentials of a user account, such as a username and password.

At operation 2906, the apparatus can determine whether the user of the electronic device is authenticated. The apparatus can determine whether the user is authenticated based on the authentication credentials in the authentication request. To do so, the apparatus can compare the authentication credentials with authentication credentials of different user accounts stored in a database. In some embodiments, the apparatus may store hashes of passwords in the database. In such embodiments, the apparatus can hash the password of the received authentication credentials and compare the hashed password to password hashes in the databases. Responsive to determining there are not any matching authentication credentials in the database, at operation 2908, the apparatus rejects the authentication request. The apparatus may do so by transmitting a message to the electronic device indicating the authentication failed, for example. However, responsive to identifying matching credentials with a user account in the database, the apparatus can authenticate the user, such as by transmitting a message to the electronic device to grant access to the platform through the application executing on the electronic device.

Through the platform, the user can control a charging session with the apparatus. For example, the user can select options on the application to communicate with the apparatus to initiate a charging session in which the apparatus provides power to the apparatus or vehicle that the user has connected with the apparatus. The apparatus can provide the power through a cable or a wireless charging device connected with the apparatus through a cable. The apparatus can automatically lock the cable for charging the apparatus with the apparatus or vehicle responsive to initiating the charging session or the user can request to lock or unlock the cable through the electronic device, such as through the application after being authenticated, and the apparatus can lock or unlock the cable responsive to receiving the request. By locking the cable, the apparatus can restrict the cable from being disconnected from the apparatus.

The apparatus can store a record of the charging session in memory and/or communicate with a remote database (e.g., in the remote server). The record can be a file or table that includes data for the charging session, such as a session identifier (which the apparatus may generate upon initiating the charging session), an identifier of the user account that was used to initiate the charging session, an amount of power or energy, state of charge, and/or battery capacity that the apparatus provided the vehicle or apparatus being charged by the apparatus. The apparatus can generate and/or store the record in memory in response to initiating the charging session. The apparatus can add values indicating the amount of power or energy the apparatus provided the apparatus or vehicle upon completion of the charging session.

At operation 2910, the apparatus receives a request to lock or unlock the outlet port (e.g., lock or unlock the cable connected to the outlet port). The apparatus can receive the request from an electronic device (e.g., the same electronic device that was used to initiate the charging session) being accessed by an individual associated with a user account on the platform of the apparatus. The request can include an identifier (e.g., a numerical or alphanumerical string) of the user account through which the electronic device transmitted the request. The electronic device may transmit such a request responsive to determining to stop an ongoing charging session or determining that the charging session has ended.

At operation 2912, the apparatus determines the electronic device, user account, and/or user that transmitted the request to the apparatus is authorized to lock or unlock the outlet port. The apparatus can determine the authorization based on the identifier of the user account in the request to lock or unlock the outlet port. For example, responsive to receiving the request to lock or unlock the outlet port, the apparatus can extract or identify the identifier of the user account from the request. The apparatus can compare the identifier with the identifier of the user account in the record for the current charging session. Responsive to determining the identifiers do not match, at operation 2914, the apparatus rejects the request to lock or unlock the outlet port. The apparatus may do so by transmitting a message to the electronic device indicating the user is not authorized to lock or unlock the outlet port, for example.

Responsive to identifying matching identifiers between the user accounts, at operation 2916, the apparatus can lock or unlock the outlet port. Upon unlocking the outlet port, the user can remove the cable from the apparatus or the outlet port. Upon locking the outlet port, the user may be restricted from removing the cable from the apparatus or the outlet port.

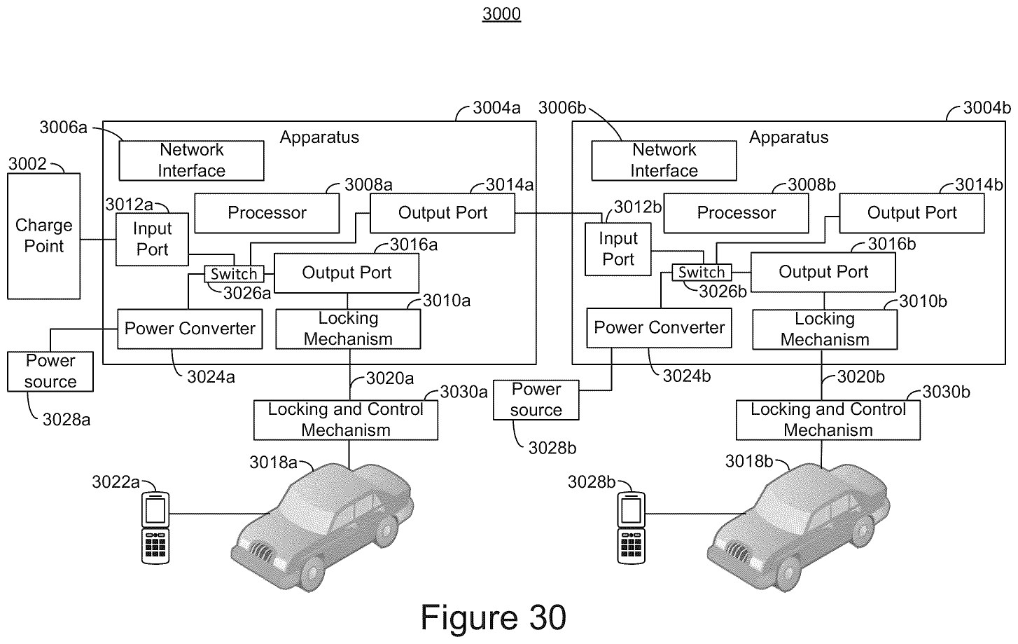

FIG. 30 is a block diagram illustrating a locking protocol for a system 3000 for charging vehicles in a daisy chain configuration, according to an embodiment of the present disclosure. In brief overview, the system 3000 can include a charge point 3002 and apparatuses 3004a and 3004b (separately, the apparatus 3004, and together, the apparatuses 3004). The charge point 3002 can be the same as or similar to the charge point 101, shown and described herein, and/or the charge point 2802, shown and described with reference to FIG. 28. The apparatuses 3004a and 3004b can each be the same as the apparatus 100, shown and described herein, and/or the apparatuses 2804, shown and described with reference to FIG. 28. The charge point 3002 can be configured to provide power or voltage (e.g., direct current (DC) power or voltage or alternating current (AC) power or voltage) to the apparatuses 3004. The apparatuses 3004 can be configured to direct power from the charge point 3002 or from power sources 3028a and/or 3028b (e.g., separate batteries or connections to an electric grid) to vehicles or other types of apparatuses that connect with the respective apparatuses 3004 through cables or other types of charging devices. The apparatuses 3004 can lock or tether the cables to the apparatuses 3004 to which the cables are connected and/or the vehicles or apparatuses can lock or tether the cables to the connection points on the vehicles or apparatuses.

The apparatuses 3004 can respectively include network interfaces 3006a and 3006b, processors 3008a and 3008b, locking mechanisms 3010a and 3010b, inputs ports 3012a and 3012b, output ports 3014a and 3014b, and output ports 3016a and 3016b. Each of the components 3006a-3016b can be the same as or similar to the corresponding components of the apparatuses 2804, shown and described with reference to FIG. 28. The apparatuses 3004 can additionally respectively include power converters 3024a and 3024b and switches 3026a and 3026b. The power converters 3024a and 3024b can be direct current-to-direct current (DC-to-DC) converters, alternating current-to-alternating current (AC-to-AC), direct current-to-alternating current (DC-to-AC), and/or alternating current-to-direct current (AC-to-DC) converters configured to adjust (e.g., increase or decrease) the voltage of power or current received from the power sources 3028a and 3028b. In some embodiments, the power sources 3028a and 3028b can be the same power source or component. The power sources 3028a and 3028b can provide voltages of 60 Vdc, 350 Vdc, 110 Vac, 230 Vac, etc. The switches 3026a and 3026b can be switches configured to selectively couple the power converters 3024a or 3024b or the input ports 3012a or 3012b to the respective output ports 3016a or 3016b. In some cases, the switches 3026a and 3026b can directly connect with the power sources 3028a and 3028b instead of connecting with the power converters 3024a and 3024b, thus conserving the number of components or devices within the apparatuses 3004a and 3004b. The processors 3008a or 3008b can transmit signals to the switches 3026a or 3026b to control the position or state of the switches 3026a or 3026b.

The apparatuses 3004 can be configured to charge or otherwise provide power to vehicles or other types of apparatuses. For example, a vehicle 3018a may be connected to the output port 3016a of the apparatus 3004a and a vehicle 3018b may be connected to the output port 3016b of the apparatus 3004b. The vehicle 3018a may be connected to the output port 3016a through a cable 3020a. The apparatus 3004 may direct power from the input port 3012a to the output port 3016a and then to the vehicle 3018a through the cable 3020a. The apparatus 3004b can similarly provide power to the vehicle 3018b through a cable 3020b.

The apparatuses 3004 can cause the vehicles 3018a and 3018b to lock or tether to cables 3020a or 3020b, or prevent the release of such lock or tether if previously activated, such that the cables 3020a or 3020b cannot be removed from the vehicles 3018a or 3018b. The apparatuses 3004 can do so in a few manners. For example, when the apparatuses 3004 provide power or energy to the vehicles 3018a or 3018b in a charging session, the establishment of the respective charging sessions may cause the vehicles 3018a or 3018b to lock or tether to the cables 3020a or 3020b in place such that the cables 3020a or 3020b cannot be removed from the vehicles 3018a or 3018b. Doing so can stop bad actors from removing the cables during a charging session or to otherwise keep the cables 3020a or 3020b for a proper charging session.

In another example, the apparatuses 3004 can cause the vehicles 3018a or 3018b to lock or tether the respective cables 3020a or 3020b when the apparatuses 3004 are not providing power or energy to the vehicles 3018a or 3018b. The apparatuses 3004 can do so by applying a voltage (e.g., a voltage from the power sources 3028a and 3028b and increased or decreased by the respective converters 3024a and 3024b) across the cables 3020a or 3020b without providing power or energy to the vehicles 3018a or 3018b. The voltage can cause the vehicles 3018a or 3018b to lock or tether to the cables 3020a or 3020b such that the cables 3020a or 3020b cannot be removed from the vehicles 3018a or 3018b. Accordingly, the apparatuses 3004 can simulate a charging session to the vehicles 3018a or 3020b to keep the cables 3020a or 320b from being removed from the vehicles 3018a or 3018b even without provisioning power (e.g., without provisioning a significant amount of power for charging) to the vehicles 3018a or 3018b.

As described herein, a simulated charging session can be a charging session in which power, voltage, and/or current is provided to a vehicle with the purpose of or with the intent to cause the vehicle to lock to a cable connecting the vehicle to an apparatus without actively charging the vehicle. Simulated charging sessions can involve providing a minimal amount of voltage, current, and/or power to a vehicle through a cable that causes the vehicle to lock to the cable, but not enough voltage, current, and/or power to charge the vehicle within a reasonable amount of time (e.g., less than 12 hours). In contrast, a charging session or active charging session can be a charging session in which power is provided to a vehicle with the purpose of or intent to actively charge the vehicle.

In one example, simulating a charging session can mean to apply 60V to a vehicle through the cable to cause the vehicle to lock to the cable. The 60V locking approach can rely on an aspect of the IEC 61851 car charging standard in which vehicle connectors (e.g., vehicle charging guns inserted into vehicles) must remain locked to the vehicles when a “hazardous” voltage is detected through the charging process, including after the end of the vehicle charging session.

In some cases, a simulated charging session can involve an apparatus 3004 communicating with a vehicle. For example, the apparatus 3004a can communicate with the vehicle 3018a using a charging communication protocol used in vehicle charging, such as, but not limited to, pulse-width modulation and powerline communication (e.g., ISO15118, IEC61851, SAE J1772, etc.). The apparatus 3004a can communicate with the vehicle 3018a in this manner in response to the cable 3020a being connected with an inlet port of the vehicle 3018a, for example. Based on the communication, in some cases in combination with providing a defined or minimum voltage or amount of power, the vehicle can activate the locking and control mechanism 3030a to the cable 3020a, locking the cable 3020a to the inlet port of the vehicle 3018a. In doing so, in some cases, the apparatus 3004a may not provide, or may provide a minimal amount of, power or voltage to the vehicle 3018a. Thus, the apparatus 3004a can simulate a charging session with the vehicle 3018a with the communication and without providing any power, only a minimal amount of power, to the vehicle 3018a.

In one example, an apparatus 3004 can use a combined charging system (CCS) protocol to simulate a charging session. The CCS protocol can involve basic signaling for AC charging and high level communication for DC and/or AC charging. When using basic signaling, the apparatus 3004 can put a 12V DC voltage on a CP line of a cable connected with a vehicle. When a vehicle connector connected with the cable is inserted into the vehicle, the CP resistor causes the vehicle to draw current and drop the voltage to 9V at the vehicle (e.g., because of the internal resistance on the apparatus 3004). When the apparatus 3004 identifies or determines that the connector has been inserted, the apparatus 3004 can instantiate a 1 kHz pulse width modulation (PWM) signal on the line. The duty cycle of the PWM signal tells the vehicle the magnitude of AC power the apparatus 3004 can deliver. When the vehicle is ready to charge, the vehicle reduces the resistance at its end of the CP line, causing the voltage to drop to 6V, which tells the apparatus 3004 that the vehicle is ready to charge. When the vehicle determines to stop charging, the vehicle increases the resistance on its end of the CP line, causing the voltage to go back to 9V.

High level communication can be used in addition to or instead of the basic signaling. However, when the apparatus 3004 starts to send the PWM signal, the apparatus 3004 sends the PWM signal with a 5% duty cycle. This signal initiates high-level communication between the vehicle and the apparatus 3004. The apparatus 3004 then communicates (e.g., both ways) with the vehicle by overlaying powerline communication (PLC) in accordance with ISO 15118 on top of the 5% duty cycle. High level communication can be used for either AC or DC charging.

In some cases, an apparatus 3004 can simulate a charging session by beginning an actual charging session with a connected vehicle and applying a charging voltage that the vehicle requests. However, the apparatus 3004 can transmit instructions to the vehicle to draw zero amperes (or the lowest number of amps the vehicle can draw). In response, the vehicle can operate per the instructions and not draw any current but still lock to the cable connecting the apparatus 3004 to the vehicle.

The apparatuses 3004a and 3004b can lock the cables 3020a and 3020b, respectively, to the vehicles 3018a and 3018b through locking and control mechanisms 3030a and 3030b. Although depicted as separate from the vehicles 3018a and 3018b, the locking and control mechanisms 3030a and 3030b can be inside or be or include components of the vehicles 3018a and 3018b, respectively. The locking and control mechanisms 3030a and 3030b can each be or include a communication interface (e.g., a wireless interface), a processor, and a memory configured to communicate with the apparatuses 3004a and 3004b and process information or data received from the apparatuses 3004a and 3004b. The processor, memory, and/or communication interface of the locking and control mechanisms 3030a and 3030b can be parts of or be the controller or central computer of the vehicles 3018a and 318b, in some embodiments. The locking and control mechanisms 3030a and 3030b can each additionally or instead include a means (e.g., a tethering component similar to or the same as the locking mechanism 3010a and 3010b, a latch, a clamp, etc.) for locking the cables 3020a and 3020b to the respective vehicles 3018a and 3018b. The locking mechanisms of the locking and control mechanisms 3030a and 3030b can be located at or in ports (e.g., input ports and/or output ports) of the respective vehicles 3018a and 3018b and be configured to lock the ports to cables (e.g., cables connected to the apparatuses 3004 for charging). The locking and control mechanisms 3030a and 3030b can each be configured to receive and/or detect power, voltage, and/or current (e.g., at least a threshold amount of power, voltage, or current) and lock the cables 3020a and 3020b to the respective vehicles 3018a and 3018b based on the received or detected, power, voltage, and/or current.

For example, the locking and control mechanism 3030b can receive a threshold amount of power, voltage, and/or current (e.g., DC or AC power, voltage and/or current) from the apparatus 3004b in a simulated charging session. The locking and control mechanism 3030b can detect the power, voltage, and/or current through a sensor of the locking and control mechanism 3030b. The locking and control mechanism 3030b can determine the power, voltage, and/or current exceeds at least the threshold amount of power, voltage, and/or current and lock (e.g., automatically lock) the cable 3020b to the vehicle 3018b such that the cable 3020b cannot be removed (e.g., cannot be removed without an excess amount of force) from the vehicle.

In another example, the processors 3008a and 3008b can communicate with the locking and control mechanisms 3030a and 3030b through the network interfaces 3006a and 3006b, respectively, to initiate simulating a charging session. For instance, the processor 3008b can transmit a message to the locking and control mechanism 3030b requesting an amount of voltage, power, and/or current that is needed to lock the locking and control mechanism 3030b of the vehicle 3018b. The processor 3008b can transmit the message, for example, responsive to the vehicle 3018b connecting with the apparatus 3004b through the cable 3020b. The locking and control mechanism 3030b can receive the message from the apparatus 3004b and respond with a voltage, power, and/or current that is required to lock the locking and control mechanism 3030b of the vehicle 3018b. The processor 3008b can receive the message and adjust the configuration of the power converter 3024b to provide the value or values indicated in the response message from the locking and control mechanism 3030b when simulating a charging session with the vehicle 3018b. Thus, the apparatus 3004b can dynamically configure the power converter 3024b to simulate charging sessions for vehicles that have different requirements for locking to cables for charging sessions.

The cables 3020a and 3020b can be locked to the vehicles 3018a and 3018b for AC charging and/or DC charging. For example, in some embodiments, for AC charging, an apparatus 3004 can be configured to provide a voltage (e.g., a defined amount of voltage, such as 230 Vac) and communicate a maximum current a vehicle 3018 should or can draw for a charging session. The vehicle 3018a can start or initiate a charging session and can lock the cable 3020a to the vehicle 3018a via the locking and control mechanism 3030b. In some cases, when multiple apparatuses 3004 are connected together (e.g., in a daisy chain configuration), the apparatuses 3004 connected with the vehicles can transmit a message to the connected vehicles indicating for all but one or two (e.g., a subset of the connected vehicles) to draw zero or a minimum amount of current, thus preventing the charging system of connected apparatuses 3004 from being overloaded from charging too many vehicles. The vehicles may operate according to the messages from the apparatuses 3004. Accordingly, the apparatuses 3004 can simulate charging sessions with the vehicles by providing zero or a minimum current that still causes the vehicles to experience the simulated charging sessions and lock to the cables connecting the vehicles to the respective apparatuses 3004 through the locking and control mechanisms of the vehicles. When a vehicle comes to the “top of the queue” and can start or initiate charging (e.g., actively charging), the apparatus 3004 connected with the vehicle may notify the vehicle (e.g., a locking and control mechanism of the vehicle) that the maximum current has increased or decreased or the apparatus 3004 can initiate a new charging session and charge the vehicle in an actual charging session (e.g., a non-simulated charging session).

In some cases, it is possible to communicate to the vehicle that the charging voltage is available, without actually providing such a charging voltage. These vehicles may lock to the cable in a simulated charging session, based only on this communication. So, if the system is able to identify that the vehicle is one of the vehicles that will do this, the system may rely on this method of locking the cable to the vehicle, thereby avoiding putting voltage on a cable that is not actively delivering power (or only delivering a minimal or nominal amount of power).

In some embodiments, for DC charging, a vehicle 3018 may communicate with an apparatus 3004 with a message indicating how much voltage the vehicle 3018 can receive in a charging session (e.g., 60 Vdc or 350 Vdc). The apparatus 3004 may then transmit a message to the vehicle 3018 indicating that the voltage is available, make the voltage available, and direct the vehicle 3018 to limit its current to a limit of the apparatus 3004 if the apparatus 3004 will charge the vehicle 3018 in an active charging session, or zero or the minimum power limit of the vehicle 3018 if the apparatus 3004 will charge the vehicle 3018 in a simulated charging session. In either case, the vehicle 3018 may lock itself to the cable.

Some vehicles may lock to the cable responsive to receiving a notification that the charging session has begun, even if there is no voltage on the cable connecting the vehicle to the apparatus 3004 connected for charging the vehicle. The apparatus 3004 can identify that a vehicle is one of such vehicles, for example, by communicating with the locking and control mechanism of the vehicle and receiving a message indicating such from the locking and control mechanism of the vehicle. In such cases, the apparatus may transmit a message to the vehicle that causes the vehicle to lock to the cable connecting the vehicle with the apparatus 3004, thereby avoiding putting voltage on a cable that is not actually delivering power.

In some embodiments, an apparatus 3004 can include one or more power sources of different voltages (e.g., AC and/or DC voltages). The one or more power sources can be internal to the apparatus 3004 and/or external to the apparatus 3004 but connected with the apparatus 3004. The switch 3026 of the apparatus 3004 can selectively connect the different power sources with the output port 3016 to simulate charging sessions. The processor 3008 of the apparatus 3004 can determine a position of the switch 3026 by determining a voltage (e.g. a minimum voltage) or other power characteristic (e.g., minimum power or current) that is needed to simulate a charging session for a connected vehicle. The processor 3008 can do so, for example, by requesting such information from the locking and control mechanism 3030b of the connected vehicle, using the applicable charging system communication protocol. Responsive to determining the minimum voltage or necessary power characteristic to simulate a charging session and determining to simulate a charging session for the vehicle, the processor 3008 can change the state of the switch to connect with the power source that is configured to provide the minimum voltage or other power characteristic to simulate a charging session with the vehicle. In doing so, the apparatus 3004 can avoid configuring or using a power converter to simulate the charging session, thus reducing wear and tear on such a power converter within the apparatus 3004 and/or removing the need for such a power converter in the apparatus 3004.

In some cases, the apparatus 3004 can include the power converter 3024 connected with the switch 3026 in addition to the other power sources. In such cases, the processor 3008 of the apparatus 3004 can connect the switch 3026 with the power converter 3024 and/or configure the power converter 3024 to simulate a charging session for a vehicle responsive to determining none of the power sources of the apparatus 3004 can provide the voltage or other power characteristic needed to simulate the charging session for the vehicle.

Locking the cables 3020a and 3020b to the vehicles 3018a and 3018b can be useful for keeping the cables 3020a and 3020b in place and connected with the vehicles 3018a and 3018b when sequentially charging the vehicles 3018a and 3018b with power from the charge point 3002. For example, the system 3000 may be configured to only charge (e.g., charge a vehicle in a reasonable amount of time (e.g., within a few fours)), charge in a charging session, or stop simulating a charging session and implement a charging session) one vehicle at a time, regardless of the number of vehicles that are connected to apparatuses 3004 in a daisy chain configuration. In this configuration, it is advantageous to keep the vehicles connected to the apparatuses such that the vehicles can receive power from the apparatuses when the vehicles are next in line for charging and/or cannot be disconnected from the apparatuses by a bad actor.

For instance, the vehicle 3018a can connect with the apparatus 3004a and the vehicle 3018b can connect with the apparatus 3004b. The apparatus 3004a can communicate with the apparatus 3004b and determine to charge the vehicle 3018a before the apparatus 3004b charges the vehicle 3018b using the systems and methods described herein. Responsive to doing so, the processor 3008a can communicate with (e.g., transmit a signal to) the switch 3026a to connect the input port directly with the output port 3016a to direct power from the charge point 3002 to the vehicle 3018a over the cable 3020a. The vehicle 3018a can lock or tether (e.g., automatically lock or tether) the cable 3020a to the vehicle 3018a (e.g., to or through the locking and control mechanism 3030a of the vehicle 3018a) responsive to receiving the power through the cable 3020a or a charging session with the charge point 3002. Additionally, the processor 3008b can communicate with (e.g., transmit a signal to) the switch 3026b to connect the switch 2026b to the power converter 3024b. The input port 3012b may receive minimal current (and voltage) from the power source 3028b through the power converter 3024b. Accordingly, the power converter 3024b can cause the voltage of the received current to “step up” to a higher voltage or “step down” to a lower voltage that is equal to the voltage at a vehicle or apparatus during a charging session or that is otherwise above or below a threshold. In some embodiments, the power converter 3024b can increase or decrease the voltage to a voltage requested by the vehicle 3018b for charging. The adjusted voltage can be transferred to the vehicle 3018b to cause the vehicle 3018b to lock or tether (e.g., through the locking and control mechanism 3030b) the cable 3020b without charging or to only minimally charge the battery of the vehicle 3018b, thus simulating a charging session with the vehicle 3018b. In cases in which the power sources 3028a and/or 3028b are AC power sources, the power converters 3024a and/or 3024b can be AC-to-DC converters. The power converters 3024a and/or 3024b can convert the AC power to DC power having a defined voltage that can be used to lock (e.g., in simulated charging sessions, as described herein) the locking and control mechanisms 3030a and 3030b. Accordingly, the apparatuses 3004 can lock the cables 3020a and 3020b to the respective vehicles 3018a and 3018b regardless of whether the apparatuses 3004 are currently charging the vehicles 3018a and 3018b.

Continuing with the examples above, the apparatuses 3004 can communicate with each other to cause the apparatus 3004b to initiate a charging session with the vehicle 3018b and the apparatus 3004a to stop the charging session with the vehicle 3018a but keep the vehicle 3018a locked to the cable 3020a. For example, the processor 3008a can determine that the charging session with the vehicle 3018a has ended responsive to determining the vehicle 3018a is fully charged or otherwise responsive to receiving a signal from the vehicle 3018a or an electronic device 3022a indicating to stop the charging session. Responsive to determining that the charging session has completed, the processor 3008a can change the state of the switch 3026a to connect the output port 3016a with the converter 3024a and/or otherwise cause the apparatus 3004a to stop providing power (e.g., a substantial amount of power or a non-nominal amount of power) to the vehicle 3018a. The converter 3024a can adjust the voltage that the converter 3024a receives from the power source 3028a to a voltage at a defined value to simulate a charging session as described above with respect to the converter 3024b. The apparatus 3004a can then provide the adjusted voltage to the vehicle 3018a to simulate a charging session to cause the vehicle 3018a to lock or tether the cable 3020a without receiving any or minimal power to charge the battery of the vehicle.

The apparatuses 3004 can communicate with each other directly or indirectly via a backend server or controller (not shown). For example, in some cases, the system 3000 can include a remote server or computer 3032. The remote server or computer 3032 can be a cloud server or computer or can be located on-site at the system 3000. The remote server or computer 3032 can maintain a queue of vehicles that are connected with apparatuses in the system 3000 to charge. The remote server or computer 3032 can generate the queue based on indications of connected vehicles and using a set of criteria. For instance, as vehicles connect with the apparatuses 3004, the apparatuses 3004 can respectively transmit indications of the connections to the remote server or computer 3032. The remote server or computer 3032 can receive the indications and generate a queue indicating an order in which to charge the connected vehicles, such as based on an order of the connections and/or the types of the connected vehicles (e.g., emergency vehicles may have higher priority than non-emergency sedans). The remote server or computer 3032 can generate the queue and control the apparatuses 3004 such that only one connected vehicle is charged at a time according to the order indicated in the queue. The remote server or computer 3032 can update the queue when a charging session completes at an apparatus 3004 and the apparatus 3004 transmits a message to the remote server or computer 3032 indicating the completion of the charging session. Responsive to receiving such a message, the remote server or computer 3032 can remove an indication of the charging session or the vehicle from the queue and identify the next vehicle in the queue. The remote server or computer 3032 can transmit a message to the apparatus to initiate a charging session with the next vehicle in the queue. The remote server or computer 3032 can similarly add or remove vehicles from the queue over time to charge vehicles one-by-one, or by any other defined number, with power from the charge point 3002. Thus, the remote server or computer 3032 can facilitate fast charging of individual vehicles in the system 3000.

Additionally, based on communication between the apparatuses 3004 and/or the remote server 3032 that the charging session at the apparatus 3004a has ended and the apparatus 3004b is next for charging the vehicle 3018b, the processor 3008b can initiate a charging session with the vehicle 3018b. To do so, for example, the processor 3008b can communicate with the switch 3026b to connect the input port 3012b directly with the output port 3016b. The processor 3008b can otherwise cause the apparatus 3004b to provide power to the vehicle 3018b to charge the vehicle 3018b in a charging session. The change in state can cause the vehicle 3018b to remain locked from the simulated charging session but instead lock based on the power the vehicle 3018b receives from the apparatus 3004b. The vehicle 3018b can remain locked by staying locked without any change in state to an unlocked state or by unlocking during the transition or at some point in the transition (e.g., when no voltage is directed to the vehicle 3018b) and then becoming locked again (e.g., when the charging session (e.g., actual charging session) is initiated). Any number of apparatuses 3004 can be connected in the system 3000 and operate in this manner to lock vehicles or apparatuses to the respective apparatuses 3004 both when the vehicles are being charged and when the vehicles are not being charged or are not intended to be charged.

In some embodiments, the switches 3026a and 3026b can each include multiple switches. The processor 3008a can control the switch 3026a based on whether the apparatus 3004a is charging a vehicle or simulating a charging session for a vehicle. For example, the switch 3026a can include a switch connecting the power converter 3024a with the output port 3016a, a switch connecting the input port 3012a with the output port 3014a, and/or a switch connecting the input port 3012a with the output port 3016a. The switches of the switch 3026a can be configured such that the input port 3012a is not directly connected with the output port 3016a during a simulated charging session and/or when the switch 3026a connects the power converter 3024a to the output port 3016a. In such cases, the switch 3026a can connect the input port 3012a to the output port 3014a. The switches of the switch 3026a can additionally or instead be configured such that the power converter 3024a is not connected with the output port 3016 during a charging session and/or when the switch 3026a connects the output port 3016a with the input port 3012a. In some embodiments, the switch 3026a only selectively connects or couples the output port 3016a to the input port 3012a or the power converter 3024. In such embodiments, there can be a direct connection between the input port 3012a and the output port 3014a such that power or energy can pass through the apparatus 3004a regardless of whether an actual or simulated charging session is in progress with the apparatus 3004a. The apparatus 3004b can be similarly configured to the apparatus 3004a.

In some embodiments, electronic devices 3022a and 3022b can control the charging sessions and/or the locking or unlocking of the cables 3020a and 3020b to the apparatuses 3004 and/or the vehicles 3018a and 3018b. For example, the electronic device 3022a can control whether the locking mechanism 3010a locks or tethers the cable 3020a to the apparatus 3004a using authentication and authorization techniques as described above. Additionally, the electronic device 3022a can control whether the apparatus 3004a simulates a charging session to lock the cable 3020a with the vehicle 3018a. For example, the electronic device 3022a can transmit a locking or unlocking request to the apparatus 3004a to control whether the apparatus simulates a charging session with the vehicle 3018a to lock the cable 3020a with the vehicle 3018a. Through the processor 3008a, the apparatus 3004a can cause the apparatus 3004a to stop outputting a voltage or simulating a charging session to the vehicle 3018a that causes the vehicle 3018a to lock or tether to the cable 3020a. The apparatus 3004a can do so by controlling the components of the apparatus 3004a, such as by changing the state of the switch 3026a to disconnect the converter 3024a from the output port 3016a or through any other method. In some cases, the apparatus 3004a may only change states to lock or unlock the vehicle 3018a from the cable 3020a responsive to authorizing and/or authenticating the user account or the electronic device 3022a, as described above.

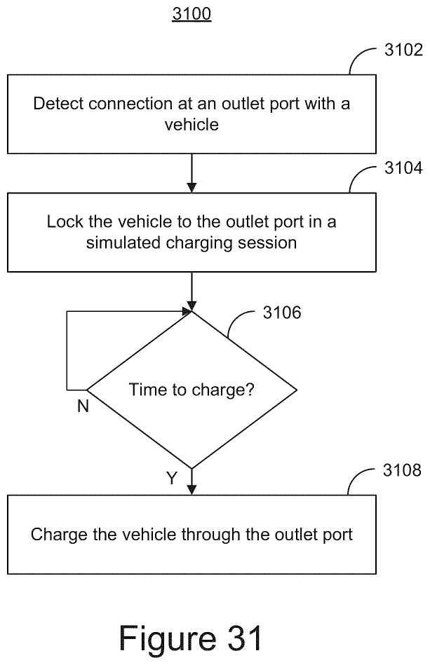

FIG. 31 is a flowchart illustrating a method for charging vehicles in a system with a daisy chain configuration, according to an embodiment of the present disclosure. The method 3100 can be performed by an apparatus (e.g., the apparatus 3004). The apparatus can be connected to a charge point (e.g., an energy source) and/or one or more other similarly configured apparatuses. The apparatus can be configured to charge an apparatus, such as a vehicle, through an output port with energy received from the charge point through an input port of the apparatus. The apparatus may provide power to the vehicle through a cable connecting the apparatus with the vehicle. The apparatus can cause the vehicle to lock the cable to the vehicle. The apparatus can do so by provisioning power to the vehicle that causes the vehicle to lock or tether (e.g., automatically lock or tether) the vehicle with the cable, and/or by directing a voltage to the vehicle over the cable or communicating with the vehicle to simulate a charging session to the vehicle. In doing so, the apparatus may restrict unauthorized individuals from disconnecting the cable facilitating energy transfer from the vehicle.

At operation 3102, the apparatus detects a connection with a vehicle or another apparatus. The apparatus can detect the connection with the vehicle at the output port of the apparatus. An individual can connect the vehicle with the apparatus through a cable that enables power transfer to and/or from the vehicle. The apparatus can detect the connection using one or more sensors and/or by detecting a signal from the vehicle through the connected cable.

At operation 3104, the apparatus locks the vehicle to the outlet port. The apparatus can automatically lock the vehicle to the outlet report responsive to detecting the connection, in some embodiments. The apparatus can lock the vehicle to the outlet port by locking the vehicle to the cable connecting the vehicle and the outlet port. In some embodiments, the apparatus can lock or tether the cable to the outlet port, as described above.

The apparatus can lock the vehicle to the cable by directing a voltage to the vehicle that is high enough (e.g., above a threshold or at a defined value) to simulate a charging session at the vehicle. The apparatus can direct the voltage to the vehicle through the cable without directing power (or by only directing a minimal amount of power) to the vehicle. In some embodiments, the apparatus can do so using a fixed voltage supply or power supply. The fixed voltage supply or power supply can be internal to the apparatus (e.g., as a battery) or external to the apparatus (e.g., as a connection with an energy grid or an external battery). In some embodiments, the apparatus can include a converter that is connected with the fixed voltage supply or power supply that adjusts voltage that the apparatus receives from the fixed voltage supply or power supply to a voltage to simulate a charging session without providing power (e.g., enough power to charge the vehicle) to the vehicle.

In some cases, the apparatus can lock the vehicle to the cable by communicating with the vehicle. For example, the apparatus can communicate with the vehicle using a charging communication protocol used in vehicle charging, such as, but not limited to, pulse-width modulation and powerline communication (e.g., ISO15118, IEC61851, SAE J1772, etc.). The apparatus can communicate with the vehicle in this manner in response to the cable being connected with an inlet port of the vehicle, for example. Based on the communication the vehicle can activate the locking and control mechanism to the cable, locking the cable to the inlet port of the vehicle. In doing so, in some cases, the apparatus may not provide power or voltage to the vehicle 3018a. Thus, the apparatus 3004a can simulate a charging session with the vehicle 3018a with the communication and without providing any power to the vehicle.

In some cases, the apparatus can simulate a charging session by beginning an actual charging session with a connected vehicle and applying a charging voltage that the vehicle requests. However, the apparatus can transmit instructions to the vehicle to draw zero amperes (or the lowest number of amps the vehicle can draw). In response, the vehicle can operate per the instructions and not draw any current but still lock to the cable connecting the apparatus to the vehicle.

At operation 3106, the apparatus determines whether to charge the vehicle. The apparatus can determine whether to charge the vehicle based on a state of other apparatuses connected with the apparatus in a daisy chain configuration. For example, the apparatus can be connected in series with one or more other apparatuses and the charge point. The daisy chain of apparatuses can communicate with each other such that only one (or another defined number) of apparatus charges a connected apparatus or vehicle at a time while the other apparatuses remain locked (e.g., while the other apparatuses simulate a charging session to lock vehicles to cables connecting the vehicles to the apparatuses). The apparatus can determine to charge the vehicle responsive to receiving a message from another apparatus of the daisy chain or from a remote computing system managing the daisy chain indicating a charging session for another vehicle has completed and the apparatus is next for charging the vehicle. The apparatus can lock the vehicle to the cable connecting the vehicle with the apparatus with a simulated charging session until determining to charge the vehicle. Responsive to determining to charge the vehicle, at operation 3108, the apparatus can charge the vehicle. In some embodiments, the apparatus can do so over the same cable that the apparatus used to simulate a charging session with the vehicle. In doing so, in some cases, the apparatus can cause the vehicle to remain locked to the cable based on the power or voltage of the power that the apparatus provisions to the vehicle over the cable for the charging session. In some cases, there may be a delay in which the cable is not locked to the vehicle during the transition from simulating the charging session to initiating the charging session, such as during a time period in which the apparatus is not providing any voltage to the vehicle during the transition.

In one embodiment, the present disclosure describes a charging system for directing power flow between multiple devices. The charging system can include an apparatus comprising one or more inlet ports for connection to one or more respective devices; a plurality of outlet ports configured for supplying electrical power from the one or more inlet ports; and a cable locking mechanism configured to prevent unauthorized users from manually disconnecting cables of devices connected with the apparatus from the plurality of outlet ports of the apparatus.

In one embodiment, the present disclosure describes an apparatus for directing power flow between multiple devices. The apparatus can include one or more inlet ports for connection to one or more respective devices; a plurality of outlet ports configured for supplying electrical power from the one or more inlet ports; and one or more processors coupled to memory, the memory comprising instructions that, when executed by the one or more processors, cause the one or more processors to detect connection at an outlet port of the plurality of outlet ports with a vehicle; responsive to detecting the connection, automatically lock the vehicle to the outlet port in a simulated charging session with the vehicle for a first time period; during the first time period in which the vehicle is locked to the outlet port in the simulated charging session, determine to charge the vehicle; and responsive to the determination to charge the vehicle, initiate directing power to the vehicle through the outlet port during a second time period subsequent to the first time period while the vehicle remains locked to the outlet port.

### Hybrid Charging System

A daisy-chained series of docks or apparatuses (e.g., as described herein) configured to charge electric vehicles (EVs) or other electrical devices can be or include one or more docks or apparatuses strung together by cables. At one end, the daisy chain can be connected to a primary vehicle charging station (e.g., a high-speed DC car charger), which can provide the power required to charge the electric vehicles. Each dock or apparatus of the daisy chain can be configured to receive power from the primary vehicle charging station, such as through the docks or apparatuses connected between the respective docks or apparatuses and the vehicle charging station. The docks or apparatuses can be configured to direct the received power from the primary vehicle charging station to electric or hybrid vehicles connected with the respective docks or apparatuses. Thus, each dock or apparatus can operate to provide power from a single power source to electric vehicles connected to the respective charging points.

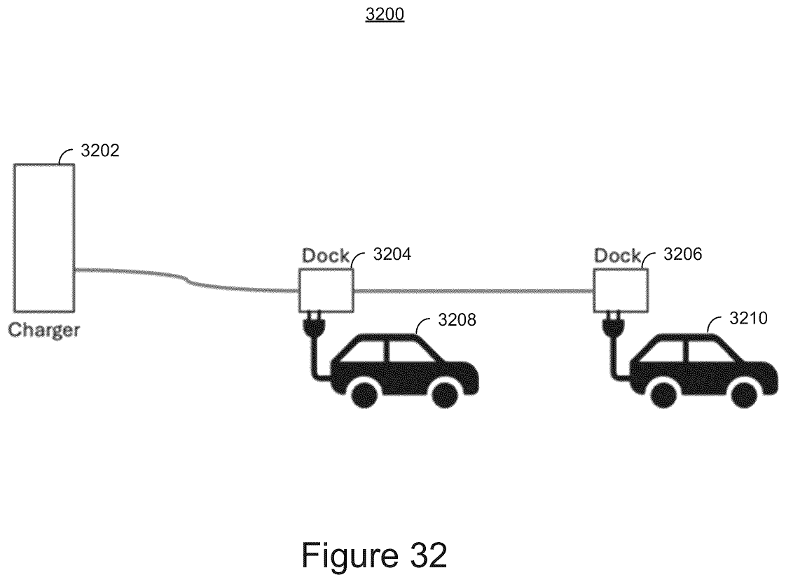

For example, referring now to FIG. 32, a system 3200 for charging vehicles in a daisy chain configuration is shown. In the system 3200, a vehicle charging station 3202 is connected in a daisy chain configuration with apparatuses 3204 and 3206. The vehicle charging station 3202 may be a charger configured to directly connect to vehicles to charge the vehicles. The vehicle charging station 3202 can be the same as or similar to the charge point 3002, shown and described with reference to FIG. 30. The apparatuses 3204 and 3206 can be configured to distribute power received from the vehicle charging station 3202 to vehicles 3208 and 3210, respectively. The apparatuses 3204 and 3206 can be the same as or similar to the apparatuses 3004a and 3004b, shown and described with reference to FIG. 30. The system 3200 can include any number of apparatuses connected with each other in the daisy chain configuration.

The system 3200 can be configured such that only one vehicle is charging at a time. For example, a control system can transmit control signals to the apparatuses 3204 and 3206 such that only one vehicle is connected, through the connected apparatus 3204 or 3206, to and/or receiving power from the vehicle charging station 3202. The connection through one of the apparatuses 3204 or 3206 can have the same effect as connecting the vehicle directly to the vehicle charging station 3202 for charging. When the vehicle has been fully charged, the apparatuses connecting the vehicle to the vehicle charging station 3202 can disconnect the charging connection between the vehicle and the vehicle charging station 3202 (e.g., stop charging the vehicle with power from the vehicle charging station 3202), such as the apparatus to which the vehicle is connected. In turn, another apparatus of the daisy chain can adjust to connect a vehicle connected to the apparatus to the vehicle charging station 3202 for a vehicle charging session.

The individual apparatuses 3204 and 3206 may be capable of charging vehicles equipped with any of a variety of vehicle charging connectors (e.g., vehicle charging guns). For example, the apparatuses 3204 and 3206 may be configured to charge vehicles with combined charging system (CCS) Type 2 vehicle connectors and vehicle inlets, national American charging standard (NACS) vehicle connectors and vehicle inlets, and/or CCS Type 1 vehicle connectors and vehicle inlets.

While the apparatuses of the system 3200 can optionally be daisy-chained as needed, with each new vehicle bringing its own apparatus and connecting it to the previous one, in some cases, the apparatuses of the system 3200 are permanent installations, and the apparatuses are permanently wired to each other. This type of installation raises the question of how to connect the vehicle charging station 3202 to the daisy chain of apparatuses. A possible solution to this is to modify the charging cable extending from the vehicle charging station 3202 by removing the vehicle connector from the end of the cable, exposing the conductors inside. These conductors can then be “hard-wired” into the apparatus 3204 (e.g., as the first apparatus downstream from the vehicle charging station 3202) of the system 3200, permanently connecting the vehicle charging point to the apparatus and therefore the chain of apparatuses connected with each other. However, a problem with this approach is that it modifies the vehicle charging station 3202 and may invalidate the warranty on that equipment. In addition, if the party controlling the charging facility should wish to remove the apparatuses 3204 and/or 3206, or relocate the apparatuses 3204 and/or 3206 to another vehicle charging station, the modified vehicle charging station 3202 would need to be repaired by having its charging cable replaced.

To address these and other problems, a connector box can be inserted at the vehicle charging station 3202 end of the system 3200 between the first apparatus (e.g., the apparatus 3204) and the vehicle charging station 3202. The connector box can be equipped with a vehicle inlet port that can receive and connect to vehicle charging guns or vehicle connectors. The vehicle inlet port can allow the vehicle charging station 3202 to be connected to the connector box, and thus to the apparatuses 3204 and 3206 chained together, by inserting the vehicle connector (e.g., charging gun) of the vehicle charging station 3202 into the vehicle inlet port of the connector box.

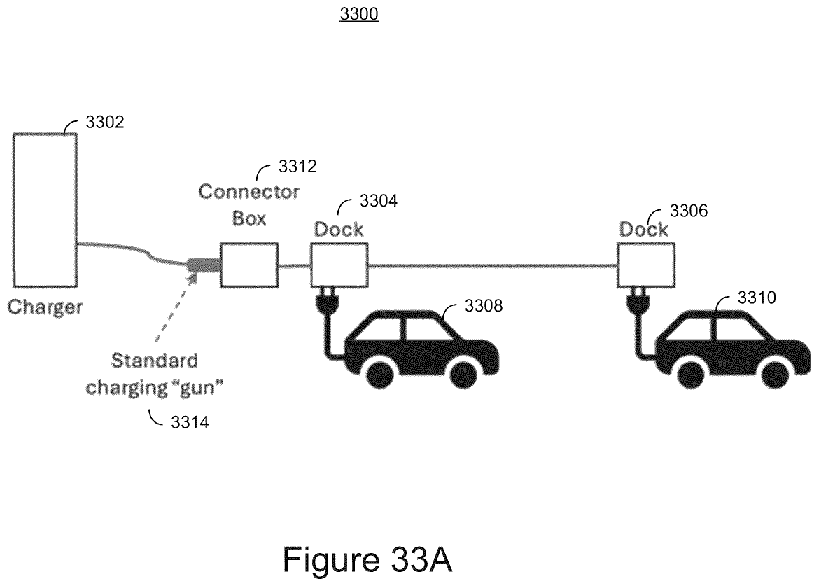

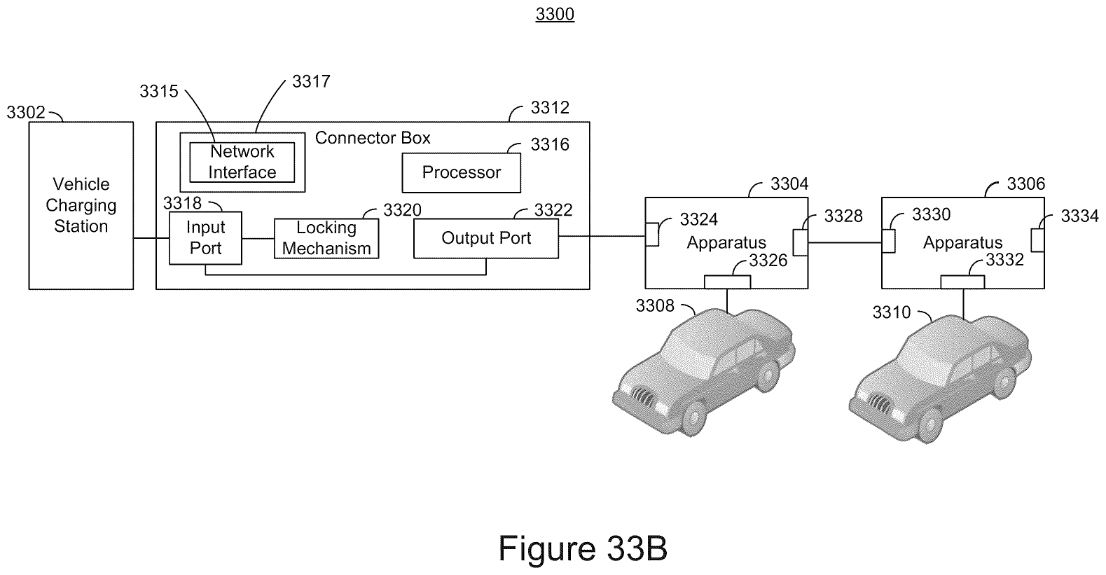

For example, referring now to FIG. 33A, a system 3300 for charging vehicles in a daisy chain configuration is shown, according to some embodiments. In the system 3300, a vehicle charging station 3302 is connected in a daisy chain configuration with apparatuses 3304 and 3306. The vehicle charging station 3302 may be a charger configured to directly connect (e.g., through a charging gun) to vehicles to charge the vehicles. The vehicle charging station 3302 can be the same as or similar to the charging station 3202, shown and described with reference to FIG. 32. The apparatuses 3304 and 3306 can be configured to distribute power received from the vehicle charging station 3302 to vehicles 3308 and 3310, respectively. The apparatuses 3304 and 3306 can be the same as or similar to the apparatuses 3204 and 3206, shown and described with reference to FIG. 32. The system 3300 can include any number of apparatuses connected with each other in the daisy chain configuration.

The system 3300 can include a connector box 3312. The connector box 3312 can be or include a box that includes inlet ports and output ports for directing and/or redirecting power (e.g., electrical power) between sources and/or destinations. For example, the connector box 3312 can include a vehicle inlet port. The vehicle inlet port can be a port of a CCS type 1, CCS type 2, NACS, etc., that can connect to vehicle charging guns connected to vehicle charging stations or points. For instance, the connector box 3312 can connect to a vehicle charging station that is configured to directly charge vehicles because the vehicle inlet port of the connector box 3312 is configured in the same manner with the same components as the vehicle inlet ports of vehicles that receive and connect with vehicle charging guns. In the system 3300, a vehicle charging gun 3314 can connect the vehicle charging station 3302 with the connector box 3312. The connector box 3312 can also connect with the apparatus 3304 such that the charging station 3302 can provide power (e.g., AC or DC power) to the apparatus 3304 through the connector box 3312 without the need for an operator to reconfigure or remove the vehicle connector or vehicle charging gun from the cable extending from the vehicle charging station 3302.

In one example, referring now to FIG. 33B, the connector box 3312 is shown to include a network interface 3315, a processor 3316, an input port 3318, a locking mechanism 3320, and an output port 3322. While only one of each of the components 3315-3322 is shown, the connector box 3312 can include any number of each component. The network interface 3315 can be similar to the network interface 3006a, and the processor 3316 can be similar to the processor 3008a, each shown and described with reference to FIG. 30. Through the components 3315-3322, the connector box 3312 can distribute or direct power from the vehicle charging station 3302 to the apparatus 3304 such that the apparatus 3304 or the apparatus 3306 (e.g., through the apparatus 3304) can charge vehicles that are respectively connected with the apparatuses 3304 and 3306.

The input port 3318 can be a vehicle inlet port that is configured to receive and connect to a vehicle connector or vehicle charging gun. The input port 3318 can be of any type (e.g., CCS type 1, CCS type 2, or NACS). The input port 3318 can enable a vehicle charging gun attached to the vehicle charging station 3302 through a cable to removably couple or attach with the connector box 3312. For example, the vehicle charging station 3302 can include or be coupled with a vehicle charging gun through a cable. The vehicle charging gun (e.g., of the same type as the input port 3318) can be coupled with the vehicle charging station 3302, such as on a hook of the vehicle charging station 3302. A user can move the vehicle charging gun from the hook and insert the vehicle charging gun into the input port 3318 of the connector box 3312. Once inserted, the vehicle charging station 3202 can provision or provide electrical power to the connector box 3312 through the vehicle charging gun and the input port 3318.

The connector box 3312 can direct the power (e.g., DC power or AC power) from the vehicle charging station 3302 to the apparatus 3304. For example, the input port 3318 can be connected with the output port 3332. The power that the connector box 3312 receives via the input port 3318 can travel through the output port 3322 to any load or device connected with the output port 3322. For instance, the apparatus 3304 can be connected with the output port 3322. The apparatus 3304 can receive power originating from the vehicle charging station 3302 through the connector box 3312 and the output port 3322 of the connector box 3312. Accordingly, the connector box 3312 can facilitate the transfer of power from the vehicle charging station 3302 to a downstream device to avoid hardwiring the vehicle charging station 3302 to the apparatus 3304 when the apparatus 3304 does not include ports that can connect with the vehicle charging gun of the vehicle charging station 3302.

A potential problem with this arrangement is that a malicious actor (e.g., someone inconsiderate who wants to charge their car or someone mischievous) might remove the vehicle charging gun from the input port 3318 of the connector box 3312, thus disconnecting the apparatuses 3304 and 3306 from the vehicle charging station 3302 and preventing the apparatuses 3304 and 3306 from distributing power from the vehicle charging station 3302 to vehicles connected to the apparatuses 3304 and 3306 (e.g., at that time, or at any future time).

To address the aforementioned problem, the locking mechanism 3320 can lock vehicle connectors or vehicle charging guns in place within the input port 3318. The locking mechanism can lock the vehicle connectors or vehicle charging guns in place with a mechanical latch, pin, solenoid, or any other means of locking vehicle connectors or vehicle charging guns to input ports. The locking mechanism 3320 can lock the vehicle charging guns in place when the charging gun is placed in the input port 3318. For instance, the locking mechanism 3320 can be activated when the vehicle connector or vehicle charging gun is inserted into the input port 3318, thus preventing removal of the vehicle charging gun from the input port 3318.

In some cases, the locking mechanism 3320 is configured in the same or a similar manner to the locking and control mechanisms 3030a and 3030b, shown and described with reference to FIG. 30, such as because the locking mechanism 3320 is the same as or similar to locking mechanisms in the charging ports of vehicles. In one example, the locking mechanism 3320 can be similar to locking mechanisms within vehicles that lock vehicle charging guns in place during charging sessions. For instance, when installed in a vehicle, a locking mechanism of the vehicle inlet can be activated during the charging process and deactivated (e.g., such that the cable can be disconnected from the vehicle) when the charging session ends. However, the locking mechanism 3320 of the connector box 3312 can be activated upon insertion of the vehicle charging gun into the input port 3318 and remain activated regardless of whether any charging is occurring or not. Accordingly, the locking mechanism 3320 can stop malicious actors from removing the charging gun from the connector box 3312.

In some embodiments, the locking mechanism 3320 may be, or may only be, deactivated by an authorized person. For example, the locking mechanism 3320 may be activated or deactivated responsive to a successful scan of a keycard or a keychain dongle. The connector box 3312 can scan the keycard or keychain dongle through the network interface 3315, such as by using a Bluetooth interface, a wireless interface, an infrared interface, a barcode scanning interface, etc. In some cases, a user can authorize or otherwise deactivate the locking mechanism 3320 using a physical key or a keycard system. In some cases, a user can access an application on a client device or a mobile device through the user's account and authorize the deactivation of the locking mechanism 3320 through the application and account (e.g., over a wireless network connection or an Internet connection), such as by receiving a message containing instructions to deactivate the locking mechanism 3320 from the client device or mobile device. The user can deactivate the locking mechanism 3320 after being authorized and/or authenticated in a similar manner to the manner described above for authorizing and authenticating users for removal of cables from apparatuses described with reference to FIGS. 28 and 29.

The connector box 3312 can contain a communication module 3317 (e.g., a communications model containing the network interface 3315) enabling the communication between apparatuses 3304 and 3306, the vehicle charging station 3302, the vehicles 3308 and 3310, and/or any backend computing system. The connector box 3312 can provide a connection point for a vehicle connector (e.g., a vehicle charging gun) of the vehicle charging station 3302 to feed communication, control, and power from the vehicle charging station 3302 to the apparatuses 3304 and 3306 via a backbone cable that runs through the length of the connected apparatuses 3304 and 3306, the connector box 3312, and/or the vehicle charging station 3302.

The connector box 3312 can communicate with the vehicle charging station 3302, the apparatuses 3304 and/or 3306, and/or the vehicles 3308 and/or 3310 through the network interface 3315. The network interface 3315 can be, include, or be a part of the communications module 3317 of the connector box 3312. The network interface 3315 can communicate with the components 3302-3310 through different means, such as through, Bluetooth, WiFi, infrared, a barcode scanning interface, etc. In some cases, the cables connecting the connector box 3312 with the vehicle charging station 3302 and/or the apparatus 3304 can include communication lines through which the network interface may transmit communication signals or control signals to the vehicle charging station 3302, the apparatus 3304, and/or any apparatuses connected directly (e.g., the apparatus 3306) or indirectly with the apparatus 3304. For example, the network interface 3315 can transmit communication signals through the cable provisioning power to the apparatus 3304. The network interface 3315 can additionally or instead transmit a message over a wireless communications network (e.g., WiFi or Bluetooth) to the vehicle 3308. The connector box 3312 can transmit any type of communication to any device through the different interfaces of the network interface 3315.

The communications module 3317 can include one or more communication interfaces and/or components for different types of communication. For example, the communications module 3317 can be or include a container (e.g., a physical container) within the connector box 3312 that includes one or more Ethernet ports, USB connectors, antenna sockets, etc. The communications module 3317 can additionally or instead antennas or other devices connected with the ports or sockets. The communications module 3317 can be configured for different types of wireless communication and/wired communication.

In one example, the connector box 3312 can initiate a charging session with the vehicle 3308 when the vehicle 3308 is connected with the apparatus 3304. For example, the connector box 3312 can transmit a message (e.g., over a wireless communications network or wireless communications channel) to the vehicle 3308 with an indication of an initiation of a vehicle charging session in the message. The connector box 3312 can additionally or instead transmit a message over the cable connecting the connector box 3312 and the apparatus 3304 indicating the initiation of the vehicle charging session with the vehicle 3308. Responsive to the messages, the apparatus 3304 can adjust a configuration of the apparatus 3304 to direct power received from the connector box 3312 to the vehicle 3308 and/or the vehicle 3308 can lock or adjust a configuration of the vehicle 3308 to charge a battery of the vehicle 3308. In some cases, the vehicle 3308 can activate a local locking mechanism (e.g., a locking mechanism in the vehicle 3308) in response to a message (e.g., the same message or a different message from the message that initiates the charging session) from the connector box 3312 indicating to lock the cable connecting the vehicle 3308 with the apparatus 3304 in place. For example, the connector box 3312 can transmit a “lock connector” message to the vehicle 3308 separate from any initiate charging session message to cause the vehicle 3308 to lock to the cable.

The connector box 3312 can additionally or instead receive and/or transmit messages over a wireless interface and/or a wired interface (e.g., a communications interface of a communications module). In doing so, the connector box 3312 can provide or operate as a connection point for a DC or AC vehicle charging station and feed communication, control, and power from the vehicle charging station to apparatuses connected with the vehicle charging station through the connector box 3312. The vehicle charging station 3302 can use a charging communication protocol or operation to communicate with vehicles connected with the vehicle charging station 3302 through the daisy chain of apparatuses and the connector box 3312. The vehicle charging station 3302 can do so by transmitting communication messages through a communication line or communication lines (e.g., CP, PE lines) between the vehicle charging station 3302, the connector box 3312, and/or any apparatuses connected between the vehicle charging station 3302 and vehicles being charged. The connector box 3312 can transmit the messages through a backbone cable that runs through the length of the connected apparatuses.

The connector box 3312 can be used to connect a series of apparatuses to the vehicle charging station 3302 to charge vehicles coupled with the apparatuses. For instance, the connector box 3312 can be a separate unit located between the vehicle charging station 3302 and the apparatus 3304. The connector box 3312 can be connected with the vehicle charging station 3302 with a cable (e.g., a first cable) that leaves the vehicle charging station 3302 and connects to the input port 3318. The connector box 3312 can be connected with an input port 3324 of the apparatus 3304. The connector box 3312 can be connected with the input port 3324 through a cable or wire that connects with the output port 3322 (e.g., after leaving the connector box 3312 and subsequently connecting with the input port 3324 of the apparatus 3304). The apparatus 3304 can lock the cable in place through a locking mechanism, such as in the manner described with reference to FIGS. 28-32.

In some cases, the connector box 3312 can be positioned within the apparatus 3304 (e.g., within an enclosure or shell of the apparatus 3304). In such cases, the connector box 3312 can connect with the vehicle charging station via a first cable that leaves the vehicle charging station 3302 and connects to the input port 3318 of the connector box 3312. The connector box 3312 can connect with input port 3324 of the apparatus 3304 through a second cable that remains inside the apparatus 3304 and connects the output port 3322 of the connector box 3312 with the input port 3324 of the apparatus 3304.

The connector box 3312 can distribute or direct power (e.g., AC or DC power) from the vehicle charging station 3302 to the apparatus 3304 through the cable connecting the output port 3322 with the input port 3324. The apparatus 3304 can direct the power to the vehicle through an output port 3326 to charge the vehicle 3308 in a charging session. The apparatus 3304 may direct little or no power to the apparatus 3306 during the charging session with the vehicle 3308. For example, the apparatus 3304 may send small amounts of power to the apparatus 3306 to operate one or more processors of the apparatus 3306, lock cables to the apparatus 3306, etc., but may not direct enough power to charge a vehicle in a reasonable amount of time. Responsive to completing the charging session, the apparatus 3304 can direct power from the connector box 3312 to the apparatus 3306 through an output port 3328 of the apparatus 3304 to an input port 3330 of the apparatus 3306. The apparatus 3306 can direct or distribute the power from the apparatus 3304 to the vehicle 3310 through an output port 3332 for another charging session. The apparatus 3306 can direct power to the vehicle 3310 until completing the charging session. Responsive to completing the charging session with the vehicle 3310, the apparatus 3306 can direct power out of an output port 3334, such as to another apparatus to continue the chain. Accordingly, the connector box 3312 can operate as a gateway to power the daisy chain of apparatus 3304 and 3306 to complete charging sessions with the vehicles 3308 and 3310.

In some embodiments, the connector box 3312 can be configured to control a daisy chain of apparatuses connected to a vehicle charging station to facilitate vehicle charging sessions. For example, the connector box 3312 can include a server module of a powerline communications (PLC) system for the apparatuses. The PLC can be set up in a server-client configuration, where there is a server PLC chip and the others (e.g., the docks of the daisy chain) operate as clients of the server PLC chip. The server PLC chip can communicate, through appropriate protocols, to the Internet or wirelessly with any devices involved in charging sessions with the daisy chain of apparatus. Thus, the server PLC chip can operate as the point of contact between the apparatuses and the Internet. Such may be important, for example, because the master controller for the daisy chain of apparatuses may be cloud-based, and the connector box 3312 may facilitate communication and/or control messages between a cloud-based server and the daisy chain of apparatuses. If system is not cloud-based, on the other hand, but is local, the connector box 3312 or another apparatus can operate to control charging sessions performed at the daisy chain of apparatuses.

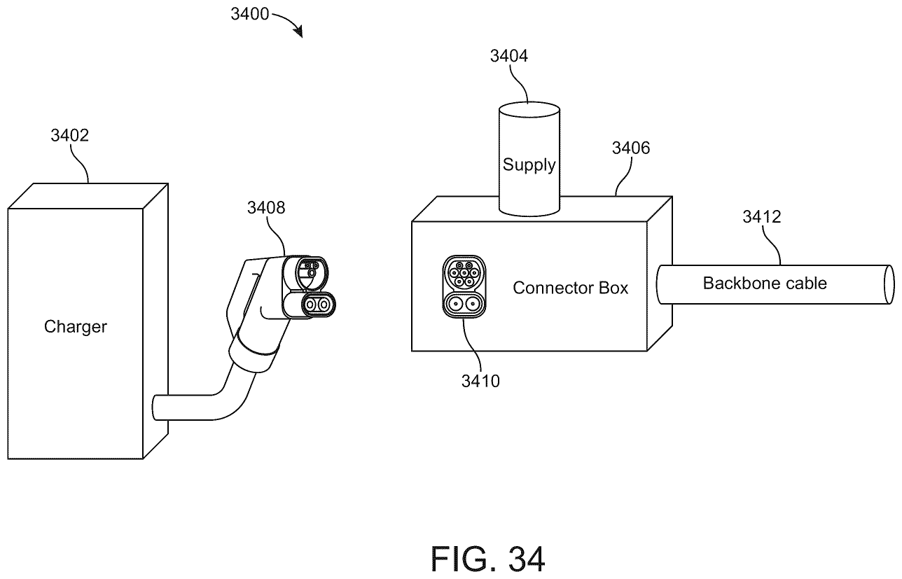

Referring now to FIG. 34, an illustration of components of a system 3400 for charging vehicles in a daisy chain configuration is shown, according to an embodiment of the present disclosure. The system 3400 can be the same as or similar to the system 3300, shown and described with reference to FIG. 33. The system 3400 can include the same or similar components to the system 3300.

For example, the system 3400 can include a vehicle charging station 3402 and an external power supply 3404. The vehicle charging station 3402 can be the same as or similar to the vehicle charging station 3302. The vehicle charging station 3402 can operate as a DC power supply or an AC power supply. In some embodiments, the external power supply 3404 is an AC power supply and can be a single-phase AC power supply or a three-phase AC power supply, such as the utility power grid or a programmable power supply. In some embodiments, the external power supply 3404 is a DC power supply. The vehicle charging station 3402 and the external power supply 3404 can connect to or can be connected to a connector box 3406 through an AC or DC inlet port of the connector box 3406. The vehicle charging station 3402 can be connected with the connector box 3406 through a vehicle charging gun 3408. The vehicle charging gun 3408 (e.g., a vehicle connector) can connect with a vehicle inlet port 3410 of the connector box 3406.

The vehicle charging gun 3408 can be or include one or more pins in a configuration to connect with charging ports of vehicles. The vehicle charging gun 3408 can be the same as or similar to the vehicle charging gun 3314. For example, the vehicle charging gun 3408 can be a CCS type 1 charging gun, a CCS type 2 charging gun, or an NACS charging gun. The pins of the vehicle charging gun 3408 can be arranged according to the type of the vehicle charging gun 3408. The vehicle charging gun 3408 can be connected with the vehicle charging station 3402 through a cable. In some cases, when not connected with the connector box 3406, the vehicle charging station 3402 can charge vehicles by directing power through the cable to the vehicle charging gun 3408 to a vehicle connected with the vehicle charging gun 3408.

The connector box 3406 can direct power received from the vehicle charging station 3402 and/or power received from the external power supply 3404 to an apparatus (e.g., the apparatus 3304) through a backbone cable 3412. The backbone cable 3412 can include one or more cables configured to direct power to one or more apparatuses connected in series with the vehicle charging station. In one example, the backbone cable 3412 can connect each of a plurality of apparatuses together in series to the connector box 3406 and/or the vehicle charging station 3402. The backbone cable 3412 can include a first set of conductors for DC power transfer and/or a second set of conductors for AC power transfer. The backbone cable 3412 can connect to different or otherwise appropriate output ports of the connector box 3406 for the DC power transfer and/or the AC power transfer. Only including a single backbone cable 3412 with multiple conductors to connect the apparatus to the connector box 3406 and/or the vehicle charging station 3402 for AC and/or DC power transfer can substantially reduce the amount of cables and/or wiring that is needed to connect the system 3400 together. The apparatus can use the power from the external power supply 3404 (e.g., AC power) to power internal electronics of the apparatus for operation and/or pass the power from the external power supply 3404 to further apparatuses downstream in the chain. In some cases, one or more of the apparatuses can provide the power from the external power supply 3404 to connected vehicles for slow charging, to condition the batteries in the vehicles for subsequent fast charging, and/or to lock the vehicles to the respective apparatuses, as described herein.

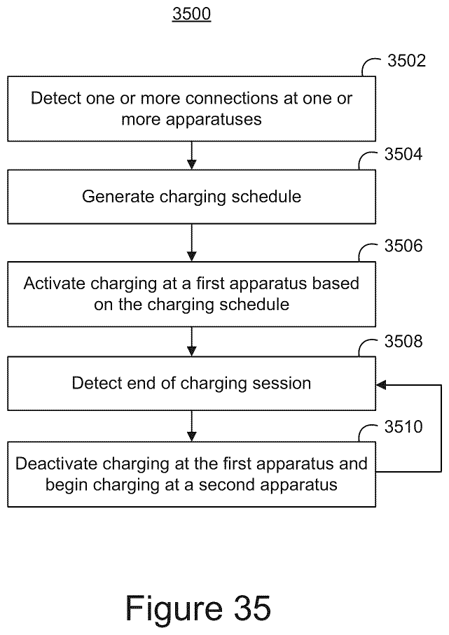

FIG. 35 is a flowchart illustrating a method 3500 for charging vehicles in a system with a daisy chain of apparatuses, according to an embodiment of the present disclosure. The method 3100 can include any number of steps and the steps may be performed in any order. The method 3500 can be performed by one or more of a connector box (e.g., the connector box 3312), a computing device remote or separate from the daisy chain of apparatuses (e.g., as described herein), and/or an apparatus within the daisy chain of apparatuses. The connector box can be connected to a vehicle charging station (e.g., the vehicle charging station 3302, a charge point, or an energy source) and/or one or more other similarly configured connector boxes. The connector box can be configured to connect to a vehicle charging station and an apparatus to direct or distribute power from the vehicle charging station to the apparatus, such as an apparatus connected with a vehicle for a charging station. The apparatus may direct power from the connector box 3312 to a connected vehicle in the charging station. The apparatus may additionally or instead direct power received from the connector box to another connected apparatus for another charging session with a different vehicle. Any number of such apparatuses may be connected in this daisy chain configuration to charge vehicles, in some cases by only charging one vehicle at a time. Accordingly, the connector box may operate as a conduit of power from a vehicle charging station to a daisy chain of apparatuses and/or a control center or controller for charging different vehicles connected with the apparatuses.

In some embodiments, the operations of the method 3500 described as being performed by the connector box can be performed by a remote computing device not physically connected with the vehicle charging station or the daisy chain of apparatuses. In some embodiments, the connector box can operate as a proxy or gateway device between a remote computing device (e.g., a cloud computing device) and apparatuses of the daisy chain of apparatuses such that the remote computing device transmits control signals to the connector box which the connector box can then propagate to the appropriate apparatuses in the daisy chain of apparatuses. The connector box can propagate received messages or information to the remote computing device. Such may be advantageous in cases in which the connector box is the only device in the charging system connected with the Internet or configured for communicating with the remote computing device.

At operation 3502, the connector box can detect one or more connections at one or more apparatuses. The one or more apparatuses can be connected in a daisy chain configuration with the connector box and the vehicle charging station, as described herein. The connections at the apparatuses can be connections between the apparatuses and vehicles for charging sessions. The connector box can detect the connections by communicating with the apparatuses. For example, a vehicle (e.g., a first vehicle) can connect (e.g., through a vehicle charging gun) with an apparatus (e.g., a first apparatus) of the daisy chain configuration of apparatuses. The apparatus can detect the connection with the vehicle. Responsive to detecting the connection, the apparatus can transmit, through a communication interface, a message to the connector box indicating the connection with the vehicle. Each apparatus of the daisy chain can similarly detect connections and transmit indications of the connections to the connector box over time. The indications can each include an identification of the connection, the apparatus transmitting the indication, an identification (e.g., an identifier of) the vehicle connected with the apparatus, and/or a timestamp of the connection and/or the message transmission. The connector box can receive and/or store the indications (e.g., and the data of the indications) and detect the connections based on the received indications.

In some cases, the connector box can detect connections at the apparatuses by communicating with the vehicles that connect with the apparatuses. For example, vehicles that connect with the apparatuses of the daisy chain of apparatuses can establish connections with the connector box. The vehicles can do so by executing a handshaking operation with the connector box, for example, via a communications interface of the connector box. The vehicles can establish the connections with the connector box responsive to detecting a signal strength of the connector box and/or responsive to users connecting the vehicles with the apparatuses (e.g., via vehicle charging guns). After or while establishing the connections, the vehicles can transmit identifications of the charging sessions and/or the vehicles to the connector box.

At operation 3504, the connector box generates a charging schedule. The connector box can generate the charging schedule to include an order in which to complete a defined number of one or more concurrent charging sessions with vehicles connected to apparatuses of the daisy chain of apparatuses. The connector box can generate the charging schedule as a data structure including one or more rows and/or one or more columns. Each row can include one or more cells in the one or more columns. In each row, one cell can be dedicated to storing an apparatus identification, one cell can be dedicated to storing an identification of a vehicle (e.g., a vehicle identification number, a MAC address, etc.), and/or one cell can indicate a priority number. Each row can correspond to (e.g., contain data for) a different connection. The connector box can insert information about new connections into the data structure as vehicles connect with the apparatuses in the daisy chain, such as by populating the rows with respective data received in the indications of the connections that the connector box receives (e.g., identifiers of the apparatuses and vehicles involved in the respective connections) and/or determined by the connector (e.g., priority information determined by the connector box for the respective connections).

The connector box can generate the charging schedule using a set of criteria. For example, the connector box can assign timestamps to each of the indications of charging sessions that the connector box receives. The timestamps can indicate times in which corresponding vehicles connected to the apparatuses and/or times in which the connector box received the respective indications of the connections or otherwise detected the connections. The connector box can generate the charging schedule to identify the apparatuses and/or the vehicles connected with the apparatuses in an order based on the timestamps (e.g., from the earliest timestamp to the latest timestamp). In doing so, the connector box can assign higher charging priorities (e.g., priorities assigned to indicate an order or sequence of apparatuses to complete charging sessions) to apparatuses and/or connected vehicles that connect with apparatuses earlier or first. In some cases, instead of relying on timestamps, the connector box can add apparatuses and/or vehicles to the charging schedule in real-time as the vehicles connect with the apparatuses, assigning lower charging priorities to vehicles or apparatuses that connect after earlier connected apparatuses and vehicles. Thus, the connector box can create or generate a dynamic charging schedule for the daisy chain of apparatuses.

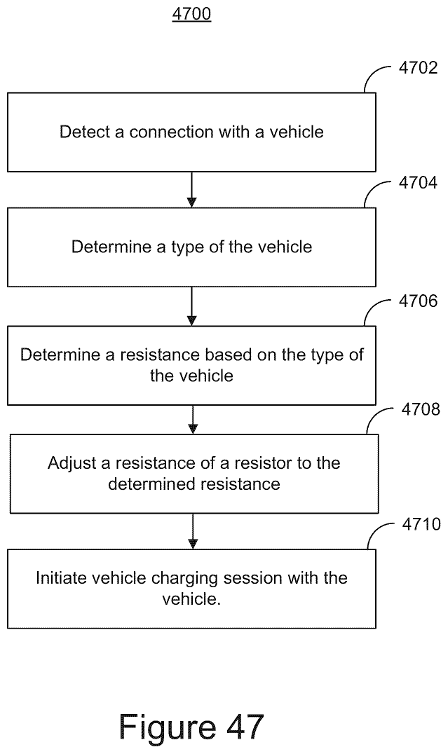

In some cases, the connector box can generate the charging schedule based on the types of vehicles that connect with the apparatuses of the daisy chain of apparatuses. Types of vehicles can be or include different combinations or permutations of makes, models, and/or years, emergency vehicles, sedans, trucks, buses, sports cars, etc. The connector box can determine the types of the vehicles in the manners described herein (e.g., as described with reference to FIG. 47). In one example, the connector box can store a table of mappings between types of vehicles and type priorities (e.g., priorities assigned to specific vehicle types). The connector box can determine the charging priorities of the connected vehicles based on the table of mappings. For instance, the connector box can determine charging priorities of vehicles or apparatus connected with the vehicles such that connected vehicles with higher type priorities have higher charging priorities than connected vehicles with lower type priorities. The connector box can order apparatuses or vehicles of the same type based on timestamps for the connections or vehicles, or otherwise based on the times in which the connector box detected the connections between the vehicles and the apparatuses. For example, the connector box can use any criteria to generate the charging schedule.

The connector box can dynamically update the charging schedule over time. For example, the connector box can continuously add apparatuses and/or vehicles to the charging schedule (e.g., populate empty or new rows in the charging schedule data structure as vehicles connect with apparatuses of the daisy chain of apparatuses). The connector box can add the vehicles to the charging schedule using the set of criteria. For example, the connector box can assign priorities to the added vehicles in the order in which the vehicles connect with the apparatuses of the daisy chain of apparatuses. In another example, the connector box can assign priorities to the added vehicles based on a combination of the timestamps of the connections and the types of the vehicles. In this configuration, the connector box can cause a connected vehicle to “skip the line” and have an earlier charging priority than connected vehicles or apparatuses in the charging schedule. This may occur, for example, if a newly connected vehicle has a higher type priority than connected vehicles or apparatuses included in the charging schedule. The connector box can cause the connected vehicle to skip the line by regenerating a new charging schedule for each detected vehicle connection with an apparatus. In some cases, the connector box may only regenerate the charging schedule for each connection in embodiments in which the connector box takes type priorities into account when generating the charging schedule, which can reduce the processing requirements and resources when generating the charging schedule based only on an order of vehicle connections with apparatuses.

At operation 3506, the connector box activates charging at a first apparatus. In doing so, the connector box can activate charging (e.g., DC charging or charging with power from the vehicle charging station) at the first apparatus in the charging schedule. For example, the connector box can activate charging at the first apparatus responsive to determining the first apparatus and/or a first vehicle (e.g., the connection between the first apparatus and the first vehicle) has a highest priority in the charging schedule generated by the connector box. The connector box can activate charging at the first apparatus by transmitting a message to the first apparatus indicating to initiate a vehicle charging session with the vehicle connected to the first apparatus. In response to the message, the first apparatus can activate an internal switch and provide power to the first vehicle received from the vehicle charging station, the connector box, and any other apparatuses connected between the first apparatus and the connector box, if any.

At operation 3508, the connector box detects an end to the charging session at the first apparatus. The connector box can detect the end to the charging session based on an indication that the connector box receives from the first apparatus or the first vehicle. For example, responsive to the first vehicle being charged to capacity or otherwise a defined percentage of capacity or amount, the first vehicle or the first apparatus can determine to end the charging session. Responsive to doing so, the first vehicle or the first apparatus can transmit a message to the connector box indicating the charging session is complete. In some embodiments, the connector box may make the determination that a charging session is complete, such as based on information received from the first apparatus or the first vehicle. The connector box can detect the end to the charging session by receiving the message.

At operation 3510, the connector box deactivates charging at the first apparatus. The connector box can deactivate charging at the first apparatus responsive to detecting the end of the charging session at the first apparatus. The connector box can deactivate charging at the first apparatus by transmitting a message to the first apparatus indicating to stop the charging session. The first apparatus can receive the message and activate the internal switch to stop charging the connected vehicle. In some cases, the first apparatus can propagate or redirect the power from the vehicle charging station to a downstream apparatus of the daisy chain, such as in response to the message or receiving the message. In some cases, the first apparatus can automatically stop charging the vehicle and/or pass or propagate the power downstream at the end of the charging session.

The connector box can activate charging at a second apparatus. The connector box can activate charging at the second apparatus based on the charging schedule and/or responsive to determining the charging session at the first apparatus has ended. For example, the connector box can identify the second apparatus as the next highest priority apparatus after the first apparatus in the charging schedule responsive to determining the charging session at the first apparatus has ended. The connector box can transmit a message to the second apparatus to initiate a vehicle charging session with a second vehicle connected to the second apparatus. The second apparatus can complete the vehicle charging session with the second vehicle and transmit a message to the connector box indicating completion of the charging session. The connector box can receive the message and repeat operations 3508 and 3510 with a third apparatus identified as the next highest priority from the charging schedule. The connector box can repeat operations 3508 and 3510 any number of times while vehicles are connected with the daisy chain of apparatuses, in some cases updating the charging schedule as described with reference to the operation 3504 as vehicles connect with and/or disconnect from the daisy chain of apparatuses. In this way, the connector box operating to connect the daisy chain of apparatuses with the vehicle charging station can also operate as a controller to control the charging sessions between the vehicles and the apparatuses connected with the vehicle charging station through the daisy chain of apparatuses.

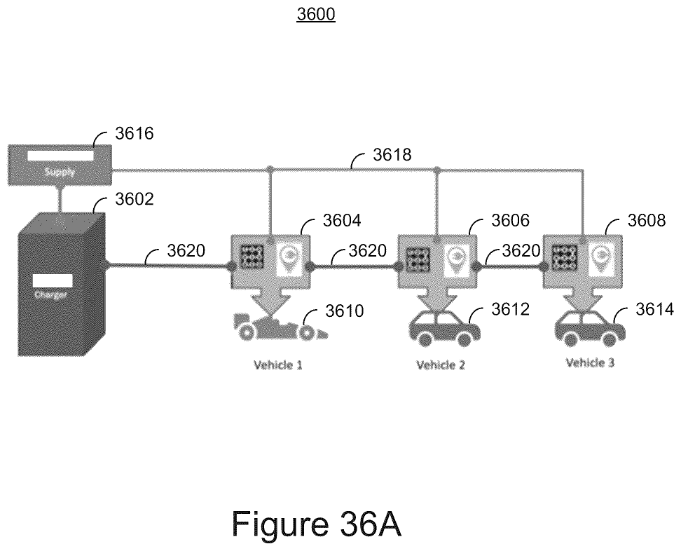

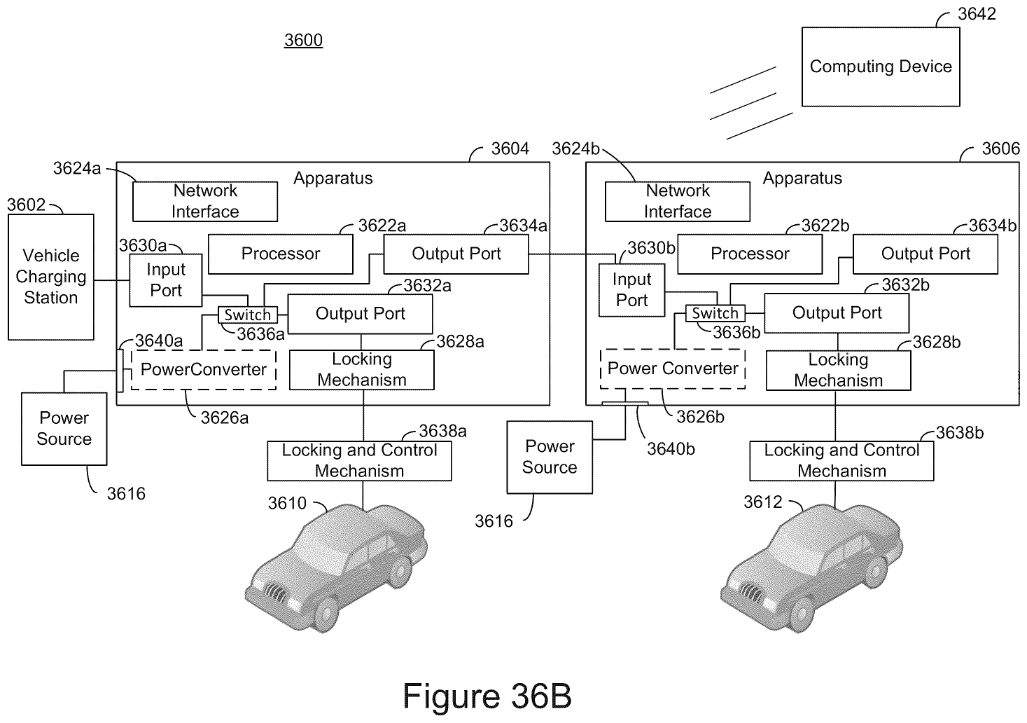

FIG. 36A is a block diagram of a system 3600 for charging vehicles in a daisy chain configuration, according to an embodiment of the present disclosure. In the system 3600, a vehicle charging station 3602 is connected in a daisy chain configuration with apparatuses 3604, 3606, and 3608. The vehicle charging station 3602 may be a charger configured to directly connect (e.g., through a charging gun) to vehicles to charge the vehicles. The vehicle charging station 3602 can be the same as or similar to the vehicle charging station 3302, shown and described with reference to FIGS. 33A and 33B. The vehicle charging station 3602 can be configured to provide or direct DC power and/or AC power to the apparatuses 3604 and/or 3606. The apparatuses 3604, 3606, and 3608 can be configured to distribute power received from the vehicle charging station 3602 to vehicles 3610, 3612, and 3614, respectively. The apparatuses 3604, 3606, and 3608 can be the same as or similar to the apparatuses 3304 and 3306, shown and described with reference to FIGS. 33A and 33B. The system 3600 can include any number of apparatuses connected with each other in the daisy chain configuration. Although not shown, the vehicle charging station 3602 can be connected with the apparatus 3304 through a connector box, such as the connector box 3312, shown and described with reference to FIGS. 33A and 33B.

The system 3600 can include an external power source 3616. In some embodiments, The external power source 3616 can be an AC power source, such as the grid (e.g., the utility grid), a programmable power source, or any other AC power source. The external power source 3616 can be configured to provide single-phase and/or three-phase AC power. The external power source 3616 can be connected with the vehicle charging station 3602 and/or the apparatuses 3604-3608. The external power source 3616 can be connected with the vehicle charging station 3602 and/or the apparatuses 3604-3608 through a cable 3618. The cable 3618 can include one or more conductors, which may depend on the number of phases of the external power source 3616.

In some embodiments, the external power source 3616 can be a DC power source. For example, the external power source 3616 can be or include a battery, a DC generator, a fuel cell, a solar cell, etc. The external power source 3616 can include a single power source or can include separate power sources for different subsets of apparatuses (e.g., a separate power source for each apparatus or individual power sources for different quantities of apparatuses).

The system 3600 can be or include a hybrid system in which the apparatuses 3604-3608 are each configured to receive (e.g., via separate input ports or sets of input ports) DC power and/or AC power from the vehicle charging station 3602 and/or the external power source 3616. The power from the external power source 3616 can be used to charge or provide power to the control and/or communication modules of the apparatuses 3604-3608. For instance, the apparatuses 3304-3308 can receive first power as DC power from the vehicle charging station 3602 and/or second power as AC power from the external power source 3616. The apparatuses 3604-3608 can supply the DC power to the vehicles 3610-3614, in some cases one-by-one in separate charging sessions. For example, the apparatus 3604 can complete a charging session with the vehicle 3610 with the DC power from the vehicle charging station 3602, then the apparatus 3606 can complete a charging session with the vehicle 3612 with DC power from the vehicle charging station 3602 (e.g., through the apparatus 3604), then the apparatus 3608 can complete a charging session with the vehicle 3614 with DC power from the vehicle charging station 3602 (e.g., through the apparatuses 3604 and 3606). The first power received from the vehicle charging station 3602 and second power received from the external power source 3616 can be any combination of AC and DC power (e.g., the first power can be either of AC power or DC power and the second power can be either of AC power or DC power, depending on the embodiment).

The apparatuses 3604-3608 and the vehicle charging station 3602 can be connected with a power cable 3620 (e.g., a DC power cable or an AC power cable, in some cases depending on the type of power the vehicle charging station 3602 is configured to provide) or power cables 3620. The power cables 3620 can each include one or more conductors for the following ports of the apparatuses 3604-3608 and/or the vehicle charging station 3602: DC+, DC−, CP, PP, PE, L1, L2, L3, N, for example. The power cables 3620 can include conductors that correspond to the type of power being provided by the vehicle charging station 3602. For example, when the vehicle charging station 3602 is a DC charger, the power cables 3620 can include DC+, DC−, CP, PP, and PE conductors. When the vehicle charging station 3602 is an AC charger, the power cables 3620 can include CP, PP, PE, L1, L2, L3, N conductors. The power cables 3620 can be configured to conduct AC and/or DC power and/or communication signals from the vehicle charging station 3602 to the respective apparatuses 3604-3608.

The power cable 3618 can be configured to provide power through different conductors to one or more for the apparatuses 3604-3610 and/or the vehicle charging station 3602. The power cable 3618 can include one or more conductors for ports of the apparatuses 3604-3608 and/or the vehicle charging station 3602. For example, the power cable 3618 can include conductors based on the type of power the external power source 3616 provides, similar to the above. The power cable 3618 can be configured to conduct power from the external power source 3616 to the vehicle charging station 3602 and/or the respective apparatuses 3604-3608.

In some cases, the power cable 3618 and the power cables 3620 can be combined into a single cable (e.g., a backbone cable). For example, the power cable 3618 and each of the power cables 3620 may be consolidated into a single cable that runs between the apparatuses 3604-3610 from the vehicle charging station 3602.

In some cases, the apparatuses 3604-3608 can direct power (e.g., second power) from the external power source 3616 to connected vehicles when another vehicle connected with an apparatus is receiving power (e.g., first power) from the vehicle charging station 3602. For example, while the apparatus 3604 is providing power from the vehicle charging station 3602 to the vehicle 3610 in a first configuration, the apparatuses 3606 and 3608 can respectively provide power from the external power source 3616 to the vehicles 3612 and 3614 in a second configuration. In doing so, the apparatuses 3606 and 3608 can charge the batteries of the vehicles 3612 and 3614 to decrease the amount of time the vehicles 3612 and 3614 will need to be charge by power from the vehicle charging station 3602. The power from the external power source 3616 can additionally or instead condition or heat up the batteries of the vehicles 3612 and 3614, such as to increase the speed with which the apparatuses 3606 and 3608 will charge the vehicles 3612 and 3614 when charging the vehicles 3612 and 3614 with power from the vehicle charging station 3602. In some cases, the power from the external power source 3616 can cause the vehicles 3612 and 3614 to lock to the cables connecting the vehicles 3612 and 3614 to the apparatuses 3606 and 3608, as described herein.

In some cases, the apparatuses 3604-3608 can use the power from the external power source 3616 to simulate a charging session or to otherwise lock vehicles to cables connected the vehicles to the apparatuses 3604-3608. For example, when connected to vehicles not being charged in a charging session with power from the vehicle charging station 3602, the apparatuses 3604-3608 can transmit communication signals to the vehicles to simulate a charging session with the vehicles, as described herein, to lock the vehicles to the respective apparatuses 3604-3608. The apparatuses 3604-3608 can do so using power from the external power source 3616. In some cases, the apparatuses 3604-3608 can direct power from the external power source 3616 to the connected vehicles to supply the minimum required power to lock the vehicles. The minimum required power can be created or adjusted from the power provided by the external power source 3616 by one or more converters in the apparatuses, in some cases.

For example, while the apparatus 3604 charges the vehicle 3610 with power from the vehicle charging station 3602, the apparatuses 3606 and 3608 may provide power from the external power source 3616 to the vehicles 3612 and 3614. In cases in which the power source 3616 is an AC power source, multiple vehicles may be charged in parallel from the power source 3616 (e.g., a single source) because AC power is at a standard voltage. In doing so, the charging current may be divided between the vehicles. The number of vehicles charged in parallel may need to be managed to avoid drawing a total charging current that exceeds the current capacity of the available AC power supply of the external power source 3616. In some cases, parallel charging may be not possible with DC fast chargers, which modulate their output voltages to meet the needs of the vehicle battery being charged, and thus may only be able to match to one vehicle battery at a time.

As an AC power source, the external power source 3616 may be a single-phase supply or a three-phase supply. The phases of the three-phase supply may be separated, enabling each phase to be used to charge a single vehicle. This may help eliminate difficulties that could be caused by interactions between the charging circuits of the vehicles 3610-3614 transmitted through the system 3600.

In some cases, the vehicles 3612 and 3614 may alternatively be charged at relatively low power using DC charging. For example, the apparatuses 3604-3608 may each be equipped or include a rectifier or converter (or other electric vehicle service equipment (EVSE) that is configured to convert AC power to DC power). The apparatuses 3606 and 3608 can receive AC power from the external power source 3616 (e.g., the electrical grid) and convert the AC power to DC power. The apparatuses 3606 and 3608 can convert the AC power to DC power with the rectifier or converter that matches the output DC voltage to the requirement of the vehicle battery being charged.

One use for the system 3600 can be to condition vehicle batteries while they are waiting for their turn to receive fast (e.g., DC) charging with power from the vehicle charging station 3602. For example, the rate at which vehicle batteries can be charged can depend in part on their internal temperature. When a battery is relatively cool, the charge controller in the battery management system may charge the battery relatively slowly, then accelerate charging as the battery warms up to full charging temperature. As a consequence, if a vehicle is connected to one of the apparatuses 3604, 3606, or 3608 and has been awaiting its turn to connect to the vehicle charging station 3602 for charging (e.g., DC charging), the vehicle's battery may have cooled during the waiting period. As a result, when it is the vehicle's turn to charge from the vehicle charging station 3602, its battery management system may cause it to charge relatively slowly at first, while its battery warms up. Since the high-power capability of the vehicle charging station 3602 is the scarce resource being managed by the system 3600, operating the vehicle charging station 3602 at relatively low power may not be the optimal use of that resource.

Accordingly, the apparatuses 3604-3608 can begin to charge the vehicles 3610-3614 using power (e.g., AC power or DC power from the external power source 3616) while the vehicles 3610-3614 wait for their respective turn to connect to the vehicle charging station 3602 for charging with power from the vehicle charging station 3602. In some cases, doing so can prepare, or condition, the batteries of the vehicles for faster charging before DC fast charging session begins, enabling the vehicles to draw higher power from the vehicle charging station 3602 earlier in the fast charging sessions and improving the utilization of the vehicle charging station 3602.

In one example, referring now to FIG. 36B, a block diagram of the system 3600 for charging vehicles in a daisy chain configuration is shown, according to an embodiment of the present disclosure. The system 3600 can be the same as or similar to the system 300, shown and described with reference to FIG. 30. The system 3600 can include a vehicle charging station 3602 and apparatuses 3604 and 3606. The vehicle charging station 3602 can be the same as or similar to the charge point 3002, shown and described with reference to FIG. 30. The vehicle charging station 3602 can provide DC or AC power to the apparatuses 3604 and 3606. The apparatuses 3604 and 3606 can be the same as or similar to the apparatuses 3004a-b, shown and described with reference to FIG. 30. The external power source 3616 can provide power to the apparatuses 3604 and 3606. The apparatuses 3604 and 3606 can provide AC and/or DC power to the connected vehicles 3610 and 3612. The apparatus 3604 can direct DC and/or AC power from the vehicle charging station 3602 and/or AC and/or DC power from the external power source 3616 to the apparatus 3606.

The apparatuses 3604 and 3606 can respectively include processors 3622a-b, network interfaces 3624a, converters 3626a-b, locking mechanisms 3628a-b, input ports 3630a-b (e.g., sets of input ports 3630a-b), output ports 3632a-b (e.g., sets of one or more output ports 3632a-b), output ports 3634a-b (e.g., sets of one or more output ports 3634a-b), and/or switches 3636a-b. The components 3622a-3636b can be the same as or similar to the corresponding components 3006a-3026b of the apparatuses 3004a and 3004b, shown and described with reference to FIG. 30.

The system can include locking and control mechanisms 3638a-b. The locking and control mechanisms 3638a-b can lock cables connecting the apparatuses 3604 and 3606 to the vehicles 3610 and 3612 for charging and/or to stop the cables from being removed from the vehicles 3610 and 3612. The locking and control mechanisms 3638a-b and/or the methods of operating or controlling the locking and control mechanism 3638a-b can be the same as or similar to the locking and control mechanisms 3030a-3030b, shown and described with reference to FIG. 30.

The apparatuses 3604 and 3606 can receive power (e.g., AC or DC power) from the external power source 3616 through input ports 3630a-3630b (first sets of inlet ports). The input ports 3640a-b (e.g., second sets of inlet ports) can each be or include a set of one or more input ports. The input ports 3640a-b can be separate from the input ports 3630a-b and be specifically configured to receive single-phase or three-phase AC power and/or DC power from the external power source 3616. The external power source 3616 can continuously or constantly provision AC or DC power through the input ports 3640a-b to power the apparatuses 3604 and 3606, such as to power the different components (e.g., the processors 3622a-b, the network interfaces 3624a-b, and/or the locking mechanisms 328a-b, etc.) of the apparatuses 3604 and 3606 for operation. Thus, the external power source 3616 can be used to facilitate operation of the apparatuses 3604 and 3606 for charging and/or locking the vehicles 3610 and 3612.

In some cases, the external power source 3616 can provide AC or DC power to the apparatuses 3604 and 3606 that can be used to power the vehicles 3610 and 3612. For example, the apparatuses 3604 and 3606 can receive power from the external power source 3616. The switches 3636a-b can each be configured to direct the power from the external power source 3616 to the output ports 3632a-b to charge the connected vehicles 3610 and 3612. Doing so can charge the batteries of the vehicles 3610 and 3612 with AC or DC power, condition the batteries for subsequent fast charging with power (e.g., AC or DC power) from the vehicle charging station 3602, and/or cause the vehicles 3610 to activate a locking mechanism to lock the vehicles to vehicle connectors connecting the vehicles with the apparatuses 3304 and 3306.

In some embodiments, the apparatuses 3604 and 3606 include the converters 3626a-b. The converters 3626a-b can be or include rectifiers or inverters configured to rectify AC power received from the external power source 3616 into DC power, convert DC power from the external power source 3616 into AC power, and/or adjust a magnitude of the DC power or AC power. The apparatuses 3604 and 3606 can receive power from the external power sources 3616 at the input ports 3640a-b that then travels to the converters 3626a-b. The converters 3626a-b can convert the AC power to DC power or DC power to AC power. The converted power can travel through the switch 3636a-b and output ports 3632a-b to the vehicles 3610 and 3612, respectively. The apparatuses 3604-3606 can charge or provide the converted DC power or AC power to the vehicles 3610 and 3612 that originated at the external power source 3616. In some cases, the converters 3626a-b can be configured to adjust a voltage of a power source. For example, the converters 3626a-b can be configured to adjust power from a DC power source by adjust (e.g., increase or decrease) the voltage of the DC power from a first voltage to a second voltage. The converters 3626a-b can similarly adjust AC power from a first voltage (e.g., amplitude) to a second voltage. The converters 3626a-b can do so, for example, to reach a defined voltage to perform an operation, such as to simulate a charging session or condition a battery. In some cases, the processors 3622 can dynamically change (e.g., automatically change in response to detecting a connection with the respective apparatuses 3604 and 3606) the adjustment based on the vehicle or vehicle type (determined as described herein) of vehicles connected with the respective apparatuses, such as to provide the vehicles with required voltages to simulate a charging session or condition their batteries, which may differ between different vehicles or vehicle types.

In some embodiments, the converters 3626a-b can be bi-directional converters to perform both AC-to-DC and DC-to-AC power conversions. Accordingly, the converters 3626 can be used for bi-directional power transfers. For example, the apparatus 3604 can supply AC power from the external power source 3616 as an AC power source to the vehicle 3610 by converting the AC power from the external power source 3616 to DC power via the rectifier or the bidirectional converter 3626a and supply the converted DC power to the vehicle 3610 via the outlet port 3632a. Additionally, the apparatus 3604 can receive DC power from the vehicle 3610 via the output port 3632 and convert it to AC power via the converter 3626a or an inverter for supply to the external power source 3616 or route the DC power or the converted AC power to another apparatus. The converters 3626a-b can similarly convert the voltage of power from vehicles to different values (e.g., to match the voltage of the power sources 3616) in AC-AC and/or DC-DC power conversions, such as to enable or facilitate charging of the power sources 3616. The directionality of the converters 3626a-b can be controlled by the processors 3622a-b and/or another computing device, such as in response to a user input, an automated control schedule, or a message from another computing device.

The system 3600 can include a computing device 3642. The computing device can include one or more processors and a memory. The memory can include machine-readable instructions that the one or more processors can execute to control operation of other components within the system 3600. For example, the computing device 3642 can operate as a system controller that controls which apparatus provides power from the vehicle charging station 3602 and which apparatuses provide power from the external power source 3616 within the system 3600. The computing device 3642 can do so based on communication signals that the computing device 3642 receives from the apparatuses 3604 and 3606, such as communication signals indicating the arrival or connection of the vehicles 3610 and 3612 at the respective apparatuses 3604 and 3606. The computing device 3642 can receive such communication signals over a network (e.g., from the network interfaces 3624a-b) of the apparatuses 3604 and 3606. Based on such communication signals, the computing device 3642 can transmit control signals to the apparatuses 3604 indicating whether to provide power from the vehicle charging station 3602 (e.g., DC power or AC power) or power from the external power source 3616 (e.g., DC power or AC power) to connected vehicles.

In some cases, the computing device 3642 can control the apparatuses through a single computing device in communication with the apparatuses. For example, only one apparatus of the apparatuses, a connector box (as described herein) connected with the apparatuses, or another local computing device may have a communications interface that can access the Internet or a wireless network to communicate with the computing device. The computing device 3642 can control the apparatuses through the one apparatus or the connector box by transmitting control instructions to the apparatus or connector box with identifications of the apparatuses the computing device 3642 is controlling. The apparatus or connector box can propagate the instructions to the identified apparatuses to facilitate control of the apparatuses. In turn, the apparatuses can transmit messages (e.g., indications indicating connections with the apparatus) to the apparatus or connector box, and the apparatus or connector box can transmit the messages to the computing device 3642 such that the computing device 3642 may operate the system 3600 to charge one vehicle at a time with power from the vehicle charging station 3602 (e.g., for DC fast charging).

To control whether the apparatuses 3604 and/or 3606 provide power from the vehicle charging station 3602 or the power sources 3616 to the vehicles 3610 and 3612, the computing device 3642 can control the positioning of the switches 3636a-b within the apparatuses 3606. For example, the switches 3636a-b can each include one or more switches (e.g., as a system or set of switches) and/or can be configured such that power (e.g., power from the vehicle charging station 3602) received through the input ports 3630a-b is directed to or through the output ports 3632a-b or the output ports 3634a-b. The switches can also be positioned such that power (e.g., power from the power source 3616) received through the input ports 3640 is directed to the output ports 3632a-b. The computing device 3642 can control the positioning of the switches 3636a-b to control the direction of distribution of the power from the external power source 3616 and/or the power from the vehicle charging station 3602 from the apparatuses 3604 and/or 3606 to the connected vehicles 3610 and/or 3612 and/or the next apparatus in the daisy chain of apparatuses of the system 3600.

For instance, the computing device 3642 can adjust or set the position of the switch 3636a of the apparatus 3604 such that the power originating from the vehicle charging station 3602 travels out of the output port 3634a and into the input port 3630b of the apparatuses 3606. In doing so, the computing device 3642 can also adjust or set the position of the switch 3636a to direct power (e.g., DC or AC power) from the external power source 3616 to the output port 3632a to either charge or lock (e.g., in combination with communication messages, as described herein) the vehicle 3610 to the apparatus 3604 through the cable connecting the apparatus 3604 to the vehicle 3610. The apparatus 3604 can be in a first configuration when the switch 3636a is in this configuration. The computing device 3642 can additionally or instead set the position of the switch 3636b such that the power (e.g., DC or AC power) from the apparatus 3604 travels to the output port 3632b and to the vehicle 3612 for charging. The position may cause the power from the external power source 3616 to be discarded or not to be discharged through the apparatus 3606. The apparatus 3604 can be in a second configuration when the switch 3636a is in this position or configuration. The computing device 3642 may set corresponding switches in each other apparatus of the system 3600 such that the external power source 3616 travels to connected vehicles, locking the respective vehicles to the connected apparatuses and/or conditioning (e.g., heating) the batteries of the vehicles for fast charging. The other apparatuses may not receive power, or may receive minimal power, from the vehicle charging station 3602 because the power from the vehicle charging station 3602 is charging the vehicle 3612 connected with the apparatus 3604. The computing device 3642 can set the positioning of the switches 3636b in any manner, and/or such that only one vehicle is being charged with power from the vehicle charging station 3602 at a time while one or more other apparatuses are provisioning power from the external power source 3616 to connected vehicles.

The computing device 3642 can adjust the configuration of the switches of apparatuses for charging over time. The computing device 3642 can do so based on indications or messages received from apparatuses to which different computing devices have been connected. For example, the computing device 3642 can receive a first indication from the apparatus 3604 indicating that the vehicle 3610 has connected with the apparatus 3604. Subsequently, the computing device 3642 can receive a second indication from the apparatus 3606 indicating that the vehicle 3638b has connected with the apparatus 3606. Based on the indications, the computing device 3642 can first adjust a configuration of the switch 3636a to power the vehicle 3610 with power from the vehicle charging station 3602 when the apparatus 3604 is in the first configuration. The computing device 3642 can adjust the switch 3636b such that the vehicle 3612 receives power from the external power source 3616 when the apparatus 3606 is in the second configuration. The computing devices 3642 can select and/or implement such switch positionings based on the vehicle 3610 connecting with the apparatus 3604 prior to the vehicle 3612 connecting with the apparatus 3606. Accordingly, the computing device 3642 can initiate a charging session between the vehicle 3610 and the apparatus 3604 while the apparatus 3606 conditions and/or locks the vehicle 3612 to the apparatus 3606.

The computing device 3642 can change configurations of the switches 3636a-3636b. For example, subsequent to completing the charging session with the vehicle 3610, the apparatus 3604 can transmit a signal or message to the computing device 3642 indicating the completion of the charging session. The computing device 3642 can receive the message and determine not to charge the vehicle 3610 with the power from the vehicle charging station 3602. Based on the determination and/or the signal or message, the computing device 3642 can adjust (e.g., activate) the position of the switch 3636a such as to direct (or route) power from the external power source 3616 to the vehicle 3610 and/or to direct (or route) power from the vehicle charging station 3602 to the apparatus 3606. The computing device 3642 can additionally or instead adjust the position of the switch 3636b to direct the power from the vehicle charging station 3602 through the apparatus 3604 to the vehicle 3612 to initiate a charging session with the vehicle 3612 at the apparatus 3606. The computing device 3642 can similarly adjust the configurations of any number of switches or apparatuses connected within the system 3600 such that only one apparatus provides power from the vehicle charging station 3602 to a connected vehicle at a time (e.g., subsequent to completing the charging session at the apparatus 3606, the computing device 3642 can similarly initiate a new charging session at an apparatus connected with the apparatus 3606).

The computing device 3642 can generate a schedule indicating an order in which to initiate charging sessions with vehicles. The computing device 3642 can generate the schedule based on varying criteria. For example, the computing device 3642 can generate the schedule based on an order in which vehicles arrived or connected with apparatuses of the system 3600. The computing device 3642 can do so by maintaining a list of vehicles (e.g., a data structure including an order of identifications of the apparatuses or connections) to charge that are connected with the apparatuses and updating the list with new apparatuses or connections as further vehicles connect with the apparatuses for charging sessions and the apparatuses send or transmit messages to the computing device 3642 indicating the connections. The computing device 3642 can additionally or instead remove vehicles from the list as they complete their charging sessions. The computing device 3642 can control or transmit control signals to provide power originating from the vehicle charging station 3602 to the apparatuses connected with the vehicles in the order indicated by the list such that only one of the apparatuses provides power from the vehicle charging station at a time while the other apparatuses connected to vehicles provide power from the external power source 3616 to the vehicles to lock the vehicles to the apparatuses and/or condition the batteries of the vehicles for future charging sessions.

In some cases, the external power source 3616 may only be connected with one apparatus of the system 3600. For example, the external power source 3616 may be connected with the apparatus 3604 but not with the apparatus 3606. The computing device 3624 may set the position of the switch 3636a such that the power from the external power source 3616 travels through to the output port 3634a and to the apparatus 3606 while power from the vehicle charging station 3602 is directed to the output port 3632a and to the vehicle 3610. In some cases, the apparatus 3604 can include a separate set of output ports from which to output or distribute the power from the external power source 3616 to the apparatus 3606. The apparatus 3606 may receive the power from the external power source 3616 through the input port 3630b or a different set of input ports dedicated to receiving power from the external power source 3616. The computing device 3642 can configure or position the switch to provide the received power from the external power source through the apparatus 3604 to the output port 3632b through to the vehicle 3612. In doing so, the apparatus 3606 can condition the battery and/or lock the vehicle 3612 to the apparatus 3606 using the power from the external power source 3616 connected with the apparatus 3604. The computing device 3642 can further configure the switch 3636b and any further switches of connected apparatuses such that the power from the external power source 3616 travels through the apparatuses to lock vehicles to the respective apparatuses and/or to condition the batteries of the connected vehicles.

The apparatuses 3604, 3606, and any other apparatuses connected in series with the apparatuses 3604 and 3606 can be connected by one or more physical cables, which together may be referred to as a backbone cable. The backbone cable can be configured to transport electrical energy and various control or communication signals between the apparatuses and/or the vehicle charging station 3602. The backbone cable can include conductors to transport both DC and AC power and/or communication signals between apparatuses and/or the vehicle charging station 3602. In doing so, the backbone cable can connect with sets of input ports and output ports of the apparatuses that are dedicated to transport AC and DC power and communication signals, respectively. The backbone cable can include a single physical cable or can include multiple cables for transporting the respective types of DC or AC power and communication signals.

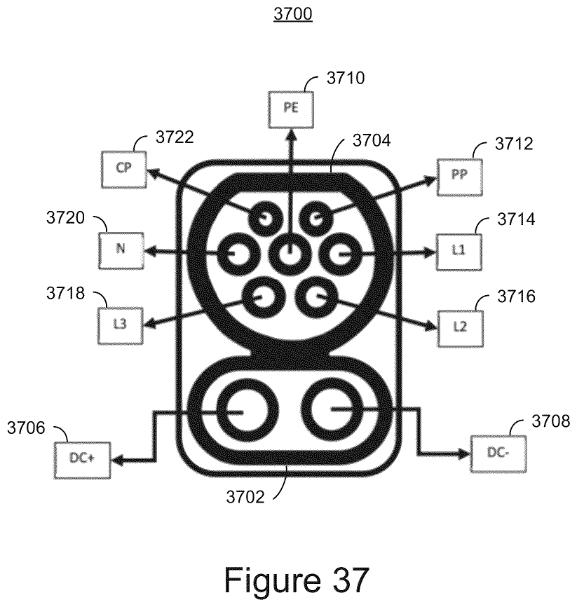

The vehicles 3610 and 3612 can be connected with the apparatuses 3604 and 3606 through vehicle charging guns that are configured to provide both AC power and DC power. An example of such a vehicle charging gun is shown in FIG. 37 as vehicle charging gun 3700, according to some embodiments. The vehicle charging gun 3700 can include DC pins 3702 and AC pins 3704. The DC pins 3702 can include a positive DC terminal 3706 and a negative DC terminal 3708. The AC pins 3704 can include a PP pin 3712, an L1 pin 3714, an L2 pin 3716, an L3 pin 3718, and an N pin 3720. The configuration of the DC pins 3702 and/or the AC pins 3704 can vary depending on the type of the vehicle charging gun 3700. The vehicle charging gun 3700 can include communication pins. The communication pins can include a PE pin 3710 and a CP pin 3722.

The vehicle charging gun 3700 can include separate conductors for the DC pins 3702, the AC pins 3704, and the communication pins. The conductors may connect with output ports of apparatuses that are dedicated to the corresponding DC pins 3702 and/or the AC pins 3704. The configuration of the vehicle charging gun 3700 can enable the system 3600 to operate because the apparatuses can switch between providing DC and AC power out of the vehicle charging guns connected with the apparatuses 3604, 3606, and 3608 when charging connected vehicles, locking the vehicles to the charging guns or apparatuses 3604, 3606, and/or 3608, and/or conditioning the batteries of the connected vehicles. Each of the apparatuses of the system 3600 can be configured with or connected to vehicle charging guns such as the vehicle charging gun 3700 to enable or facilitate the operation of the system 3600. The communication pins can additionally facilitate communication with the vehicles, such as to simulate, initiate, and/or facilitate charging sessions.

In some embodiments, the apparatuses 3604 and 3606 can operate bi-directionally. For example, each of the apparatuses 3604 and 3606 can be configured to direct power from the vehicle charging station 3602 and the external power sources 3616 to the vehicles 3610 and 3612 as well as direct power from the external power sources 3616 and the vehicles 3610 and 3612 to the vehicle charging station 3602. The apparatuses 3604 and 3606 can be configured to do so based on control signals that the apparatuses 3604 and 3606 generate or receive from different processors or computers, such as the processors 3622, the computing devices 3642, computers or processors of the vehicles 3610 and/or 3612, etc. For example, the processors 3622 can receive or generate a control signal to direct power to the vehicle charging station 3602 from the external power sources 3616 and/or the vehicles 3610 and 3612. Based on the control signal, the apparatuses 3604 and 3606 can respectively direct the power from the different power sources to the vehicle charging station 3602. In doing so, the apparatuses 3604 and 3606 can direct DC and/or AC power from the vehicles 3610 and/or 3612 and/or the external power sources 3616 to the vehicle charging station. The apparatuses 3604 and 3606 can direct the power to the vehicle charging station 3602 through any number of apparatuses that are connected in the daisy chain configuration. The apparatuses 3604 and 3606 and direct the power through cables configured to transfer the specific types of power (e.g., DC power and/or AC power), such as through the backbone cable of the system 3600. In some cases, the apparatuses 3604 and 3606 can be configured to direct power to the power sources 3616. For instance, the apparatuses 3604 and 3606 can direct power through the respective converters 3626a-b. The converters 3626a-b can convert the power to power that the power source 3616 can receive for charging and direct the power to the power source 3616. The apparatuses 3604 and 3606 can do so in response to a control signal, similar to the above. The apparatuses 3604 and 3606 can be configured to direct such power to any load. Thus, the apparatuses 3604 and 3606 can be configured in a vehicle-to-everything (V2X) configuration in which vehicles and/or external power sources connected to the apparatuses direct power to other apparatuses in the daisy chain configuration to the vehicle charging station 3602, the grid, or any load or destination.

The apparatuses 3604 and 3606 can be configured to direct communication signals to connected vehicles. The apparatuses 3604 and 3606 can do so via CP and/or PE lines in the cable connecting the apparatuses 3604 and 3606 to respective vehicles. For example, the cables connecting the apparatus 3604 and 3606 can be configured to provide power to the vehicles 3610 and 3612, respectively through AC and/or DC power lines. Additionally, the cables can include CP and/or PE lines configured for transferring communication from the apparatuses 3604 and 3606. The communication signals can originate from the vehicle charging station 3602. Such communication can be to initiate or simulate a charging session, as described herein, or to perform any other task, such as to query connected vehicles regarding information about the vehicles (e.g., information that can be used to initiate or simulate a charging session, such as to set a voltage to cause the connected vehicles to lock).

The source of the communication signals transmitted through the CP and/or PE lines can differ based on the configurations of the apparatuses 3604 and 3606. For example, when the apparatus 3604 is in the first configuration (e.g., charging the vehicle 3610 in a charging session with power from the vehicle charging station 3602), the vehicle charging station 3602 can generate and transmit messages (e.g., via a charging protocol) via the communication lines connecting the vehicle charging station 3602 to a vehicle connected to the apparatus 3604 to facilitate a vehicle charging session. While the apparatus 3604 is in the first configuration, the apparatus 3606 can be in the second configuration (e.g., providing power from the external power source 3616 to the vehicle 3612 instead of the vehicle charging station). While in the second configuration, the processor 3622b can generate and transmit messages to the vehicles 3612 via a communication line, such as to simulate a charging session at the vehicle 3612. The apparatuses 3604 and 3606 can each similarly propagate communication messages from the vehicle charging station 3602 to connected vehicles over the CP and/or PE lines and/or generate and transmit communication messages to connected vehicles over the CP and/or PE lines depending on if the apparatuses 3604 and 3606 are in the first configuration or the second configuration.

In cases in which the apparatus 3606 is in the first configuration, the vehicle charging station 3602 can transmit communication messages through the apparatus 3604, a connector box, and/or any other number of apparatuses of the daisy chain configuration of the apparatuses to the apparatus 3606 to directly communicate with the vehicle 3612. In doing so, the vehicle charging station 3602 can directly initiation and/or facilitate a vehicle charging session with the vehicle 3612.

The apparatuses 3604 and 3606 can be controlled to direct power to different loads or to vehicles. For example, after adjusting the configuration of the apparatuses 3604 and 3606 to provide power to the vehicle charging station 3602 and/or another load, the apparatuses 3604 and/or 3606 can generate or receive (e.g., from an external computing device, such as the computing device 3642) a control signal to provide (e.g., again provide) power from the vehicle charging station 3602 and/or the external power sources 3616 to connected vehicles (e.g., the vehicles 3610 and/or 3612). In response to the control signals, the apparatuses 3604 can provide or direct power to the connected vehicles as described herein, such as by only directing power from the vehicle charging station 3602 to one vehicle at a time from an apparatus in a first configuration while each other apparatus in the daisy chain provides power from the external power source 3616 in the second configuration.

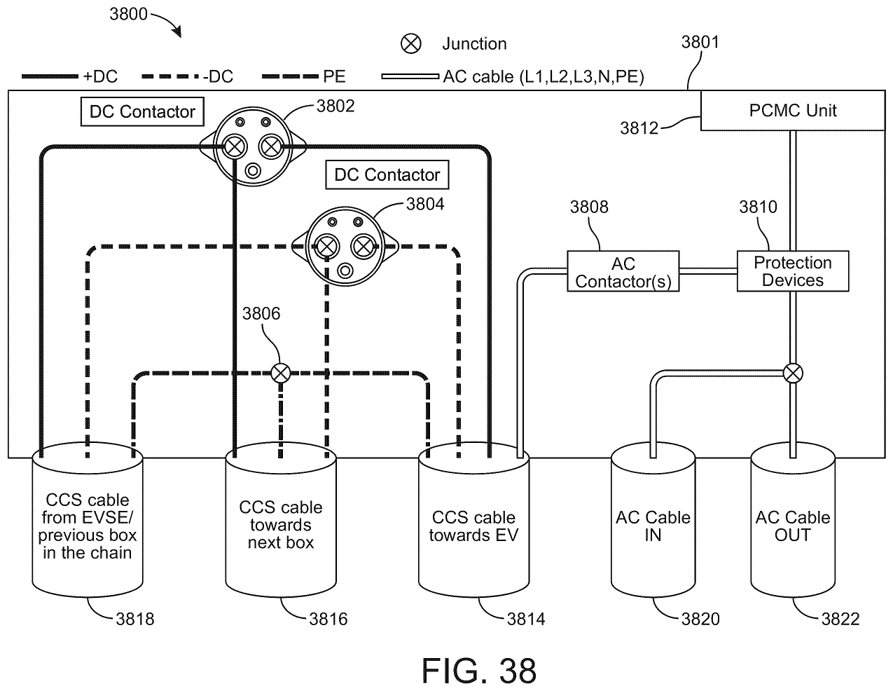

FIG. 38 is an illustration of a hybrid wiring system 3800 in which an AC supply is used for AC vehicle charging, according to an embodiment of the present disclosure. The hybrid wiring system 3800 can be a wiring diagram of an apparatus 3801, such as one of the apparatuses 3604 or 3606, for example.

The hybrid wiring system 3800 can include DC contactors 3802 and 3804, a PE contactor 3806 or a junction point 3806, AC contactors 3808, protection devices 3810, and a pulse code modulated controller (PCMC) unit 3812. The DC contactors 3802 and 3804 can be controlled such that only one vehicle is charged with DC power at a time. The PCMC unit 3812 can be or include a computing device within the apparatus 3801 with one or more processors and/or memory. While shown and described as a PCMC unit, the PCMC unit 3812 can be or include any type of controller or one or more processors. The PCMC unit 3812 can control (e.g., based on messages from a remote computing device) and/or determine whether to draw power from an AC input circuit or AC power source, to optionally supply AC charging to a vehicle connected to the apparatus 3801, such as if the vehicle is not involved in a vehicle charging session (e.g., in a DC vehicle charging session). The protection devices 3810 can include circuitry for protecting the apparatus 3801 from overheating and/or from providing too much current (e.g., surge protection devices, fuses and circuit breakers, overvoltage protection devices, etc.).

In the hybrid wiring system 3800 the contactors 3802 and 3804 can be connected with cobber-clad steel (CCS) cables 3814 that can connect with a vehicle for charging, a CCS cable 3816 configured to connect with another apparatus downstream from the apparatus 3801, and/or a CCS cable 3818 that is configured to connect with another apparatus (e.g., an apparatus closer to the vehicle charging station than the apparatus 3801). While CCS cables are shown and described, the cables 3814-3818 can be or include any type of cable (e.g., North American Charging Standard (NACS) cables or any other type of cable). The AC contactors 3808 can connect with the CCS cable 3814 and/or AC cables 3820 and 3822 to receive AC power from the AC power source. Although not shown, the apparatus 3801 can include one or more switches that can be activated or adjusted to connect the different contactors with the cables 3814-3822. The PCMC unit 3812 can control the switches to provide DC and/or AC power to different destinations, such as based on messages from the remote computing device monitoring and/or controlling the system of apparatuses.

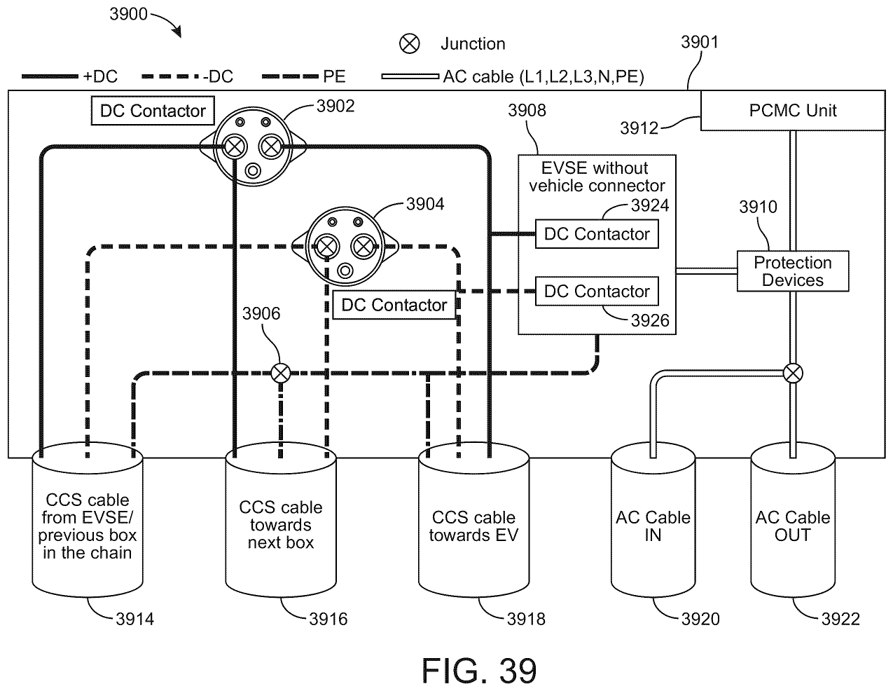

FIG. 39 is an illustration of a hybrid wiring system 3900 in which an alternating current supply is used for direct current vehicle charging, according to an embodiment of the present disclosure. The hybrid wiring system 3900 can be a wiring diagram within an apparatus 3901, such as one of the apparatuses 3604 or 3606, for example.

The hybrid wiring system 3900 can include DC contactors 3902 and 3904, a PE contactor 3906 or a junction 3906, electric vehicle service equipment (EVSE) 3908, protection devices 3910, and a PCMC unit 3912. The DC contactors 3902 and 3904 can be controlled such that only one vehicle is charged with DC power at a time. The PCMC unit 3912 can be or include a computing device within the apparatus 3901 with one or more processors and/or memory. The PCMC unit 3912 can control (e.g., based on messages from a remote computing device) and/or determine whether to draw power from an AC input circuit or AC power source. The EVSE 3908 can include a rectifier, converter, or inverter and be configured to convert AC power to DC power. The EVSE 3908 can include DC contactors 3924 and 3926, out of which the EVSE 3908 can direct DC power. The PCMC unit 3912 can draw AC power from cables 3920 and convert the AC power to DC power through the EVSE 3908. The EVSE 3908 can supply the converted DC power to a vehicle connected with the apparatus 3901, such as if the vehicle is not involved in a vehicle charging session receiving DC power from the DC contactor 3902 and 3904. The protection devices 3910 can include circuitry for protecting the apparatus 3901 from overheating and/or from providing too much current (e.g., surge protection devices, fuses and circuit breakers, overvoltage protection devices, etc.). The configuration of the hybrid wiring system 3900 can enable a vehicle that is not being charged from the vehicle charging station (e.g., the fast-charging DC circuit) to nevertheless charge using DC charging and to do so even while another vehicle is being charged via the fast-charging DC circuit through another apparatus.

In the hybrid wiring system 3900 the contactors 3902 and 3904 can be connected with CCS cables 3914 that can connect with a vehicle for charging, a CCS cable 3916 configured to connect with another apparatus downstream from the apparatus 3901, and/or a CCS cable 3918 that is configured to connect with another apparatus (e.g., an apparatus closer to the vehicle charging station than the apparatus 3901). While CCS cables are shown and described, the cables 3914-3918 can be or include any type of cable (e.g., North American Charging Standard (NACS) cables or any other type of cable). The EVSE 3908 can connect with the CCS cable 3914 and/or AC cables 3920 and 3922 to receive AC power from the AC power source to convert into DC power. Although not shown, the apparatus 3901 can include one or more switches that can be activated or adjusted to connect the different contactors with the cables 3914-3922. The PCMC unit 3912 can control the switches to provide DC power from the vehicle charging station and/or from the AC power source to different destinations, such as based on messages from the remote computing device monitoring and/or controlling the system of apparatuses.

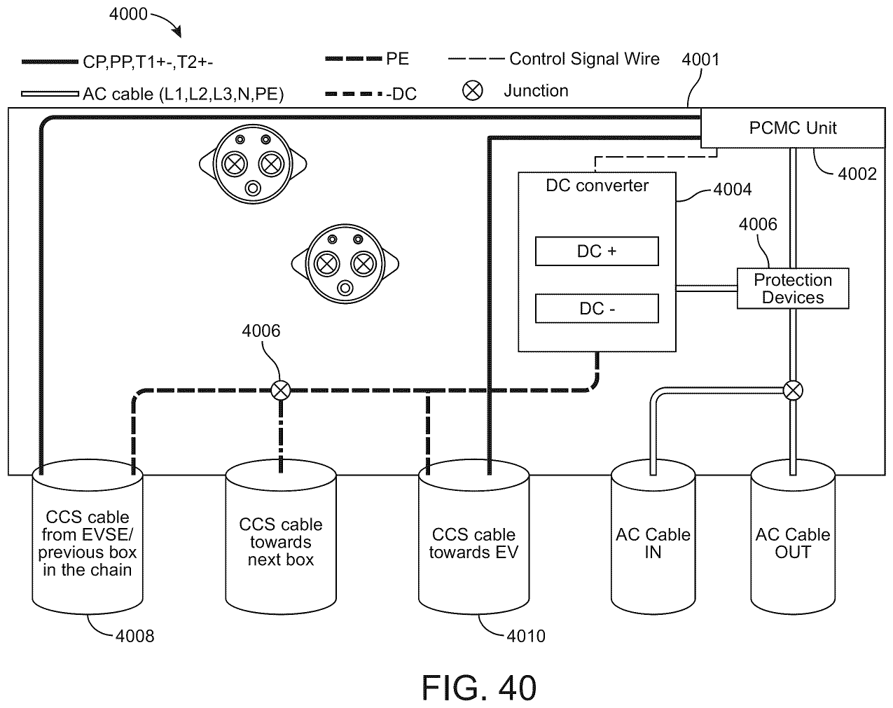

FIG. 40 is an illustration of a communication, monitoring, and control circuit, according to an embodiment of the present disclosure. The hybrid wiring system 4000 can be a wiring diagram within an apparatus 4001, such as one of the apparatuses 3604 or 3606, for example.

The hybrid wiring system 4000 can include a PCMC unit 4002, a DC converter 4004, and protection devices 4006. The PCMC unit 4002 can be connected with CCS cables 4008 and 4010 through communication wires. While CCS cables are shown and described, the cables 4008 and 4010 can be or include any type of cable (e.g., North American Charging Standard (NACS) cables or any other type of cable). The PCMC unit 4002 can transmit communication signals to different apparatuses through the communication lines, such as to manage or control a daisy chain of apparatuses charging different vehicles. Additionally, the PCMC unit 4002 can transmit signals to control switches and converters to provide power from external AC or DC power sources for charging, locking, and/or battery conditioning.

The PCMC unit 4002 can be connected with a vehicle through communication lines (e.g., CP, PE). The PCMC unit 4002 can communicate with the vehicle through the communication lines. The PCMC unit 4002 can communicate to simulate charging sessions. For example, the PCMC unit 4002 can connect with a vehicle through the control pilot line. The PCMC unit 4002 can communicate with the connected vehicle through the control pilot line using the charging communication standard to simulate a charging session, as described above.

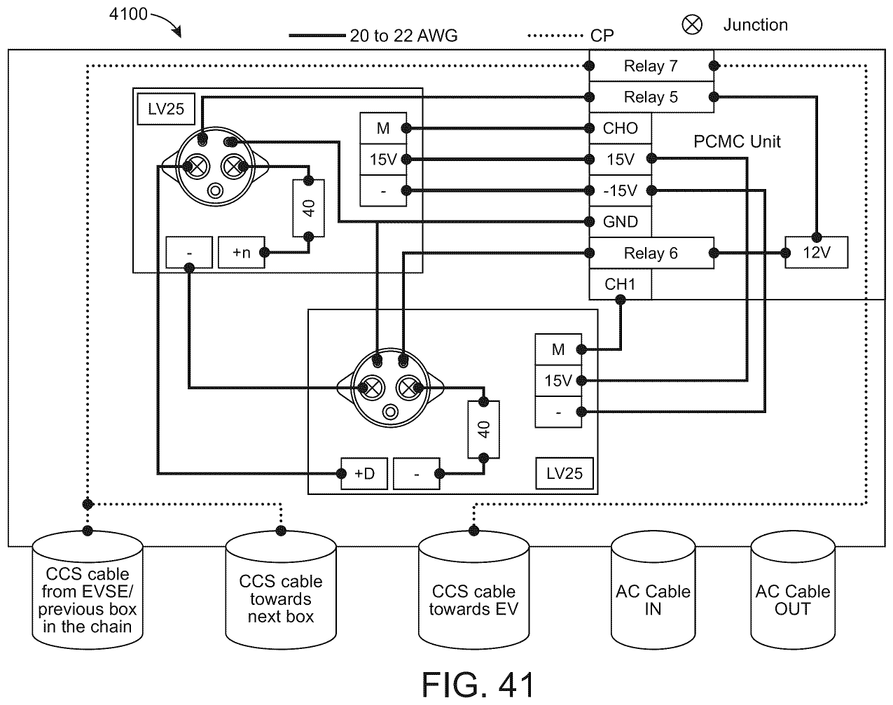

An issue that can arise with contactors used in high-power circuits (such as those shown in FIGS. 38 and 39) is that they may weld internally, becoming fixed in one or another switch position. FIG. 41 shows an embodiment of a welding detection circuit 4100 for high-power DC contactors, according to an embodiment. If the welding detection circuit determines that a contactor is welded in place, the system controller can implement appropriate control logic that can, for example, activate safety relays that will isolate the failed contactor.

In FIG. 41, the box marked LV25 is a voltage transducer. The M pin sends measured values from the “+D” and “−D” pins to the control unit. The pin marked 15V is the positive power supply for LV25, and the −15V pin below it is the negative power supply. There is one LV25 transducer for each of the contactors. If the contactors are working (e.g., not fused) and the vehicle is charging, then both M values will show the charging voltage. If the box is not charging then it will show no voltage on either one. If a contactor is welded, then the measured voltages will not match expectations. The voltage signals from the M pins can be sent to the PCMC control unit, which detects them and determines whether a contactor is welded in place.

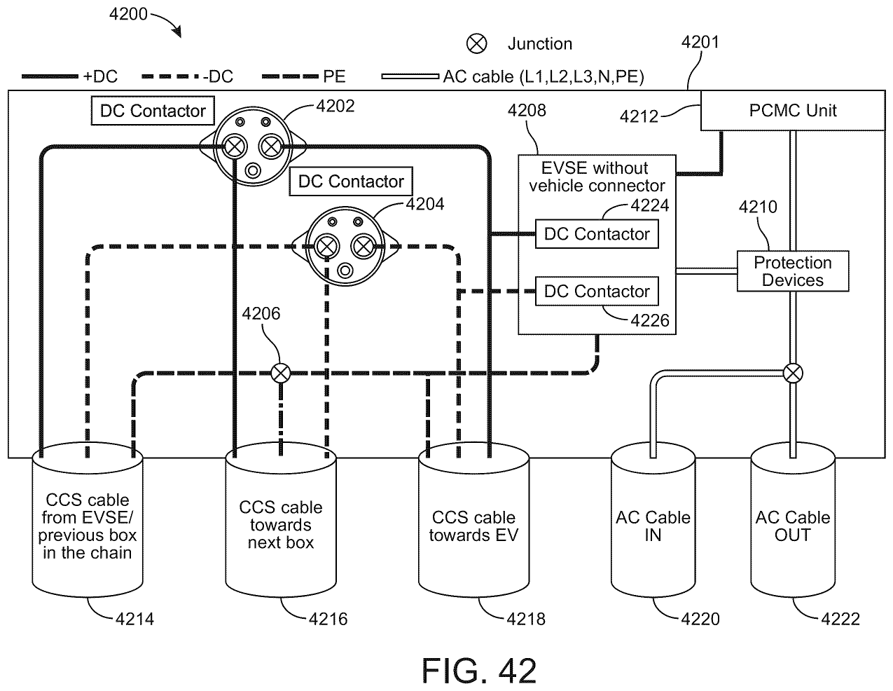

FIG. 42 is an illustration of a circuit for DC charging power from an AC power source, according to an embodiment of the present disclosure. The hybrid wiring system 4200 can be a wiring diagram within an apparatus 4201, such as one of the apparatuses 3604 or 3606, for example.

The hybrid wiring system 4200 can include DC contactors 4202 and 4204, a PE contactor 4206 or a junction 4206, a DC converter 4208, protection devices 4210, and a PCMC unit 4212. The DC contactors 4202 and 4204 can be controlled such that only one vehicle connected with a daisy chain of apparatuses is charged with DC power from a vehicle charging station at a time. The PCMC unit 4212 can be or include a computing device within the apparatus 4201 with one or more processors and/or memory. The PCMC unit 4212 can control (e.g., based on messages from a remote computing device) and/or determine whether to draw power from an AC input circuit or AC power source. The DC converter 4208 can include a rectifier, converter, or inverter and be configured to convert AC power to DC power. The PCMC unit 4212 can draw AC power from cables 4220 and convert the AC power to DC power through the DC converter 4208. The DC converter 4208 can include DC contactors 4224 and 4226 out of which the DC converter 4208 can direct DC power. The DC converter 4208 can supply the converted DC power to a vehicle connected with the apparatus 4201, such as if the vehicle is not involved in a vehicle charging session receiving DC power from the DC contactor 4202 and 4204. The protection devices 4210 can include circuitry for protecting the apparatus 4201 from overheating and/or from providing too much current (e.g., surge protection devices, fuses and circuit breakers, overvoltage protection devices, etc.). The configuration of the hybrid wiring system 4200 can enable a vehicle that is not being charged from the vehicle charging station (e.g., the fast-charging DC circuit) to nevertheless charge using DC charging and to do so even while another vehicle is being charged via the fast-charging DC circuit through another apparatus.

In the hybrid wiring system 4200 the contactors 420 and 4204 can be connected with CCS cables 4214 that can connect with a vehicle for charging, a CCS cable 4216 configured to connect with another apparatus downstream from the apparatus 4201, and/or a CCS cable 4218 that is configured to connect with another apparatus (e.g., an upstream apparatus or an apparatus closer to the vehicle charging station than the apparatus 4201). While CCS cables are shown and described, the cables 4214-4218 can be or include any type of cable (e.g., North American Charging Standard (NACS) cables or any other type of cable). The DC converter 4208 can connect with the CCS cable 4214 and/or AC cables 4220 and 4222 to receive AC power from the AC power source to convert into DC power. Although not shown, the apparatus 4201 can include one or more switches that can be activated or adjusted to connect the different contactors with the cables 4214-4222. The PCMC unit 3912 can control the switches to provide DC power from the vehicle charging station and/or AC power from the AC power source to different destinations, such as based on messages from the remote computing device monitoring and/or controlling the system of apparatuses.

The hybrid wiring system 4200 can be controlled by the PCMC unit 4212. The PCMC unit 4212 can control the DC converter 4208 to draw power from the cable 4220 and to produce or generate a voltage on the DC pins of a vehicle charging gun connected with the CCS cable 4218. In applying the voltage (e.g., 60V) to these pins, the apparatus 4201 can cause a vehicle connected with the vehicle charging gun to lock itself or remain locked to the vehicle charging gun. Thus, the hybrid wiring system 4200 can operate as a vehicle locking circuit.

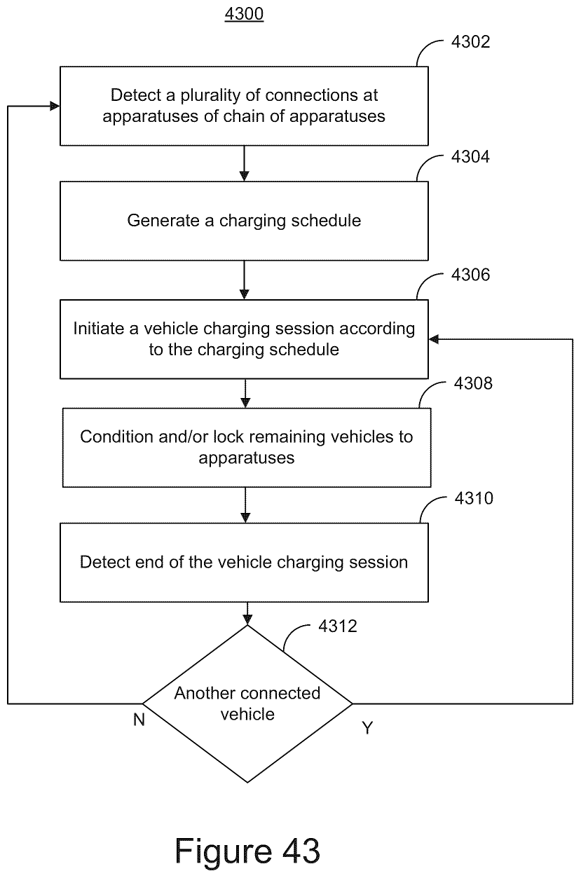

FIG. 43 is a flowchart illustrating a method 4300 for charging vehicles in a system with a daisy chain configuration, according to an embodiment of the present disclosure. The method 4300 can be performed by one or more processors of a hybrid chain of apparatuses that are connected and each configured to charge vehicles through vehicle charging guns. The one or more processors can be processors of a remote computing device (e.g., the computing device 3642) a processor of a connector box (e.g., the connector box 3312), and/or processors (e.g., the processors 3622a-b) within the apparatuses (e.g., the apparatuses 3604 and 3606) of the hybrid chain of apparatuses. The apparatuses can be connected in series with each other and/or a vehicle charging station (e.g., through a connector box, as described herein). The apparatuses can each be configured to charge connected vehicles with DC power received from the vehicle charging station and/or supply AC power from an AC power source (e.g., the utility grid) to connected vehicles. One apparatus can charge a vehicle at a time from the chain of apparatuses while the other apparatuses supply AC power to condition the batteries of connected vehicles and/or lock the vehicles to connected apparatuses (e.g., through cables and/or vehicle charging guns of the apparatuses). One or more operations of the method 4300 can be performed in conjunction with, during, or as one or more operations of the method 3500, shown and described with reference to FIG. 35.

At operation 4302, the one or more processors detect a plurality of connections at the apparatuses of the daisy chain of apparatuses. At operation 4304, the one or more processors generate a charging schedule. At operation 4306, the one or more processors initiate a vehicle charging session according to the charging schedule. The charging session can involve charging a vehicle connected with an apparatus of the daisy chain of apparatuses via a vehicle charging gun while the apparatus is in a first configuration with power from a vehicle charging station connected with the daisy chain of apparatuses. The one or more processors can complete operations 4302-4306 in the manner described with reference to operations 3502-3506, shown and described with reference to FIG. 35.

At operation 4308, the one or more processors condition and/or lock the other or remaining vehicles connected to the daisy chain of apparatuses. The one or more processors can do so using AC power or DC power. For example, in addition to transmitting a message to the apparatus to initiate the charging session to charge the vehicle with power (e.g., AC or DC power) from the vehicle charging station (e.g., for DC fast charging), the one or more processors can transmit messages to each other apparatus of the daisy chain of apparatuses that is connected with a vehicle. The message can contain instructions to provide power (e.g., AC or DC power) from an external power source connected with the other apparatuses to the connected vehicles. In response to the message, the apparatuses can change or remain in a second configuration in which the apparatuses provide power from the external power source to the connected vehicles. The power from the external power source can slowly charge the connected vehicles, can cause the vehicles to lock to vehicle charging guns connecting the vehicles to the apparatuses, and/or can condition (e.g., heat up) the batteries of the vehicles for faster charging when the one or more processors initiate vehicle charging sessions via power from the vehicle charging station with the vehicles. Receipt of the messages can cause the apparatuses to activate an internal switch to direct power from the external power sources connected with the apparatuses to the vehicles via vehicle charging guns connecting the vehicles with the respective apparatuses.

At operation 4310, the one or more processors detect an end to the vehicle charging session. The one or more processors can do so in the manner described with reference to operation 3508. At operation 4312, the one or more processors determine if there is another vehicle connected to the daisy chain of apparatuses. The one or more processors can determine another vehicle is connected by querying the charging schedule for the apparatus or vehicle with the next highest priority. Responsive to determining there is not another vehicle or apparatus listed in the vehicle charging schedule, the one or more processors can stop the method 4300. The one or more processors can return to the operation 4302 upon detecting a new connection between a vehicle and an apparatus of the daisy chain of apparatuses.

Otherwise, responsive to determining there is another connected vehicle from the charging schedule, the one or more processors can repeat operation 4306. In doing so, the one or more processors can transmit a message to the apparatus and/or vehicle of the completed charging session indicating to stop charging with power from the vehicle charging station. In some cases, at operation 4308, the one or more processors can include instructions in the message to the apparatus to lock or otherwise provide power from the external power source to the vehicle, such as to lock the vehicle to the apparatus until an authorized user unlocks the vehicle from the apparatus. The apparatus can receive the message and adjust to the second configuration accordingly. The one or more processors can transmit a message to the next apparatus in the charging schedule to initiate a vehicle charging session at the next apparatus. The next apparatus can complete the vehicle charging session in response to the message, and, at operation 4310, the one or more processors can detect the end or completion of the vehicle charging session. The one or more processors can repeat operations 4306-4312 any number of times until determining, at operation 4312, that there are not any more connected vehicles identified on the charging schedule.

Advantageously, by performing the method 4300, the one or more processors can manage charging sessions of vehicles connected to the daisy chain of apparatuses in a secure and fast manner. The one or more processors can use the hybrid system to lock and condition vehicles for future charging sessions while individual vehicles are being charged with fast charging or with power from the vehicle charging station, which can both stop unauthorized individuals from disconnecting vehicles from charging stations and ensure that individual vehicles quickly charge.

In the world of vehicle charging controls, a vehicle charging session is a term denoting both a period of time during which a vehicle is charged and a sequence of events that occurs when a vehicle charges. A vehicle charging session may result in the charging of the vehicle, but a session may also be terminated before the vehicle has been charged. For example, a vehicle charging session may be initiated but then terminated when the state of charge of the vehicle's battery has been read.

Some types of vehicles have charging controllers that implement logic requiring that, once a vehicle charging session has been terminated (or, in some cases, paused), the vehicle charging gun facilitating power transfer to the vehicle during the vehicle charging session must be physically removed from the vehicle inlet (e.g., vehicle input port), and then the same or another vehicle charging gun must be inserted into the vehicle inlet before the vehicle will start another session or resume the original one, as appropriate. Some vehicle charger implementations may impose a corresponding requirement (e.g., that the gun must be removed from the current vehicle and then inserted into the same or another vehicle before the charger will start another session or resume the original one). To provide the range of functionality intended for the dockchain or daisy chain system described herein, it is desirable to be able to stop a vehicle charging session and resume it or start another vehicle without physically moving the charging gun.

The systems and methods described herein can facilitate both the vehicle and the charger to stopping or pausing a vehicle charging session, then starting a new session or restarting the previous one, without removing the vehicle charging gun from the vehicle inlet, even if the charging control system for either the car or the charger, or both, is designed to prevent this under normal circumstances. Commonly, the vehicle charging gun contains a resistor, such that when the vehicle charging gun is inserted into a vehicle inlet, a circuit is closed that includes the resistor, enabling the vehicle and/or the vehicle charging station to determine that the vehicle charging gun is present in the vehicle inlet. When the gun is removed, the circuit that includes the resistor is broken, causing the vehicle and/or the vehicle charging station to determine that the vehicle charging gun has been removed from the vehicle inlet. In the present method, the vehicle charging gun can also contain or be connected by wiring to a switch that enables a resistor to be switched into or out of the detection circuit. By controlling the position of the switch, a control system can then cause the vehicle and/or the vehicle charging station to determine that the gun is in the vehicle inlet or out of the vehicle inlet.

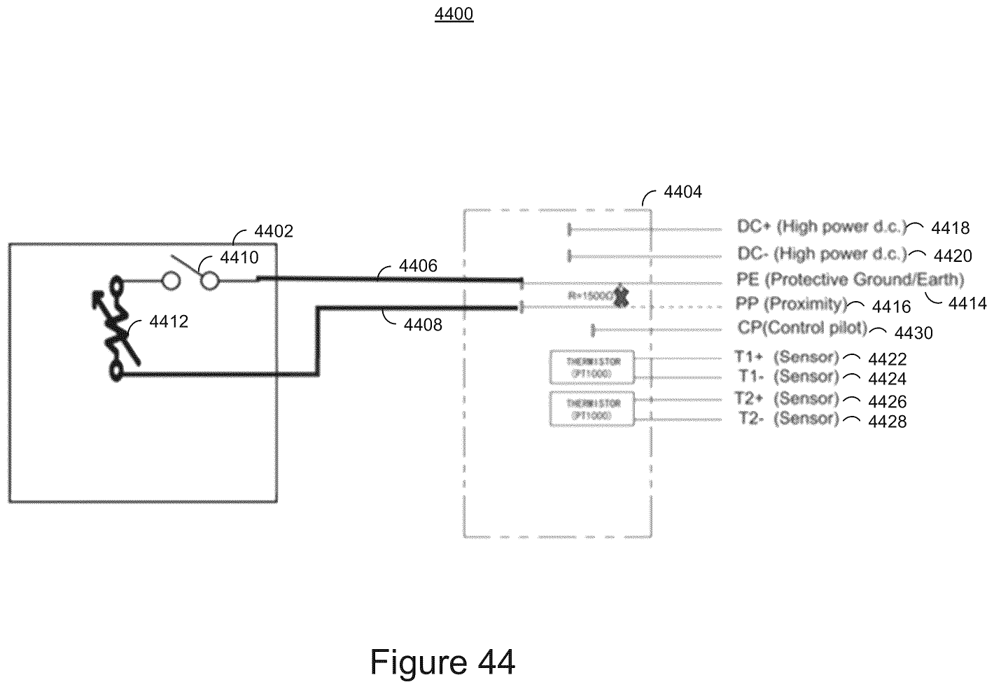

For example, referring now to FIG. 44, a block diagram of a system 4400 for charging vehicles is shown, according to an embodiment of the present disclosure. The system 4400 can include an apparatus 4402 and a vehicle charging gun 4404. The apparatus 4402 can be the same as or similar to the apparatus 3604 or the apparatus 3606, shown and described with reference to FIGS. 36A and B. The vehicle charging gun 4404 can be the same as or similar to the vehicle charging gun 3700. The vehicle charging gun 4404 can be a CCS type 2 vehicle connector. The vehicle charging gun 4404 can be connected with the apparatus 4402 through conductors 4406 and 4408. Through the conductors 4406 and 4408, the vehicle charging gun 4404 can extend from the apparatus 4402 to connect with different vehicles. Through the connections through the conductors 4406 and 4408, the vehicle charging gun 3700 can initiate and complete vehicle charging sessions with vehicles using power from a DC power source, such as a vehicle charging station, and/or an AC power source, such as the utility grid.

The apparatus 4402 can include a switch 4410 and a resistor 4412. The switch 4410 can be connected between the conductor 4406 and the resistor 4412. The conductor 4406 can directly connect the switch 4410 with a protective ground/earth (PE) pin 4414 of the vehicle charging gun 4404. The resistor 4412 can be connected between the switch 4410 and the conductor 4408. The conductor 4408 can directly connect the resistor with a proximity (PP) pin 4416. The PE pin 4414 can be configured to connect to ground. The PP pin 4416 can be configured to detect when the vehicle charging gun 4404 has been inserted into a vehicle.

In addition to the pins 4414 and 4416, the vehicle charging gun 4404 can include DC pins 4418 and 4420, sensors 4422, 4424, 4426, and 4428, and a control pilot (CP) pin 4430. The DC pins 4418 and 4420 can be configured to provide DC power to vehicles. The sensors 4422-4428 can be thermistors that monitor the temperature of the vehicle charging gun 4404 (e.g., the handle of the vehicle charging gun 4404) for control of power distribution from the vehicle charging gun 4404. The sensors 4422, 4424, 4426, and 4428 can transmit temperature measurements to the apparatus 4402, and the apparatus 4402 can reduce or increase the amount of power the apparatus 4402 is directing out of the vehicle charging gun 4404 based on the temperature measurements. For example, the sensors 4422, 4424, 4426, and 4428 can transmit temperature measurements of the temperature of the vehicle charging gun 4404 to the vehicle charging gun 4404 (e.g., over a network interface or through the conductors 4406 and/or 4408). The apparatus 4402 (e.g., a processor of the apparatus 4402) can receive the measurements and increase or decrease the amount of power the apparatus 4402 provides through the vehicle charging gun 4404 such that the temperature remains within a range (e.g., a defined range).

Normally, a CCS type 2 vehicle charging gun would include a resistor between the PE and PP pins. When the vehicle charging gun is inserted into a vehicle receiver (e.g., a vehicle inlet port), current flows through the resistor, enabling the vehicle to determine that the connector has been inserted. In contrast, as illustrated in FIG. 44, the PE pin 4414 and the PP pin 4416 of the vehicle charging gun 4404 do not have a resistor between them. Instead, the apparatus 4402 includes the resistor 4412 between the conductors 4406 and 4408 that run through a cable connecting the apparatus 4402 and vehicle charging gun 4404 and are connected to the PE and PP pins 4414 and 4416.

In addition to moving the resistor 4412 to the apparatus 4402, the apparatus 4402 can include the switch 4410 that can be controlled by a system controller (e.g., the computing device 3642 and/or processors (not shown) of the apparatus 4402). For example, the switch 4410 can be controlled to be in a first position (e.g., a closed position) that enables the vehicle or the vehicle charging station connected with the apparatus 4402 to determine (e.g., electrically detect) that the vehicle charging gun 4404 is in a vehicle outlet of a vehicle, such as because it enables the vehicle to send an electrical signal or current across the resistor 4412 that can be detected by the apparatus 4402 and/or the vehicle. The system controller can adjust the position of the switch 4410 to be in a second position (e.g., an open position). In the second position, the apparatus 4402 and the vehicle charging gun 4404 can generate an electrical effect that simulates the vehicle charging gun 4404 not being in the vehicle, even if the vehicle charging gun 4404 is physically inside a vehicle inlet port. If the apparatus 4402 terminates a vehicle charging session, the apparatus 4402 can adjust the switch 4410 to the second position (e.g., simulating the removal of the vehicle charging gun 4404 from the vehicle inlet) and then subsequently return the switch 4410 to the first position (simulating re-insertion of the vehicle charging gun 4404 into the vehicle inlet). To the vehicle and/or the vehicle charging station, it can appear as if the vehicle charging gun 4404 had been removed and re-inserted, so that the vehicle and/or vehicle charging station will enable the apparatus 4402 to resume or start a vehicle charging session.

In some embodiments, the resistor 4412 is a variable resistor. The apparatus 4402 can control or adjust the resistance of the resistor 4412, such as through a processor of the apparatus 4402. For example, the apparatus 4402 can adjust the resistance of the resistor 4412 based on a type of a vehicle that the apparatus 4402 is charging. For example, the apparatus 4402 can determine a type of a vehicle connected with the apparatus 4402 for a charging session. The apparatus 4402 can store a table of mappings between resistances to types of vehicles (e.g., different combinations of makes, models, and/or years, emergency vehicles, sedans, trucks, buses, sports cars, etc.). Responsive to detecting a connection with a vehicle for a charging session, the apparatus 4402 can determine a type of the vehicle. The apparatus 4402 can compare the type (e.g., an identification of the type of the vehicle) with the table and identify a resistance that maps to the type based on the comparison. The apparatus 4402 can adjust the resistance of the resistor 4412 to the identified resistance and initiate or complete the vehicle charging session with the vehicle.

The apparatus 4402 can determine the type of a connected vehicle by communicating with the vehicle. For example, responsive to detecting a connection with a vehicle, the apparatus 4402 can transmit (e.g., via a network or communications interface) a message or signal to the connected vehicle requesting a type of the vehicle and/or voltage at which to supply power to the vehicle. The apparatus 4402 can transmit the message over a network or over a communication line in the same cable as the conductors 4406 and 4408. A processor of the vehicle can receive the message and transmit a response with the requested information, such as with an identification of the type of the vehicle. The apparatus 4402 can supply power at the requested voltage. The apparatus 4402 can adjust the resistance of the resistor 4412 based on the identification of the type of the vehicle, such as using the table of vehicle types to resistances.

In some cases, the apparatus 4402 can adjust the position of the switch 4410 based on user inputs. For example, the apparatus 4402 can communicate with a client device being accessed by a user. The user can provide inputs into the client device that indicate whether to start or stop a charging session at the apparatus 4402. The apparatus 4402 can receive the inputs and adjust the position of the switch 4410 to the first position (e.g., the closed position) based on a request to start or restart a vehicle charging session and/or adjust the position of the switch 4410 to the second position (e.g., the open position) based on a request to stop a vehicle charging session. The adjustment to the first position or the state of switch in the first position can enable the initiation or resumption of a charging session (e.g., by the apparatus 4402) and/or otherwise initiate or resume a charging session with a vehicle. The adjustment or first position can do so because it may enable the apparatus 4402 to detect the vehicle charging gun 4404 in the vehicle.

In some cases, the apparatus 4402 can adjust the position of the switch 4410 based on a charging session status of a vehicle charging session. For example, the switch may be in the closed position during a vehicle charging session. The apparatus 4402 can determine when a connected vehicle is sufficiently charged (e.g., charged to capacity, to a defined percentage of capacity, or to a defined amount). Responsive to the determination, the apparatus can adjust the position of the switch to the open position. The apparatus 4402 can close or open the switch depending on whether the apparatus 4402 is charging a vehicle in a vehicle charging session.

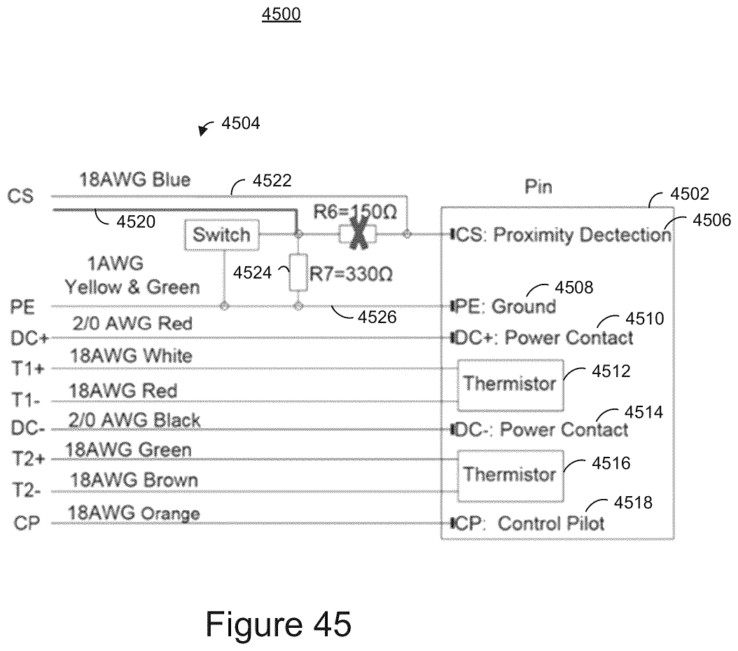

FIG. 45 is an illustration of a wiring diagram of a vehicle charging gun 4500, according to an embodiment of the present disclosure. The vehicle charging gun 4500 can be connected to an apparatus, such as the apparatus 4402, shown and described with reference to FIG. 44. The vehicle charging gun 4500 can be the same as or similar to the vehicle charging gun 3700. The vehicle charging gun 4500 can be a CCS type 1 vehicle charging gun. The vehicle charging gun 4500 can be connected to a vehicle through a vehicle inlet port of the vehicle to charge the vehicle.

The vehicle charging gun 4500 can include pins 4502 and conductors 4504 that connect with the apparatus. The pins 4502 can include a proximity detection (CS) pin 4506, a ground (PE) pin 4508, a positive DC pin 4510, a thermistor 4512, a negative DC pin 4514, a thermistor 4516, and a control pilot pin 4518. The PE pin 4508 can be configured to connect to ground. The CS pin 4506 can be configured to detect when the vehicle charging gun 4500 has been inserted into a vehicle. The pins 4502 can configured to connect with vehicle inlets of vehicles that have corresponding pins for charging sessions. The pins 4502 can additionally or instead be connected with the apparatus through the conductors 4504 of a cable. The apparatus may be connected with a DC power source (e.g., a vehicle charging station or another power source) and/or an AC power source (e.g., the utility grid or a vehicle charging station) such that the apparatus may direct power from the AC power source and/or the DC power source to vehicles for charging sessions. The CS pin 4506 can be connected with a resistor of an apparatus (e.g., the apparatus 4402) through a conductor in the same manner as the PP pin 4416, and the PE pin 4508 can be connected with a switch of the apparatus through a conductor in the same manner as the PE pin 4414, both shown and described with reference to FIG. 44.

The resistor that is normally present inside the CCS type 1 vehicle charging gun is shown with an X through it in FIG. 45. Instead, the vehicle charging gun 4500 can include a conductor 4520 inside the cable with the conductors connected to the pins 4506-4518. The conductor 4520 can run parallel to a CS line 4522 or conductor and connect to the junction at the top of a resistor 4524 (e.g., a second resistor). Inside the apparatus connected with the vehicle charging gun 4500, the resistor and switch would be connected (e.g., directly connected) between the conductor 4520 and the CS line 4522. For instance, the conductor 4520 can be directly connected or coupled to the switch and a conductor 4526 can connect the PE pin 4508 with the resistor in the apparatus. Accordingly, the resistor can be located so as to enable current to flow between the CS and PE pins of the vehicle charging gun 4500.

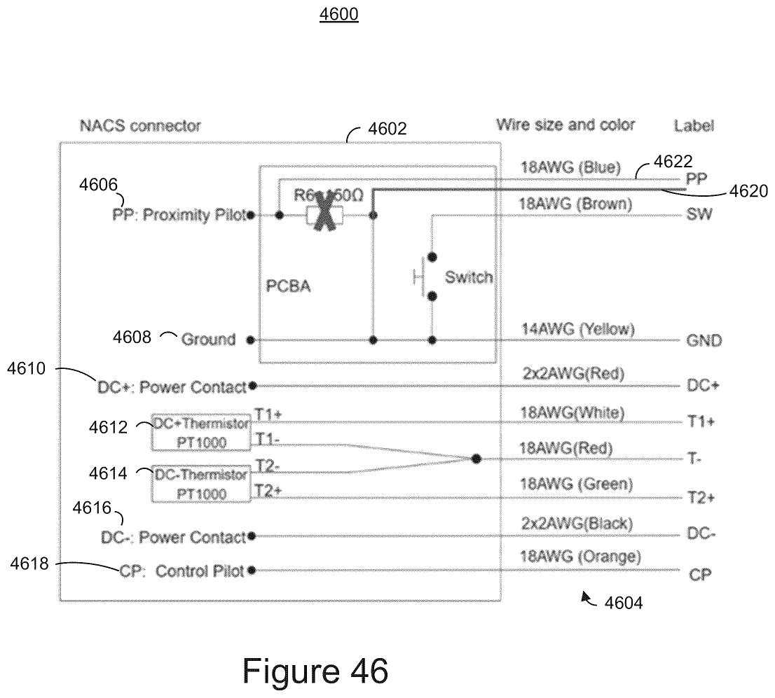

FIG. 46 is an illustration of a wiring diagram of a vehicle charging gun 4600, according to an embodiment of the present disclosure. The vehicle charging gun 4600 can be connected to an apparatus, such as the apparatus 4402, shown and described with reference to FIG. 44. The vehicle charging gun 4600 can be the same as or similar to the vehicle charging gun 3700. The vehicle charging gun 4600 can be an NACS vehicle charging gun. The vehicle charging gun 4600 can be connected to a vehicle through a vehicle inlet port of the vehicle to charge the vehicle.

The vehicle charging gun 4600 can include pins 4602 and conductors 4604 that connect with the apparatus. The pins 4602 can include proximity pilot PP pin 4606, a ground pin 4608, a positive DC pin 4610, thermistors 4612 and 4614, a negative DC pin 4616, and a control pilot pin 4618. The ground (GND) pin 4608 can be configured to connect to ground. The proximity pilot pin 4606 can be configured to detect when the vehicle charging gun 4600 has been inserted into a vehicle. The pins 4602 can configured to connect with vehicle inlets of vehicles that have corresponding pins for charging sessions. The pins 4602 can additionally or instead be connected with the apparatus through the conductors 4604 of a cable. The apparatus may be connected with a DC power source (e.g., a vehicle charging station or another power source) and/or an AC power source (e.g., the utility grid or a vehicle charging station) such that the apparatus may direct power from the AC power source and/or the DC power source to vehicles for charging sessions.

The resistor that is normally present inside the NACS type vehicle charging, is shown with an X through it. The vehicle charging gun 4600 can be implemented without requiring an additional conductor in the cable of the conductors 4604, such as because the right side of the removed resistor connects to the GND line (e.g., the conductor connected with the ground pin 4608), which is already present in the cable. In some embodiments, a conductor 4620 in the apparatus can connect directly with the ground pin 4608. The conductor 4620 can run parallel to a PP line 4622 (e.g., a conductor) connected with the PP pin 4606 of the vehicle charging gun 4600. The resistor and switch inside the apparatus can be connected between the conductors 4620 and 4622 to connect with the ground pin 4608 and the PP pin 4606 (e.g., the PP pin 4606 can connect directly with the switch and the ground pin 4608 can connect directly with the resistor). The switch can enable current to flow between the pins 4606 and 4608 when the switch is in the first position (as described with reference to FIG. 44).

While the vehicle charging guns 4404-4600 are illustrated to show showed a resistor as being removed from the vehicle charging guns 4404-4600 and relocated to the apparatus 4402, in some embodiments, the vehicle charging guns 4404-4600 would include the resistor and instead also include a controllable switch that can disconnect the resistor from the respective ports of the vehicle charging gun and/or the apparatus 4402. In this implementation, the apparatus 4402 could control the controllable switch and/or a variable resistance of the resistor through a communication path. For instance, the apparatus 4402 could control or adjust the resistance of the resistor and/or the position of the switch via conductors in the cable connecting the apparatus 4402 to the vehicle charging gun 4404, 4500, or 4600 or wirelessly (e.g., via a wireless network interface of the apparatus 4402).

FIG. 47 is a flowchart illustrating a method 4700 for charging vehicles in a system with a daisy chain configuration, according to an embodiment of the present disclosure. The method 4700 can be performed by one or more processors of a hybrid chain of apparatuses that are connected and each configured to charge vehicles through vehicle charging guns. The one or more processors can be processors of a remote computing device (e.g., the computing device 3642), a processor of a connector box (e.g., the connector box 3312), and/or processors (e.g., the processors 3622a-b) within the apparatuses (e.g., the apparatuses 3604 and 3606) of the hybrid chain of apparatuses. The apparatuses can be connected in series with each other and/or a vehicle charging station (e.g., through a connector box, as described herein). The apparatuses can each be configured to charge connected vehicles with DC power received from the vehicle charging station and/or supply AC power from an AC power source (e.g., the utility grid) to connected vehicles. One apparatus can charge a vehicle at a time from the daisy chain of apparatuses while the other apparatuses supply AC power to condition the batteries of connected vehicles and/or lock the vehicles to connected apparatuses (e.g., through cables and/or vehicle charging guns of the apparatuses).

At operation 4702, an apparatus of the daisy chain of apparatuses can detect a connection with a vehicle. The connection can be between the vehicle and the apparatus. For example, a vehicle charging gun extending from the apparatus can be inserted into an inlet port of the vehicle. The apparatus can detect the connection with the vehicle based on signals the vehicle sends to the apparatus through the vehicle charging gun responsive to the vehicle charging gun being inserted into the inlet port of the vehicle and/or through a wireless connection established between the vehicle and the apparatus.

At operation 4704, the apparatus determines a type of the vehicle. The apparatus can determine the type of the vehicle by communicating with the vehicle. Examples of types of vehicles can include, but are not limited, different makes, models, and/or years of the vehicles, emergency vehicles, sedans, trucks, buses, sports cars, etc. In one example, responsive to detecting the connection with the vehicle, the apparatus can transmit a message to the vehicle requesting information about the vehicle. In response to the request, the vehicle can transmit the requested information about the vehicle, such as a type of the vehicle, an identifier of the vehicle (e.g., a vehicle identification number (VIN), an Internet Protocol (IP) address, a media access control (MAC) address, etc.), and/or a voltage for a charging session. In some cases, the vehicle can automatically transmit such information to the apparatus responsive to the connection. The apparatus can determine the type of the vehicle by identifying the type from the requested information or based on information received in the requested information.

For instance, in some embodiments, the apparatus can determine the type of the vehicle based on the identifier of the vehicle that the apparatus receives. For example, the apparatus can store a table containing mappings between defined portions (e.g., defined digits) of identifiers of vehicles to types of vehicles. The apparatus can receive the identifier of the connected vehicle and identify the defined portion of the identifier of the vehicle. The apparatus can compare the identified defined portion of the identifier of the vehicle with the mapping to identify a type of vehicle that corresponds to a mapping with the defined portion of the identifier.

In another example, the table can include mappings between voltage and/or current limitations and different vehicle types. The voltage and/or current limitations can be defined values of voltage and/or current and/or ranges of voltage and/or current. The requested information can include voltage and/or current limitations of the connected vehicle. The apparatus can compare the voltage and/or current limitations of the requested information with the table and identify or determine a vehicle with matching voltage and/or current limitations and/or correspond to a range including the voltage and/or current limitations in the table.

In another example, the apparatus can determine the vehicle type using image processing. For example, the apparatus can include or be in communication with a camera or other image capture device. The camera can capture one or more images of a vehicle responsive to the vehicle connecting with the apparatus. The images can be of the body of the vehicle and/or depict the vehicle's license plate. The apparatus can receive the images from the camera. The apparatus can use image processing techniques, such as object recognition techniques via a machine learning model (e.g., a neural network), to determine the type of the vehicle depicted in the images either. The apparatus can do so based on one or both of the depictions of the license plate and/or the body of the vehicle.

The vehicle type can be determined in this way to perform the method 4700 and/or to determine vehicle types to determine a queue for charging, as described above.

At operation 4706, the apparatus determines a resistance of a variable resistor of the apparatus. The variable resistor can be a resistor within the apparatus and can be configured to be connected between the PE and the PP pins of the vehicle charging gun connecting the apparatus with the vehicle. Current can flow through the variable resistor to enable the apparatus and/or the vehicle to determine when the vehicle is connected with the apparatus. The apparatus can determine the resistance of the variable resistor based on the determined type of the vehicle. For example, the apparatus can store a table containing mappings between types of vehicles and resistances. The apparatus can compare the determined type of the connected vehicle (e.g., an identifier of the determined type of the connected vehicle) with the mapping to identify a resistance that maps to the type of the connected vehicle.

At operation 4708, the apparatus adjusts a resistance of a variable resistor in the apparatus. The apparatus can adjust the resistance to the resistance determined in operation 4706. At operation 4710, the apparatus can initiate a vehicle charging session with the connected vehicle based on the adjusted variable resister. The apparatus can initiate the vehicle charging session by adjusting a position of a switch in series with the variable resistor and connecting the vehicle with the apparatus from an open position to a closed position and directing energy through the switch and the vehicle charging gun connected to the vehicle inlet. When the charging session ends, the apparatus can open the switch (e.g., simulating the removal of the charging gun from the vehicle inlet) to stop charging the vehicle (e.g., cause the vehicle to stop drawing current or power from the apparatus or otherwise stop the apparatus from directed power (e.g., DC power) to the vehicle through the vehicle charging gun).

In one aspect, the present disclosure describes a charging system for directing power flow between multiple devices. The charging system can include an apparatus comprising one or more inlet ports for connection to one or more respective devices; a plurality of outlet ports configured for supplying electrical power from the one or more inlet ports; and a cable locking mechanism configured to prevent unauthorized users from manually disconnecting cables of devices connected with the apparatus from the plurality of outlet ports of the apparatus.

In one aspect, the present disclosure describes an apparatus for directing power flow between multiple devices. The apparatus can include one or more inlet ports for connection to one or more respective devices; a plurality of outlet ports configured for supplying electrical power from the one or more inlet ports; and one or more processors coupled to memory, the memory comprising instructions that, when executed by the one or more processors, cause the one or more processors to detect connection at an outlet port of the plurality of outlet ports with a vehicle; responsive to detecting the connection, automatically lock the vehicle to the outlet port in a simulated charging session with the vehicle for a first time period; during the first time period in which the vehicle is locked to the outlet port in the simulated charging session, determine to charge the vehicle; and responsive to the determination to charge the vehicle, initiate directing power to the vehicle through the outlet port during a second time period subsequent to the first time period while the vehicle remains locked to the outlet port.

In one aspect, a connector box can include a vehicle inlet port configured to receive a vehicle connector configured to connect to a direct current (DC) or alternating current (AC) vehicle charging station; a locking mechanism configured to secure the vehicle connector within the vehicle inlet port, wherein the locking mechanism is configured to be activated upon insertion of the vehicle connector into the vehicle inlet port and remain activated until deactivation by an authorized user; and an outlet port configured to supply electrical power received via the vehicle inlet port and to an apparatus, the apparatus configured to supply the electrical power from the outlet port to a vehicle connected to the apparatus in a vehicle charging session.

In some embodiments, the outlet port is configured to supply the electrical power to the apparatus through a cable; and wherein the connector box is configured to transmit communication signals and power received through the vehicle inlet port to the apparatus through the cable. In some embodiments, the connector box further includes a communications module; and one or more processors configured by executable instructions stored in memory to: transmit the communication signals through the cable via the communications module; and transmit a message over a wireless communications network to a remote computing device via the communications module.

In some embodiments, the one or more processors are configured to transmit the message to the remote computing device by including an indication of a connection between the vehicle and the apparatus in the message, wherein the remote computing device initiates the vehicle charging session based at least in part on the message. In some embodiments, the connector box is configured as a separate unit located between the vehicle charging station and the apparatus; wherein the connector box is configured to connect with the vehicle charging station through a first cable that leaves the vehicle charging station and connects to the vehicle inlet port; and wherein the connector box is configured to connect with the apparatus through a second cable that leaves the connector box through the outlet port and connects with the apparatus.

In some embodiments, the vehicle connector is configured with pins to connect with a charging port of a second vehicle to supply second electrical power to the vehicle. In some embodiments, the connector box further includes a communications module; and one or more processors configured by executable instructions stored in memory to: receive a message from a client device, the message comprising instructions to deactivate the locking mechanism; and deactivate the locking mechanism in response to the message.

In some embodiments, the connector box is positioned within the apparatus; wherein the connector box is configured to connect with the vehicle charging station through a first cable that leaves the vehicle charging station and connects to the vehicle inlet port of the connector box; and wherein the connector box is configured to connect with the apparatus through the outlet port via a second cable that connects with the vehicle inlet port of the apparatus, where the second cable is contained entirely within the enclosure of the apparatus. In some embodiments, the vehicle inlet port is configured to receive DC power from the vehicle charging station, and the connector box further comprises: an AC inlet port configured to connect to and to receive AC power from an AC power source, wherein the connector box is configured to direct the AC power to the apparatus through a second outlet port of the connector box.

In one aspect, a charging system includes an apparatus comprising: an apparatus inlet port configured to receive electrical power originating from a direct current (DC) or alternating current (AC) vehicle charging station; and one or more outlet ports configured to supply the electrical power to an electric vehicle; and a connector box configured to connect to the apparatus and the DC or AC vehicle charging station, the connector box comprising: a vehicle inlet port configured to receive a vehicle connector from the DC or AC vehicle charging station; a locking mechanism configured to secure the vehicle connector within the vehicle inlet port; and an outlet port configured to supply electrical power received via the vehicle inlet port to an apparatus, the apparatus configured to supply the electrical power from the outlet port to a vehicle connected to the apparatus in a vehicle charging session.

In some embodiments, the outlet port is configured to connect to and supply the electrical power to the apparatus over a cable; and the connector box is configured to transmit communication signals and power received through the vehicle inlet port to the apparatus through the cable. In some embodiments, the connector box further comprises a communications module; and one or more processors configured by executable instructions stored in memory to: transmit the communication signals through the cable via the communications module; and transmit a message over a wireless communications network to a remote computing device via the communications module.

In some embodiments, the one or more processors are configured to transmit the message to the remote computing device by: including an indication of a connection between the vehicle and the apparatus in the message, wherein the remote computing device initiates the vehicle charging session based at least in part on the message. In some embodiments, the connector box is configured as a separate unit located between the vehicle charging station and the apparatus; wherein the connector box is configured to connect with the vehicle charging station through a first cable that leaves the vehicle charging station and connects to the vehicle inlet port; and wherein the connector box is configured to connect with the apparatus through a second cable that leaves the connector box through the outlet port and connects with the apparatus.

In some embodiments, the vehicle connector is configured with pins to connect with a charging port of a second vehicle to supply second electrical power to the vehicle. In some embodiments, the connector box further comprises a communications module; and one or more processors configured by executable instructions stored in memory to: receive a message from a client device, the message comprising instructions to deactivate the locking mechanism; and deactivate the locking mechanism in response to the message. In some embodiments, the vehicle inlet port is configured to receive DC power from the vehicle charging station, and the connector box further comprises: an AC inlet port configured to connect to and receive AC power from an AC power source; wherein the connector box is configured to direct the AC power to the apparatus through a second outlet port of the connector box.

In one aspect, a connector box, comprises a vehicle inlet port configured to receive a vehicle connector from a direct current (DC) or alternating current (AC) vehicle charging station; a locking mechanism configured to secure the vehicle connector within the vehicle inlet port; an outlet port configured to supply electrical power received via the vehicle inlet port and to an apparatus, the apparatus configured to supply the electrical power from the outlet port to a vehicle connected to the apparatus in a vehicle charging session;
a communications module; and one or more processors configured by machine-readable instructions to communicate with a remote computing device via the communications interface to control the vehicle charging session.

In some embodiments, the outlet port is configured to supply the electrical power to the apparatus over a cable; and wherein the connector box is configured to transmit communication signals and power received through the vehicle inlet port to the apparatus through the cable.

In some embodiments, the one or more processors are configured to: transmit the communication signals through the cable via the communications module; and transmit a message over a wireless communications network to the remote computing device.

In one aspect, an apparatus for directing power flow between multiple devices, the apparatus comprises a first set of inlet ports to connect with a vehicle charging station, the first set of inlet ports configured to receive first power from a vehicle charging station; a second set of inlet ports to connect with an external power source, the second set of inlet ports configured to receive second power from the external power source; a first set of outlet ports to supply the first power from the vehicle charging station to a first vehicle in a first configuration and the second power from the external power source to the first vehicle in a second configuration; and a second set of outlet ports to direct the first power from the vehicle charging station to a second apparatus in the second configuration, wherein the second apparatus is configured to supply the first power to a second vehicle.

In some embodiments, the first set of inlet ports are configured to receive the first power as direct current power from the vehicle charging station; and wherein the second set of inlet ports are configured to receive the second power as alternating current power from the external power source. In some embodiments, the first set of inlet ports are configured to receive the first power as direct current power from the vehicle charging station; and wherein the second set of inlet ports are configured to receive the second power as direct current power from the external power source.

In some embodiments, the first set of inlet ports are configured to receive the first power as alternating current power from the vehicle charging station; and wherein the second set of inlet ports are configured to receive the second power as direct current power from the external power source. In some embodiments, the first set of inlet ports are configured to receive the first power as alternating current power from the vehicle charging station; and wherein the second set of inlet ports are configured to receive the second power as alternating current power from the external power source.

In some embodiments, the apparatuses further comprises: one or more processors configured by machine-readable instructions to: determine not to charge the first vehicle with the first power from the vehicle charging station; and in response to the determination, reroute the first power to the second apparatus. In some embodiments, the one or more processors are configured to determine not to charge the first vehicle with the first power from the vehicle charging station by: detecting that a charging session supplying the first power to the first vehicle has completed; and determining to not further charge the first vehicle with the first power from the vehicle charging station in response to the detection.

In some embodiments, the one or more processors are further configured to route the first power from the vehicle charging station to the second apparatus by: activating one or more switches to redirect the first power from the first vehicle to the second apparatus. In some embodiments, the second set of outlet ports are further configured for directing the second power from the external power source to the second apparatus.

In some embodiments, in the first configuration, the apparatus is configured is to pass communication from the vehicle charging station to the first vehicle in the first configuration; and the apparatus is configured to directly communicate with the first vehicle in the second configuration. In some embodiments, the first set of inlet ports receive the first power from the vehicle charging station through a third apparatus. In some embodiments, the apparatuses further comprises: a rectifier, wherein the first set of outlet port are configured to supply the second power from the external power source to the first vehicle by: converting the second power from alternating current (AC) power to direct current (DC) power via the rectifier; and supplying the converted DC power to the first vehicle via the first set of outlet ports.

In some embodiments, the apparatus further comprises an inverter, wherein the first set of outlet port are configured to supply the second power from the external power source to the first vehicle by: converting the second power from direct current (DC) power to alternating current (AC) power via the inverter; and supplying the converted DC power to the first vehicle via the first set of outlet ports.

In some embodiments, the apparatus further comprises a converter, wherein the first set of outlet port are configured to supply the second power from the external power source to the first vehicle by: adjusting a voltage of the second power from a first voltage to a second voltage; and supplying the adjusted second power to the first vehicle via the first set of outlet ports.

In one aspect, a system for directing power flow between multiple devices comprises a first apparatus comprising: a first set of inlet ports for connection with a vehicle charging station, the first set of inlet ports configured to receive first power from a vehicle charging station via a second apparatus; a second set of inlet ports for connection with an external power source, the second set of inlet ports configured to receive second power from the external power source; a first set of outlet ports configured for supplying the first power from the vehicle charging station to a first vehicle in a first configuration and the second power from the external power source to the first vehicle in a second configuration; and a second set of outlet ports configured for directing the first power from the vehicle charging station to a third apparatus in the second configuration, wherein the first apparatus is configured to supply the second power from the external power source to the first vehicle while the third apparatus supplies a second vehicle with the first power from the vehicle charging station.

In some embodiments, the first apparatus directs the first power from the second apparatus for a vehicle charging session responsive to receiving the first power from the second apparatus through the first set of inlet ports. In some embodiments, the supply of the second power to the first vehicle is to heat up a battery of the first vehicle for faster charging during the vehicle charging session and/or to lock the first vehicle to a vehicle charging connector.

In some embodiments, the first apparatus is to connect to the first vehicle through a vehicle charging connector, the vehicle charging connector comprising: a first set of pins configured to supply direct current power to the first vehicle; and a second set of pins configured to supply alternating current power to the first vehicle. In some embodiments, the first set of pins are positioned below the second set of pins on the vehicle charging connector. In some embodiments, the first apparatus is connected with the second apparatus via a single cable comprising a plurality of conductors, the plurality of conductors configured transfer both direct current power and alternating current power from the second apparatus to the apparatus.

In one aspect, a system for directing power flow between multiple devices, the system comprises a plurality of apparatuses to connect in series with each other and with a vehicle charging station, the plurality of apparatuses each to connect to an external power source; and one or more processors configured by machine-readable instructions to: configure a first apparatus of the plurality of apparatuses in a first configuration to supply first power from the vehicle charging station to a first vehicle; configure a second apparatus of the plurality of apparatuses in a second configuration to supply second power from the external power source to a second vehicle while the first apparatus supplies the first power to the first vehicle; adjust the configuration of the first apparatus to a third configuration to supply the first power to the second apparatus; and adjust the configuration of the second apparatus to a fourth configuration to supply the first power from the first apparatus to the second vehicle.

In some embodiments, the one or more processors are configured to adjust the configurations of the first apparatus and the second apparatus responsive to determining a charging session between the first apparatus and the first vehicle has completed. In some embodiments, the one or more processors configuring the second apparatus to supply the second power to the second vehicle also causes the second vehicle to lock a cable connecting the second vehicle with the second apparatus to a vehicle inlet port of the second vehicle.

In some embodiments, the one or more processors are configured to ensure only one of the plurality of apparatuses supplies power originating from the vehicle charging station to a vehicle at a time. In some embodiments, the one or more processors are configured to: adjust the configuration of the first apparatus to the third configuration by adjusting a position of a switch within the first apparatus from a first position to a second position.

In one aspect, a vehicle charging system for directing power flow to a vehicle can include a vehicle charging gun comprising at least two pins, a protective earth (PE) pin configured to connect to ground and a proximity pilot (PP) pin configured to detect when the vehicle charging gun has been inserted into a vehicle; and an apparatus to couple with the vehicle charging gun, the apparatus comprising: a switch operable between a first position and a second position, the switch being controlled by a controller, wherein, when the switch is in the first position, the switch enables the vehicle or vehicle charging station to detect that the vehicle charging gun is inserted into a vehicle inlet port of the vehicle, and when the switch is in the second position, the apparatus generates an electrical effect that simulates the removal of the vehicle charging gun from the vehicle inlet port.

In some embodiments, the vehicle charging gun is a combined charging system (CCS) type 2 vehicle charging gun. In some embodiments, the apparatus generates the electrical effect that simulates the removal of the vehicle charging gun from the vehicle inlet port while the vehicle charging gun remains connected with the vehicle inlet port.

In some embodiments, the apparatus further includes a resistor located between two conductors to connect to the PE and PP pins of the vehicle charging gun when the switch is in the first position. In some embodiments, the resistor is a variable resistor, and wherein the controller comprises one or more processors configured by machine-readable instructions to: determine a vehicle type of the vehicle; adjust a resistance value of the variable resistor based on the determined vehicle type.

In some embodiments, the apparatus further comprises a communications interface, and wherein the one or more processors are configured to: communicate, over the communications interface, with a processor of the vehicle responsive to the vehicle charging gun connecting with the vehicle inlet port; and determine the vehicle type of the vehicle based on the communication with the processor of the vehicle.

In some embodiments, the controller comprises one or more processors configured by machine-readable instructions to, and wherein the one or more processors are configured to: adjust a position of the switch from the first position to the second position; and subsequent to the adjustment of the switch from the first position to the second position, adjust the position of the switch from the second position to the first position, the adjustment from the second position to the first position enabling the initiation or resumption of a charging session with the vehicle.

In some embodiments, the controller comprises one or more processors configured by machine-readable instructions to, and wherein the one or more processors are configured to: electronically adjust the position of the switch based on a charging session status or a user input. In some embodiments, the vehicle charging gun does not include a resistor that is used to detect the presence of the vehicle charging gun in the vehicle inlet port of the vehicle.

In one aspect, a vehicle charging system for directing power flow to a vehicle includes a vehicle charging gun comprising: at least two pins, a protective earth (PE) pin configured to connect to ground and a proximity detection (CS) pin configured to detect when the vehicle charging gun has been inserted into a vehicle; and an apparatus to couple with the vehicle charging gun, the apparatus comprising: a switch operable between a first position and a second position, the switch to be controlled by a controller, wherein, when the switch is in the first position, the switch enables the vehicle or vehicle charging station to detect that the vehicle charging gun is inserted into a vehicle inlet port of the vehicle, and when the switch is in the second position, the apparatus generates an electrical effect that simulates the removal of the vehicle charging gun from the vehicle inlet port.

In some embodiments, the vehicle charging gun is a combined charging system (CCS) type 1 vehicle charging gun. In some embodiments, the apparatus further comprises a resistor located so as to enable current to flow between the CS and PE pins of the vehicle charging gun when the switch is in the first position.

In some embodiments, the vehicle charging gun further comprises: a second resistor connected to the PE pin; and a first conductor coupled directly to the second resistor, the conductor configured to connect to directly to the switch. In some embodiments, the vehicle charging gun further comprises: a second conductor connected to the CS pin, the second conductor connected to the resistor. In some embodiments, the resistor and the switch are connected in series.

In some embodiments, the resistor is a variable resistor, and wherein the controller comprises one or more processors configured by machine-readable instructions to: determine a vehicle type of the vehicle; adjust a resistance value of the variable resistor based on the determined vehicle type.

In some embodiments, the apparatus further comprises a communications interface, wherein the one or more processors are configured to: communicate, over the communications interface, with a processor of the vehicle responsive to the vehicle charging gun connecting with the vehicle inlet port; and determine the vehicle type of the vehicle based on the communication with the processor of the vehicle.

In one aspect, a vehicle charging system for directing power flow to a vehicle includes a vehicle charging gun comprising: at least two pins, a ground (GND) pin configured to connect to ground and a proximity pilot (PP) pin configured to detect when the vehicle charging gun has been inserted into a vehicle; and an apparatus to couple with the vehicle charging gun, the apparatus comprising: a switch operable between a first position and a second position, the switch to be controlled by a controller, wherein, when the switch is in the first position, the switch enables the vehicle or vehicle charging station to detect that the vehicle charging gun is inserted into a vehicle inlet port of the vehicle, and when the switch is in the second position, the apparatus generates an electrical effect that simulates the removal of the vehicle charging gun from the vehicle inlet port.

In some embodiments, the vehicle charging gun is a NACS vehicle charging gun. In some embodiments, the apparatus further comprises a resistor located between two conductors to connect to the PP and GND pins of the vehicle charging gun when the switch is in the first position. In some embodiments, the vehicle charging gun further comprises a first conductor coupled directly to the switch and the GND pin; and a second conductor coupled directly to the resistor and the PP pin.

In one aspect, a vehicle charging system for directing power flow to a vehicle includes an apparatus comprising one or more processors and memory; a vehicle charging gun communicatively coupled to the apparatus, the vehicle charging gun comprising: a switch operable between a first position and a second position, the switch to be controlled by the apparatus, wherein, when the switch is in the first position, the switch enables the vehicle or a vehicle charging station to detect that the vehicle charging gun is inserted into a vehicle inlet port of the vehicle, and when the switch is in the second position, the apparatus generates an electrical effect that simulates the removal of the vehicle charging gun from the vehicle inlet port.

In some embodiments, the one or more processors are configured by machine-readable instructions to adjust a position of the first switch based on whether the vehicle charging gun is charging the vehicle in a charging session. In some embodiments, the vehicle charging gun further comprises: at least two pins, a first pin configured to connect to ground and a second pin configured to detect when the vehicle charging gun has been inserted into a vehicle, wherein the switch enables current to flow between the first and second pins in the first position and not in the second position.

In one aspect, an apparatus for directing power flow between multiple devices, the apparatus comprises a first set of inlet ports to connect with a vehicle charging station, the first set of inlet ports configured to receive power in either direct current (DC) or alternating current (AC) form from the vehicle charging station or supply power in DC or AC form to the vehicle charging station; a second set of inlet ports to connect with an external power source, the second set of inlet ports configured to receive power in either AC or DC form from the external power source or supply power in AC or DC form to the external power source; a first set of outlet ports configured to supply power, either in DC or AC form as appropriate, to a first vehicle, where the power is derived from the vehicle charging station, the external power source, or a combination thereof, or to receive power from the first vehicle for transfer to the vehicle charging station, external power source, or both; and a second set of outlet ports configured to direct power, either in DC or AC form as appropriate, from the vehicle charging station or the external power source to a second apparatus, or to receive power from the second apparatus for transfer to the vehicle charging station, the external power source, or the first vehicle, wherein the second apparatus is configured to supply the power to a second vehicle, or receive power from the second vehicle for transfer to the vehicle charging station or the external power source, or the first vehicle.

In some embodiments, the apparatus further comprises a communication system, wherein: when power is supplied or received via the vehicle charging station through the first set of inlet ports: if communication with the first vehicle is handled by the apparatus, the apparatus is configured to act as an intermediary in the communication chain, functioning as: a virtual electric vehicle (EV) to the vehicle charging station; and a virtual vehicle charging station to the first or second vehicle, or another apparatus in the chain. In some embodiments, when power is supplied or received via the external power source through the second set of inlet ports: communication with the first and/or second vehicles is performed directly by the apparatus acting as a vehicle charging station to transfer power to or from the external power source.

In some embodiments, the apparatus further comprises one or more processors configured by machine-readable instructions to: determine not to charge the first vehicle with the DC or AC power from the vehicle charging station; and in response to the determination, route the DC or AC power from the vehicle charging station to the second apparatus or receive DC or AC power from the second apparatus and route it to the vehicle charging station.

In some embodiments, the one or more processors are configured to determine not to charge the first vehicle with the DC or AC power from the vehicle charging station by: detecting that a charging session supplying or receiving DC or AC power to or from the first vehicle has completed; and determining to stop charging the first vehicle with the DC or AC power from the vehicle charging station in response to the detection.

In some embodiments, the one or more processors are further configured to route the DC or AC power between the vehicle charging station and the second apparatus by: activating one or more switches to redirect the DC or AC power from the vehicle charging station to the second apparatus; or redirect the DC or AC power from the second apparatus to the vehicle charging station. In some embodiments, the second apparatus is connected to a third apparatus, the third apparatus configured to: charge a third vehicle using the AC or DC power from the external power source; supply AC or DC power to the external power source or to the second apparatus; while the second apparatus is configured to supply the DC or AC power from the vehicle charging station to the second vehicle or receive AC or DC power from the second vehicle and route it to the vehicle charging station, the external power source, or the third apparatus.

In some embodiments, the first apparatus is connected to the second apparatus, and the second apparatus is connected to a third apparatus, the system configured to: charge a first and/or second vehicle using the AC or DC power from the external power source; or receive AC or DC power from the first and/or second vehicle and route it to the external power source, the second apparatus, or the third apparatus, while the third apparatus is configured to: supply the DC or AC power from the vehicle charging station to the third vehicle; or receive DC or AC power from the third vehicle and route it to the vehicle charging station, the external power source, the second apparatus, or the first apparatus.

In some embodiments, the second set of outlet ports are further configured to: direct AC or DC power from the external power source to the second apparatus; or receive AC or DC power from the second apparatus and route it to the external power source. In some embodiments, the first set of inlet ports receive or supply the DC or AC power from or to the vehicle charging station through a third apparatus. In some embodiments, The apparatus further comprises a rectifier configured to convert AC power to DC power and an inverter configured to convert DC power to AC power; or a bidirectional converter configured to perform both AC-to-DC and DC-to-AC power conversions,

In some embodiments, the first set of outlet ports are configured to: supply AC power from the external AC power source to the first vehicle by: converting the AC power from the external source to DC power via the rectifier or the bidirectional converter; and supplying the converted DC power to the first vehicle via the first set of outlet ports. The first set of outlet ports can be configured to receive DC power from the first vehicle via the first set of outlet ports and: convert it to AC power via the inverter or the bidirectional converter for supply to the external AC power source; or route it as DC power or the converted AC power to another apparatus.

It will be understood that while exemplary features of an apparatus 100 for directing power flow between multiple devices have been described, such an arrangement is not to be construed as limiting the present teaching to such features. The functionality for directing power flow between multiple devices (and furthermore according to various charging protocols) may be implemented in software, firmware, hardware, or a combination thereof. In one mode, the functionality is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. The functionality may be implemented by a server or computer in which the software modules reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functionality of the present teaching. The processor(s) is a hardware device for executing software, particularly software stored in memory. Processor(s) can be any custom made or commercially available processor, a primary processing unit (CPU), an auxiliary processor among several processors associated with a computer, a semiconductor based microprocessor (in the form of a microchip or chip set), a macro-processor, or generally any device for executing software instructions.

Memory is associated with processor(s) and can include any one or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example of heretofore described, the software in memory is executable on a suitable operating system (O/S).

The present disclosure may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When the functionality is implemented in software, it should be noted that such software can be stored on any computer readable medium for use by or in connection with any computer related system or method. In the context of the present teaching, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus 100, or device, such as a computer-based system, processor-containing system, or other system that can fetch the instructions from the instruction execution system, apparatus 100, or device and execute the instructions. In the context of the present disclosure, a “computer-readable medium” can be any means that can store, communicate, propagate, or transport the program for use by or in connection with the instruction execution system, apparatus 100, or device. The computer readable medium can be for example, but not limited to, an electronic, magnetic, optical, electromagnetic, infrared, or semiconductor system, apparatus 100, device, or propagation medium. Any process descriptions or blocks in the figures, should be understood as representing modules, segments, or portions of code which include one or more executable instructions for implementing specific logical functions or steps in the process, as would be understood by those having ordinary skill in the art.

The above detailed description of embodiments of the disclosure is not intended to be exhaustive nor to limit the disclosure to the exact form disclosed. While specific examples for the disclosure are described above for illustrative purposes, those skilled in the relevant art will recognize various modifications are possible within the scope of the disclosure. For example, while processes and blocks have been demonstrated in a particular order, different implementations may perform routines or employ systems having blocks, in an alternate order, and some processes or blocks may be deleted, supplemented, added, moved, separated, combined, and/or modified to provide different combinations or sub-combinations. Each of these processes or blocks may be implemented in a variety of alternate ways. Also, while processes or blocks are at times shown as being performed in sequence, these processes or blocks may instead be performed or implemented in parallel or may be performed at different times. The results of processes or blocks may be also held in a non-persistent store as a method of increasing throughput and reducing processing requirements.

The present disclosure is not limited to the embodiment(s) described herein but can be amended or modified without departing from the scope of the present disclosure. Additionally, it will be appreciated that in embodiments of the present disclosure some of the above-described steps may be omitted and/or performed in an order other than that described.

Similarly the words comprises/comprising when used in the specification are used to specify the presence of stated features, integers, steps or components but do not preclude the presence or addition of one or more additional features, integers, steps, components or groups thereof.

What is claimed is:

1. A vehicle charging system for directing power flow to a vehicle, the vehicle charging system comprising:
a vehicle charging gun comprising:
at least two pins, a protective earth (PE) pin configured to connect to ground and a proximity pilot (PP) pin configured to detect when the vehicle charging gun has been inserted into a vehicle; and
an apparatus to couple with the vehicle charging gun, the apparatus comprising:
a switch operable between a first position and a second position, the switch being controlled by a controller,
wherein, when the switch is in the first position, the switch enables the vehicle or a vehicle charging station to detect that the vehicle charging gun is inserted into a vehicle inlet port of the vehicle, and when the switch is in the second position, the apparatus generates an electrical effect that simulates the removal of the vehicle charging gun from the vehicle inlet port.

2. The vehicle charging system of claim 1, wherein the vehicle charging gun is a combined charging system (CCS) type 2 vehicle charging gun.

3. The vehicle charging system of claim 1, wherein the apparatus generates the electrical effect that simulates the removal of the vehicle charging gun from the vehicle inlet port while the vehicle charging gun remains connected with the vehicle inlet port.

4. The vehicle charging system of claim 1, further comprising a resistor located between two conductors to connect to the PE and PP pins of the vehicle charging gun when the switch is in the first position.

5. The vehicle charging system of claim 4, wherein the resistor is a variable resistor, and wherein the controller comprises one or more processors configured by machine-readable instructions to:
determine a vehicle type of the vehicle;
adjust a resistance value of the variable resistor based on the determined vehicle type.

6. The vehicle charging system of claim 5, wherein the apparatus further comprises:
a communications interface,
wherein the one or more processors are configured to:
communicate, over the communications interface, with a processor of the vehicle responsive to the vehicle charging gun connecting with the vehicle inlet port; and
determine the vehicle type of the vehicle based on the communication with the processor of the vehicle.

7. The vehicle charging system of claim 1, wherein the controller comprises one or more processors configured by machine-readable instructions to, and
wherein the one or more processors are configured to:
adjust a position of the switch from the first position to the second position; and
subsequent to the adjustment of the switch from the first position to the second position, adjust the position of the switch from the second position to the first position, the adjustment from the second position to the first position enabling the initiation or resumption of a charging session with the vehicle.

8. The vehicle charging system of claim 1, wherein the controller comprises one or more processors configured by machine-readable instructions to, and
wherein the one or more processors are configured to:
electronically adjust the position of the switch based on a charging session status or a user input.

9. The vehicle charging system of claim 1, wherein the vehicle charging gun does not include a resistor that is used to detect the presence of the vehicle charging gun in the vehicle inlet port of the vehicle.

10. A vehicle charging system for directing power flow to a vehicle, the vehicle charging system comprising:
a vehicle charging gun comprising:
at least two pins, a protective earth (PE) pin configured to connect to ground and a proximity detection (CS) pin configured to detect when the vehicle charging gun has been inserted into a vehicle; and
an apparatus to couple with the vehicle charging gun, the apparatus comprising:
a switch operable between a first position and a second position, the switch to be controlled by a controller,
wherein, when the switch is in the first position, the switch enables the vehicle or a vehicle charging station to detect that the vehicle charging gun is inserted into a vehicle inlet port of the vehicle, and when the switch is in the second position, the apparatus generates an electrical effect that simulates the removal of the vehicle charging gun from the vehicle inlet port.

11. The vehicle charging system of claim 9, wherein the vehicle charging gun is a combined charging system (CCS) type 1 vehicle charging gun.

12. The vehicle charging system of claim 9, wherein the apparatus further comprises a resistor located so as to enable current to flow between the CS and PE pins of the vehicle charging gun when the switch is in the first position.

13. The vehicle charging system of claim 12, wherein the vehicle charging gun further comprises:
a second resistor connected to the PE pin; and
a first conductor coupled directly to the second resistor, the first conductor configured to connect to directly to the switch.

14. The vehicle charging system of claim 13, wherein the vehicle charging gun further comprises:
a second conductor connected to the CS pin, the second conductor connected to the resistor.

15. The vehicle charging system of claim 14, wherein the resistor and the switch are connected in series.

16. The vehicle charging system of claim 12, wherein the resistor is a variable resistor, and wherein the controller comprises one or more processors configured by machine-readable instructions to:
determine a vehicle type of the vehicle;
adjust a resistance value of the variable resistor based on the determined vehicle type.

17. The vehicle charging system of claim 16, wherein the apparatus further comprises:
a communications interface,
wherein the one or more processors are configured to:
communicate, over the communications interface, with a processor of the vehicle responsive to the vehicle charging gun connecting with the vehicle inlet port; and
determine the vehicle type of the vehicle based on the communication with the processor of the vehicle.

18. A vehicle charging system for directing power flow to a vehicle, the vehicle charging system comprising:
a vehicle charging gun comprising:
at least two pins, a ground (GND) pin configured to connect to ground and a proximity pilot (PP) pin configured to detect when the vehicle charging gun has been inserted into a vehicle; and
an apparatus to couple with the vehicle charging gun, the apparatus comprising:
a switch operable between a first position and a second position, the switch to be controlled by a controller,
wherein, when the switch is in the first position, the switch enables the vehicle or vehicle charging station to detect that the vehicle charging gun is inserted into a vehicle inlet port of the vehicle, and when the switch is in the second position, the apparatus generates an electrical effect that simulates the removal of the vehicle charging gun from the vehicle inlet port.

19. The vehicle charging system of claim 16, wherein the vehicle charging gun is a NACS vehicle charging gun.

20. The vehicle charging system of claim 16, wherein the apparatus further comprises a resistor located between two conductors to connect to the PP and GND pins of the vehicle charging gun when the switch is in the first position.

21. The vehicle charging system of claim 20, wherein the vehicle charging gun further comprises:
a first conductor coupled directly to the switch and the GND pin; and
a second conductor coupled directly to the resistor and the PP pin.

22. A vehicle charging system for directing power flow to a vehicle, the vehicle charging system comprising:
an apparatus comprising one or more processors and memory;
a vehicle charging gun communicatively coupled to the apparatus, the vehicle charging gun comprising:
a switch operable between a first position and a second position, the switch to be controlled by the apparatus,
wherein, when the switch is in the first position, the switch enables the vehicle or a vehicle charging station to detect that the vehicle charging gun is inserted into a vehicle inlet port of the vehicle, and when the switch is in the second position, the apparatus generates an electrical effect that simulates the removal of the vehicle charging gun from the vehicle inlet port.

23. The vehicle charging system of claim 22, wherein the one or more processors are configured by machine-readable instructions to adjust a position of the first switch based on whether the vehicle charging gun is charging the vehicle in a charging session.

24. The vehicle charging system of claim 22, wherein the vehicle charging gun further comprises:
at least two pins, a first pin configured to connect to ground and a second pin configured to detect when the vehicle charging gun has been inserted into a vehicle,
wherein the switch enables current to flow between the first and second pins in the first position and not in the second position.
